(19) United States
(12) Patent Application Publication
(10) Pub. No.: US 2016/0042122 A1
(43) Pub. Date: Feb. 11, 2016

(54) IMAGE PROCESSING METHOD AND IMAGE PROCESSING APPARATUS

(71) Applicant: CANON KABUSHIKI KAISHA, Tokyo (JP)

(72) Inventors: Kazuyuki Sato, Yokohama-shi (JP); Takuya Tsujimoto, Kawasaki-shi (JP)

(21) Appl. No.: 14/817,350

(22) Filed: Aug. 4, 2015

(30) Foreign Application Priority Data
Aug. 11, 2014 (JP) 2014-163671
Aug. 11, 2014 (JP) 2014-163672

(51) Int. Cl. G06F 19/00; G06T 19/00; G06F 3/0484; G06T 7/00

(52) U.S. Cl. CPC G06F 19/321; G06T 7/0012; G06T 19/003; G06F 3/04842

(57) ABSTRACT

An image processing method includes: acquiring an operation instruction to change a display area from a state in which first image data of a first area is being displayed to a state in which image data of a second area is to be displayed; acquiring thickness information indicating an existence range of an object in a depth direction; selecting second image data, which is to be displayed after the display area is changed, from among the image data of the one or more layers of the second area, based on the thickness information of the object; and generating display image data from the second image data to be output.

### BACKGROUND OF THE INVENTION

1. Field of the Invention

The present invention relates to an image processing method and an image processing apparatus and, in particular, to a technology for displaying image data of an object.

2. Description of the Related Art

In recent years, attention has been paid in the pathology field to a virtual slide system having an imaging apparatus as an alternative to an optical microscope used for a pathological analysis. With the virtual slide system, it is possible to pick up an image of a sample (hereinafter called a test sample) placed on a slide (also called a preparation) and digitize the acquired image to perform a pathological analysis on a display.

Thanks to the digitization of a pathological analysis image with the virtual slide system, it becomes possible to handle a conventional optical microscope image of a test sample as digital data. As a result, it has been expected to produce effects such as a quick remote analysis, explanation to a patient using a digital image, sharing of a rare case, and improved efficiency of education and training. In order to realize the same operation as that of an optical microscope with the virtual slide system, it is required to digitize an image of the whole sample on a slide. With the digitization of an image of the whole test sample, digital data generated by the virtual slide system may be observed through viewer software operating on a personal computer (PC) or a workstation. When an image of the whole test sample is digitized, the number of the pixels of the image generally falls within an enormous data amount between hundreds of millions of pixels and tens of billions of pixels. Although the amount of data generated by the virtual slide system is enormous, it becomes possible to observe an image from a micro level (at which the details of the image are enlarged) to a macro level (at which the image is overlooked) through enlarging/reducing processing on a viewer. As a result, various conveniences are offered. With the acquisition of all required information in advance, it becomes possible to immediately display an image as a low-magnification image or a high-magnification image at a resolution/magnification requested by a user.

A test sample on a slide has a thickness, and thus a depth position at which tissues or cells to be observed exist is different depending on the observation position of the slide (in an XY direction). Therefore, there is a configuration in which a plurality of images is picked up with a focal position changed along an optical axis direction to generate the plurality of images different in focal position. Hereinafter, the depth position of an object in an optical axis direction (Z direction) will be called a layer, and a two-dimensional image picked up with a focal position set at the depth position will be called a layer image. Further, an image group (three-dimensional image information) constituted by a plurality of layer images different in focal position will be called a Z-stack image.

As a method of efficiently viewing a Z-stack image, there has been proposed a medical image display apparatus that displays an in-focus image by auto focus (by which the in-focus image is automatically selected) to support a doctor's analysis (U.S. Patent Application Publication No. 2012/0007977 A1).

### SUMMARY OF THE INVENTION

According to a conventional method, in a case in which a display is automatically switched to an in-focus image by auto focus when a user gives a scrolling operation instruction to move a display area in an XY direction, there is a likelihood that the layer of the displayed in-focus image and the layer of an image to be initially observed are different from each other. In addition, when the switching display of a layer, the display of an all in-focus image in which the most in-focus layers of respective display areas are joined together, or the like is automatically performed, there is a likelihood that a user does not notice the discontinuous state of the displayed image in a depth direction.

When a layer is changed by the scrolling without being noticed by the user or when the position of a currently-observed layer in a depth direction is not clear, it is hard to understand the three-dimensional structure of tissues or cells.

Generally, the size of a test sample serving as an object is much greater than the width of the view of the image pick-up system of the virtual slide system. Therefore, a divided image pickup is performed to divide a test sample into a plurality of areas (image pickup regions) to pick up an image of the test sample. The divided images (layer images) of the respective areas will be called tile images. In a case in which a display is automatically switched to the tile image of a different layer when the user performs a scrolling operation to move a display area, an artifact occurs at the boundary between the tile images. As a result, there is a likelihood that an accurate analysis is hindered.

The present invention has been made in view of the above circumstances and has an object of providing a technology for improving user's operability and convenience when a user observes an image data set having a plurality of layers on a screen.

The present invention in its first aspect provides an image processing method for generating display image data, which is to be displayed on a display apparatus, based on an image data set of an object, the image data set having image data of one or more layers different in depth position for each of a plurality of areas of the object, the method comprising:

acquiring an operation instruction to change a display area from a state in which first image data of a first area is being displayed to a state in which image data of a second area is to be displayed;

acquiring thickness information indicating an existence range of the object in a depth direction;

selecting second image data, which is to be displayed after the display area is changed, from among the image data of the one or more layers of the second area, based on the thickness information of the object; and

generating display image data from the second image data to be output.

The present invention in its second aspect provides a non-transitory computer readable storage medium storing a program for causing a computer to execute respective steps of an image processing method for generating display image data, which is to be displayed on a display apparatus, based on an image data set of an object, the image data set having image data of one or more layers different in depth position for each of a plurality of areas of the object, the method including:

acquiring an operation instruction to change a display area from a state in which first image data of a first area is being displayed to a state in which image data of a second area is to be displayed;

acquiring thickness information indicating an existence range of the object in a depth direction;

selecting second image data, which is to be displayed after the display area is changed, from among the image data of the one or more layers of the second area, based on the thickness information of the object; and

generating display image data from the second image data to be output.

The present invention in its third aspect provides an image processing apparatus for generating display image data, which is to be displayed on a display apparatus, based on an image data set of an object, the image data set having image data of one or more layers different in depth position for each of a plurality of areas of the object, the image processing apparatus comprising:

an instruction information acquisition unit that acquires an operation instruction to change a display area from a state in which first image data of a first area is being displayed to a state in which image data of a second area is to be displayed;

a thickness information acquisition unit that acquires thickness information indicating an existence range of the object in a depth direction;

a selection unit that selects second image data, which is to be displayed after the display area is changed, from among the image data of the one or more layers of the second area based on the thickness information of the object; and

a generation unit that generates display image data from the second image data.

The present invention in its fourth aspect provides an image processing method for generating display image data, which is to be displayed on a display apparatus, based on an image data set of an object, the image data set having image data of one or more layers different in depth position for each of a plurality of areas of the object, the method comprising:

acquiring an operation instruction to change a display area from a state in which image data of a first area is being displayed to a state in which image data of a second area is to be displayed;

generating third image data to indicate a change in depth position between first image data and second image data when the first image data and the second image data are image data of different layers, the first image data being the image data of the first area currently-displayed, the second image data being the image data of the second area to be displayed after the display area is changed; and

outputting the third image data to the display apparatus.

The present invention in its fifth aspect provides a non-transitory computer readable storage medium storing a program for causing a computer to execute respective steps of an image processing method for generating display image data, which is to be displayed on a display apparatus, based on an image data set of an object, the image data set having image data of one or more layers different in depth position for each of a plurality of areas of the object, the method including:

acquiring an operation instruction to change a display area from a state in which image data of a first area is being displayed to a state in which image data of a second area is to be displayed;

generating third image data to indicate a change in depth position between first image data and second image data when the first image data and the second image data are image data of different layers, the first image data being the image data of the first area currently-displayed, the second image data being the image data of the second area to be displayed after the display area is changed; and

outputting the third image data to the display apparatus.

The present invention in its sixth aspect provides an image processing apparatus for generating display image data, which is to be displayed on a display apparatus, based on an image data set of an object, the image data set having image data of one or more layers different in depth position for each of a plurality of areas of the object, the image processing apparatus comprising:

an acquisition unit that acquires an operation instruction to change a display area from a state in which image data of a first area is being displayed to a state in which image data of a second area is to be displayed;

a generation unit that generates third image data to indicate a change in depth position between first image data and second image data when the first image data and the second image data are image data of different layers, the first image data being the image data of the first area currently-displayed, the second image data being the image data of the second area to be displayed after the display area is changed; and

an output unit that outputs the third image data to the display apparatus.

According to an embodiment of the present invention, it is possible to improve user's operability and convenience when a user observes an image data set having a plurality of layers on a screen.

Further features of the present invention will become apparent from the following description of exemplary embodiments with reference to the attached drawings.

### BRIEF DESCRIPTION OF THE DRAWINGS

FIG. 1 is the whole diagram of the apparatus configuration of an image processing system according to a first embodiment;

FIG. 2 is a function block diagram of an imaging apparatus according to the first embodiment;

FIG. 3 is a function block diagram of an image processing apparatus according to the first embodiment;

FIG. 4 is a hardware configuration diagram of the image processing apparatus according to the first embodiment;

FIG. 5 is a schematic diagram showing the relationship between a test sample and the acquisition position of tile image data;

FIGS. 6A to 6C are diagrams showing the configuration of an image data set;

FIGS. 7A and 7B are conceptual diagrams of a layer selection method at scrolling according to the first embodiment;

FIG. 8 is a flowchart showing the flow of image display processing according to the first embodiment;

FIG. 9 is a flowchart showing the details of step S802 of FIG. 8;

FIG. 10 is a diagram showing an example of a screen for setting a user setting list according to the first embodiment;

FIG. 11 is a diagram showing an example of the screen display of user setting information according to the first embodiment;

FIG. 12 is a flowchart showing the details of step S804 of FIG. 8;

FIG. 13 is a diagram showing a layout example of a display screen according to the first embodiment;

FIG. 14 is the whole diagram of the apparatus configuration of an image processing system according to a second embodiment;

FIG. 15 is a conceptual diagram for selecting a layer within the depth of field according to the second embodiment;

FIG. 16 is a flowchart showing the flow of exception processing according to the second embodiment;

FIGS. 17A and 17B are diagrams showing an example of the switching display of an image according to the second embodiment;

FIGS. 18A to 18D are conceptual diagrams showing the boundary between tile image data according to a third embodiment;

FIG. 19 is a flowchart showing the flow of boundary display processing according to the third embodiment;

FIG. 20 is a function block diagram of an image processing apparatus according to a fourth embodiment;

FIGS. 21A and 21B are schematic diagrams showing interpolation display image data according to the fourth embodiment;

FIG. 22 is a flowchart showing the flow of image display processing according to the fourth embodiment;

FIG. 23 is a flowchart showing the details of step S2220 of FIG. 22;

FIGS. 24A and 24B are conceptual diagrams of the generation of a plurality of images different in in-focus degree according to the fourth embodiment;

FIG. 25 is a flowchart showing the details of step S2301 of FIG. 23;

FIGS. 26A and 26B are conceptual diagrams of the generation of a time-divided-display Z-stack image according to a fifth embodiment;

FIG. 27 is a flowchart of time-divided-display data setting processing according to the fifth embodiment;

FIGS. 28A and 28B are diagrams showing an example of the switching display of an image according to the fifth embodiment;

FIG. 29 is a function block diagram of an image processing apparatus according to a sixth embodiment;

FIG. 30 is a diagram showing an example of the setting screen of a user setting list according to the sixth embodiment;

FIG. 31 is a diagram showing a layout example of a display screen according to the sixth embodiment;

FIGS. 32A to 32C are conceptual diagrams of the generation of input data according to a seventh embodiment; and

FIG. 33 is a flowchart showing the flow of the generation of input data according to the seventh embodiment.

### DESCRIPTION OF THE EMBODIMENTS

### First Embodiment

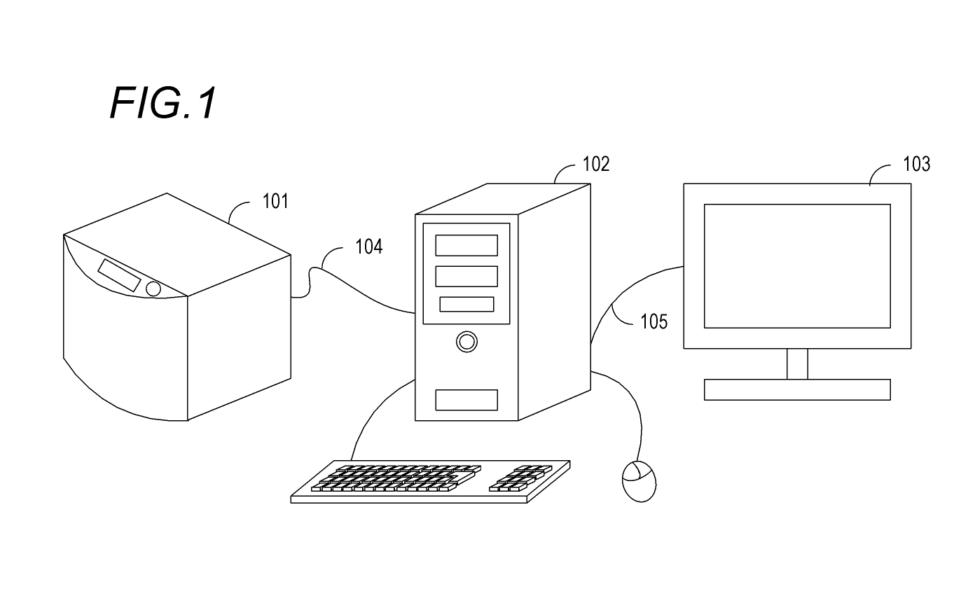

A first embodiment describes an example in which an image processing method and an image processing apparatus according to the present invention are applied to an image processing system having an imaging apparatus and a display apparatus. A description will be given of the image processing system with reference to FIG. 1.

(Apparatus Configuration of Image Processing System)

FIG. 1 shows the image processing system according to a first embodiment of the present invention. The system is constituted by an imaging apparatus (a microscope apparatus or a virtual slide apparatus) 101, an image processing apparatus 102, and a display apparatus 103 and has the function of acquiring and displaying a two-dimensional image of a slide (test sample).

The imaging apparatus 101 and the image processing apparatus 102 are connected to each other by a dedicated or general-purpose I/F cable 104, and the image processing apparatus 102 and the display apparatus 103 are connected to each other by a general-purpose I/F cable 105.

As the imaging apparatus 101, a virtual slide apparatus may be used that has the function of dividing the XY plane of a slide into a plurality of areas, picking up images of the respective areas, and outputting a plurality of two-dimensional images (digital images). A solid-state image pick-up device such as a charge coupled device (CCD) and a complementary metal oxide semiconductor (CMOS) is used to acquire two-dimensional images. Note that instead of the virtual slide apparatus, the imaging apparatus 101 may be constituted by a digital microscope apparatus in which a digital camera is attached to the eyepiece of a normal optical microscope.

The image processing apparatus 102 is an apparatus having the function of generating image data to be displayed on the display apparatus 103 in response to a user's request based on an image data set acquired by the imaging apparatus 101. Here, as the image processing apparatus 102, a general-purpose computer or a workstation is assumed that has hardware resources such as various interfaces including a central processing unit (CPU), a RAM, a storage unit, and an operation unit. The storage unit is a high-capacity information storage unit such as a hard disk drive and stores a program, data, an operating system (OS), or the like to implement respective processing that will be described later. The respective functions described above are implemented when the CPU loads a program and data for the RAM from the storage unit and executes the same. The operation unit is constituted by a keyboard, a mouse, or the like and used when an operator inputs various instructions.

In addition, the image processing apparatus 102 may receive image data from any apparatus other than the imaging apparatus 101. For example, the image processing apparatus 102 may receive image data from an imaging apparatus such as a digital camera, an X-ray camera, a CT, an MRI, a PET, an electron microscope, a mass microscope, an operation-type probe microscope, a ultrasonic microscope, a fundus camera, an endoscope, and a scanner.

The display apparatus 103 is a display that displays an observation image as a result calculated by the image processing apparatus 102 and is constituted by a CRT, a liquid crystal display, a projector, or the like.

In the example of FIG. 1, the image processing system is constituted by the three apparatuses of the imaging apparatus 101, the image processing apparatus 102, and the display apparatus 103. However, the configuration of the present invention is not limited to this configuration. For example, the image processing apparatus integrated with the display apparatus may be used, or some of or all the functions of the image processing apparatus may be embedded in the imaging apparatus. In addition, one apparatus may implement the functions of the imaging apparatus, the image processing apparatus, and the display apparatus. Conversely, a plurality of apparatuses may implement the divided functions of the respective apparatuses constituting the system.

(Function Blocks of Image Pick-Up Apparatus)

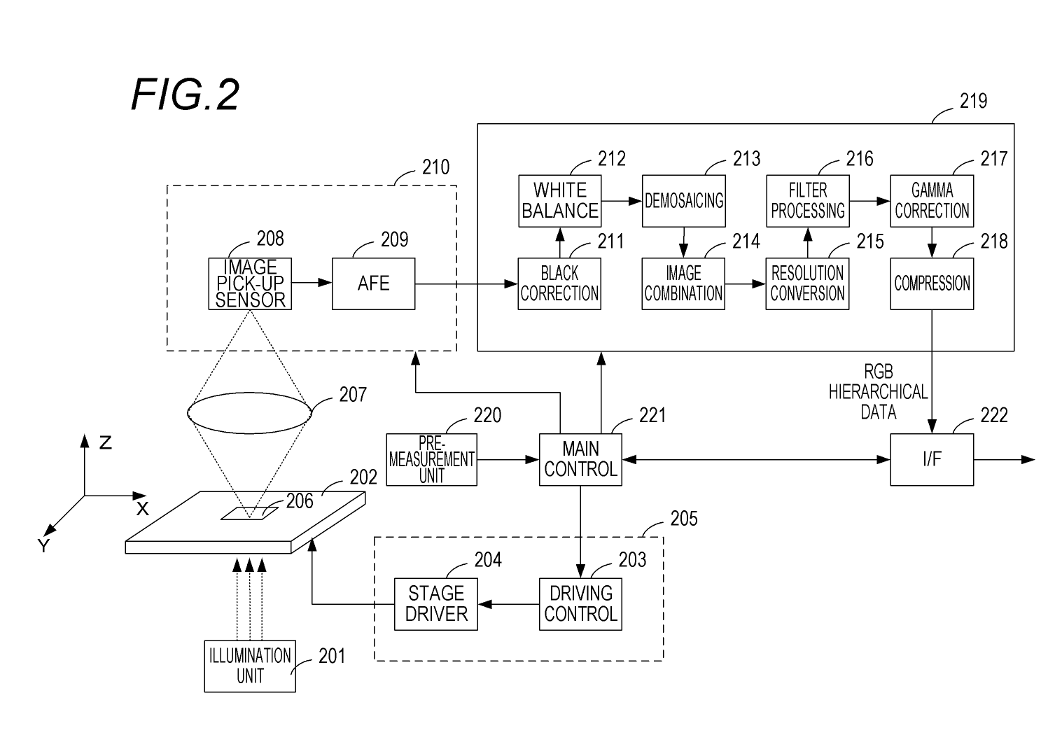

FIG. 2 is a block diagram showing the function configuration of the imaging apparatus 101.

The imaging apparatus 101 is generally constituted by an illumination unit 201, a stage 202, a stage control unit 205, an image forming optical system 207, an image pick-up unit 210, a development processing unit 219, a pre-measurement unit 220, a main control system 221, and a data output unit 222.

The illumination unit 201 is a unit that evenly applies light onto a slide 206 arranged on the stage 202 and is constituted by a light source, an illumination optical system, and a control system for driving the light source. The stage 202 is driven and controlled by the stage control unit 205 and capable of moving three X, Y, and Z axial directions. The slide 206 is a member in which the segments of tissues to be observed or smeared cells are placed on a slide glass and that is fixed beneath a cover glass with a mounting medium.

The stage control unit 205 is constituted by a driving control system 203 and a stage driving mechanism 204. The driving control system 203 drives and controls the stage 202 upon receiving an instruction from the main control system 221. The moving direction, the moving amount, or the like of the stage 202 is determined based on the position information and the thickness information (or the distance information) of a test sample measured by the pre-measurement unit 220 and an instruction from a user where necessary. The stage driving mechanism 204 drives the stage 202 in response to an instruction from the driving control system 203.

The image forming optical system 207 is a lens group that forms an optical image of a test sample placed on the slide 206 onto an image pick-up sensor 208.

The image pick-up unit 210 is constituted by the image pick-up sensor 208 and an analog front end (AFE) 209. The image pick-up sensor 208 is a one-dimensional or two-dimensional image sensor that converts a two-dimensional optical image into an electric physical amount through photoelectric conversion, and a CCD or a CMOS device is, for example, used as such. In the case of the one-dimensional sensor, a two-dimensional image is obtained by scanning in a scanning direction. The image pick-up sensor 208 outputs an electric signal having a voltage value corresponding to the intensity of light. When it is desired to obtain a color image as an image pick-up image, a single-plate image sensor having a Bayer-arrangement color filter may be, for example, used. The image pick-up unit 210 picks up a divided image of a test sample when the stage 202 drives in an XY axis direction corresponding to a two-dimensional plane orthogonal to an optical axis.

The AFE 209 is a circuit that converts an analog signal output from the image pick-up sensor 208 into a digital signal. The AFE 209 is constituted by an H/V driver, a correlated double sampling (CDS), an amplifier, an AD converter, and a timing generator. The H/V driver converts a vertical sync signal and a horizontal sync signal for driving the image pick-up sensor 208 into potentials for driving the sensor. The CDS is a correlated double sampling circuit that eliminates noise having a fixed pattern. The amplifier is an analog amplifier that regulates the gain of an analog signal from which noise is eliminated by the CDS. The AD converter converts an analog signal into a digital signal. When the last output of the imaging apparatus 101 is of 8 bits, the AD converter converts an analog signal into digital data quantized from about 10 bits to 16 bits and outputs the same in consideration of the following processing. The converted sensor output data is called RAW data. The RAW data is developed by the following development processing unit 219. The timing generator generates signals for regulating the timing of the image pick-up sensor 208 and the timing of the following development processing unit 219.

When a CCD is used as the image pick-up sensor 208, the AFE 209 is mandatory. However, when a CMOS image sensor allowing a digital output is used, it is required to have the function of the AFE 209. In addition, although not shown in the figures, an image pick-up control unit that performs the control of the image pick-up sensor 208 exists. The image pick-up control unit also performs the operation control of the image pick-up sensor 208, regulates an operation timing for a shutter speed, a frame rate, and a region of interest (ROI), and performs image pick-up control.

The development processing unit 219 is constituted by a black correction unit 211, a white balance regulation unit 212, a demosaicing processing unit 213, an image combination processing unit 214, a resolution conversion processing unit 215, a filter processing unit 216, a γ correction unit 217, and a compression processing unit 218. The black correction unit 211 performs processing to subtract black correction data obtained at light-shielding time from the respective pixels of RAW data. The white balance regulation unit 212 performs processing to regulate the gains of respective RGB colors according to the color temperature of the light of the illumination unit 201 to reproduce a desired white color.

Specifically, white balance correction data is added to RAW data having been subjected to black correction. When a single-color image is handled, the white balance regulation processing is not required. The development processing unit 219 generates hierarchical image data that will be described later from the tile image data of a test sample picked up by the image pick-up unit 210.

The demosaicing processing unit 213 performs processing to generate the image data of the respective RGB colors from the RAW data having a Bayer arrangement. The demosaicing processing unit 213 interpolates the values of peripheral pixels (including pixels having the same color and pixels having different colors) in RAW data to calculate the values of the respective RGB colors of target pixels. In addition, the demosaicing processing unit 213 performs processing (interpolation processing) to correct defective pixels. Note that when the image pick-up sensor 208 does not have a color filter and a single-color image is obtained, the demosaicing processing is not required. In addition, when RGB-independent image data is allocated to a plurality of image sensors to pick up an image as in a 3 CCD, the demosaicing processing unit 213 is not required.

The image combination processing unit 214 performs processing to combine together tile image data obtained by dividing an image pick-up range with the image pick-up sensor 208 to generate high-capacity image data in a desired image pick-up range. In general, since the existence range of a test sample is wider than an image pick-up range that may be acquired by an existing image sensor in a single image pick-up, the two-dimensional image data of one layer (at a depth position) is generated by combining a plurality of divided tile image data together. For example, when it is assumed that an image of a 15 mm×15 mm range on the slide 206 is picked up at a resolution of 0.25 μm, one side of the range has 60,000 pixels (15 mm/0.25 μm) and the range has 3,600,000,000 pixels in total (60,000×60,000). In order to acquire the image data of 3,600,000,000 pixels using the image pick-up sensor 208 having a pixel number of 10 M (10,000,000 pixels), it is required to divide the range into 360 (3,600,000,000/10,000,000) areas to pick up an image. Note that examples of a method of combining a plurality of tile image data together include a method of performing positioning based on the position information of the stage 202 to combine the tile image data together, a method of connecting the corresponding points or lines of the plurality of tile images together, and a method of combining the tile image data together based on the position information of the tile image data. The tile image data may be smoothly combined together by interpolation processing such as zero-order interpolation, linear interpolation, and high-order interpolation. Although it is assumed in the embodiment that one high-capacity image is generated in the imaging apparatus 101, the image processing apparatus 102 may have the function of combining divided tile image data together at the time of generating display image data.

The resolution conversion processing unit 215 performs processing to generate an image corresponding to a display magnification in advance through resolution conversion in order to display a high-capacity two-dimensional image generated by the image combination processing unit 214 at a high speed. The resolution conversion processing unit 215 generates a plurality of levels of image data from a low magnification to a high magnification to be constituted as image data (hierarchical image data) having a bundled hierarchical structure. Image data acquired by the imaging apparatus 101 is desirably high-definition and high-resolution image pick-up data for diagnosis. However, when image data having multibillion pixels as described above is displayed at a reduced scale, the processing is not successfully performed in time if the resolution is converted on a case-by-case basis to suit a request for the display. Therefore, it is desirable to prepare several levels of hierarchical images different in magnification in advance, select image data at a magnification close to a display magnification from among the prepared hierarchical images according to a request from a display side, and regulate the magnification to suit the display magnification. In general, it is preferable to generate display data from high-magnification image data from the viewpoint of image quality. In order to pick up an image at a high resolution, display hierarchical image data is generated by reducing image data having the highest resolution based on a resolution conversion method. As a method of converting the resolution, bicubic using a third-order interpolation formula besides bilinear as two-dimensional linear interpolation has been widely known.

The filter processing unit 216 is a digital filter that implements reduction in high frequency component contained in an image, noise elimination, and a resolution-feeling emphasis. The γ correction unit 217 performs processing to add reverse characteristics to an image to suit the gradation expression characteristics of a general display device or processing to convert gradation to suit human's visual characteristics through the gradation compression of a high brightness unit or dark processing. In the embodiment, the gradation conversion suitable for the following display processing is applied to image data to acquire an image whose shape is to be observed.

The compression processing unit 218 performs coding processing for still-image compression to improve the efficiency of the transmission of high-capacity two-dimensional image data and reduce capacity for storing the image data. As a method of compressing a still image, standardized coding methods such as joint photographic experts group (JPEG) and JPEG2000 and JPEG XR created as improved and advanced coding methods of the JPEG have been widely known in general.

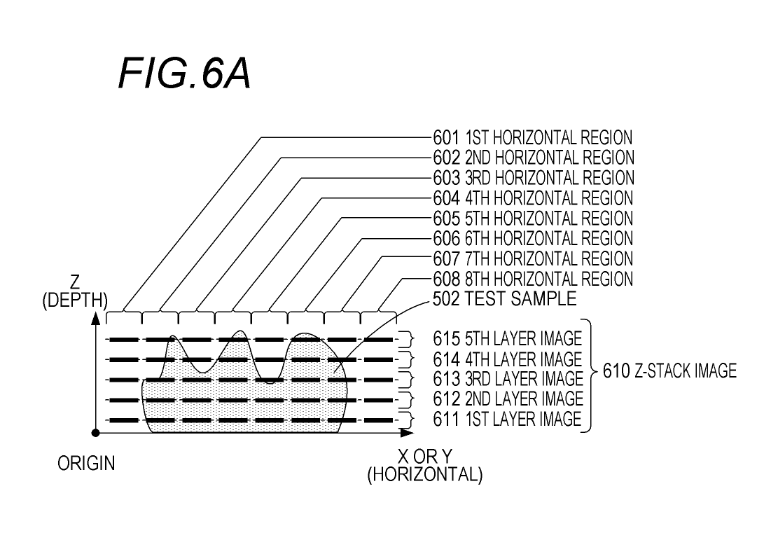

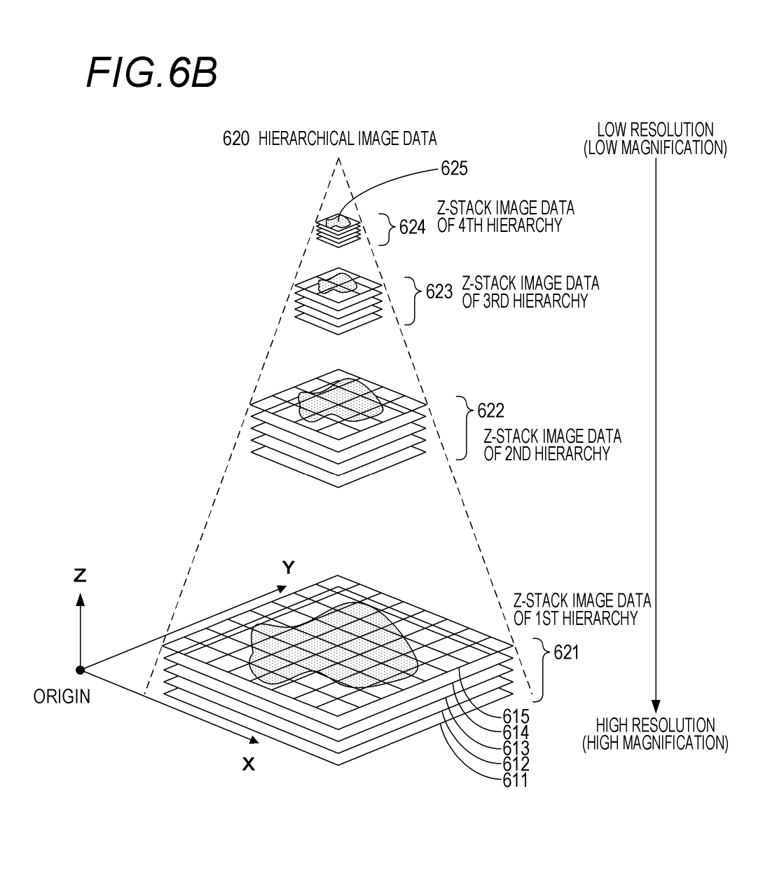

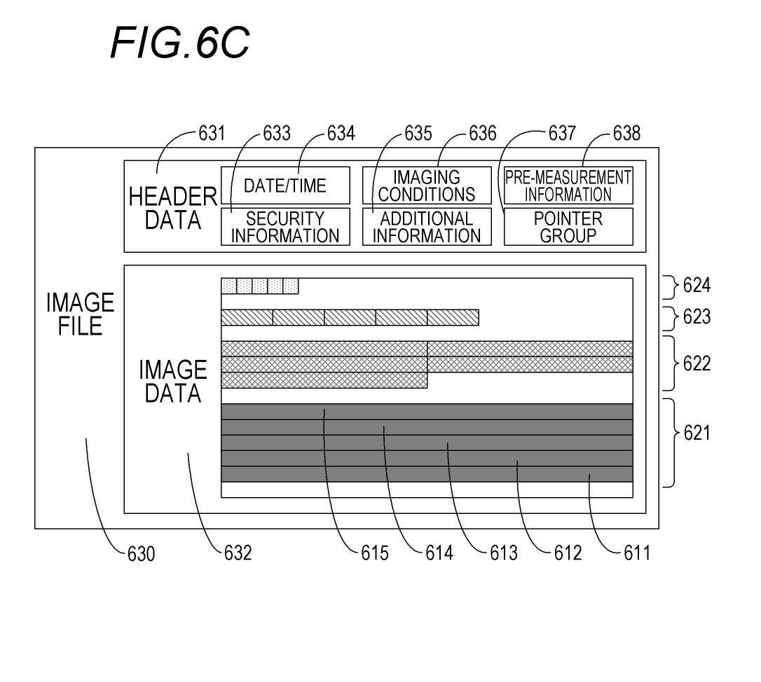

In addition, in the two-dimensional image data of hierarchical image data, each hierarchy is divided into a plurality of tile image data for data transmission and improvement in the efficiency of JPEG decoding at the time of displaying the two-dimensional data. Note that although the previous description expresses an acquired divided image as a tile image, an image further divided for a display besides the tile image is also called a tile image and the data of the tile image is called tile image data. The details of the configuration of the hierarchical image data will be described with reference to FIGS. 6A and 6B.

The pre-measurement unit 220 is a unit that performs pre-measurement to calculate the position information of a test sample on the slide 206, the information of a distance to a desired focal position, and parameters for regulating a light amount resulting from the thickness of the test sample. Information is acquired by the pre-measurement unit 220 before actual measurement (acquisition of the data of a picked-up image) to determine the image pick-up position of the actual measurement, whereby an optimal image pick-up is made possible. In order to acquire the information of the position of a two-dimensional plane, a two-dimensional image pick-up sensor lower in resolution than the image pick-up sensor 208 is used. The pre-measurement unit 220 finds the position of a test sample on the XY plane from an acquired image. In order to acquire distance information and thickness information, a laser displacement gauge or a Shack-Hartmann sensor is used.

The main control system 221 has the function of controlling the various units described above. The control functions of the main control system 221 and the development processing unit 219 are implemented by a control circuit having a CPU, a ROM, and a RAM. That is, the ROM stores a program and data, and the CPU uses the RAM as a work memory to execute the program to implement the functions of the main control system 221 and the development processing unit 219. A device such as an EEPROM and a flash memory is, for example, used as the ROM, and a DRAM device such as a DDR3 is, for example, used as the RAM. Note that the function of the development processing unit 219 may be replaced with a device formed in an ASIC as a dedicated hardware device.

The data output unit 222 is an interface that transmits an RGB color image generated by the development processing unit 219 to the image processing apparatus 102. The imaging apparatus 101 and the image processing apparatus 102 are connected to each other by an optical fiber cable. Alternatively, a general-purpose interface such as a USB and GigabitEthernet™ is used.

(Function Blocks of Image Processing Apparatus)

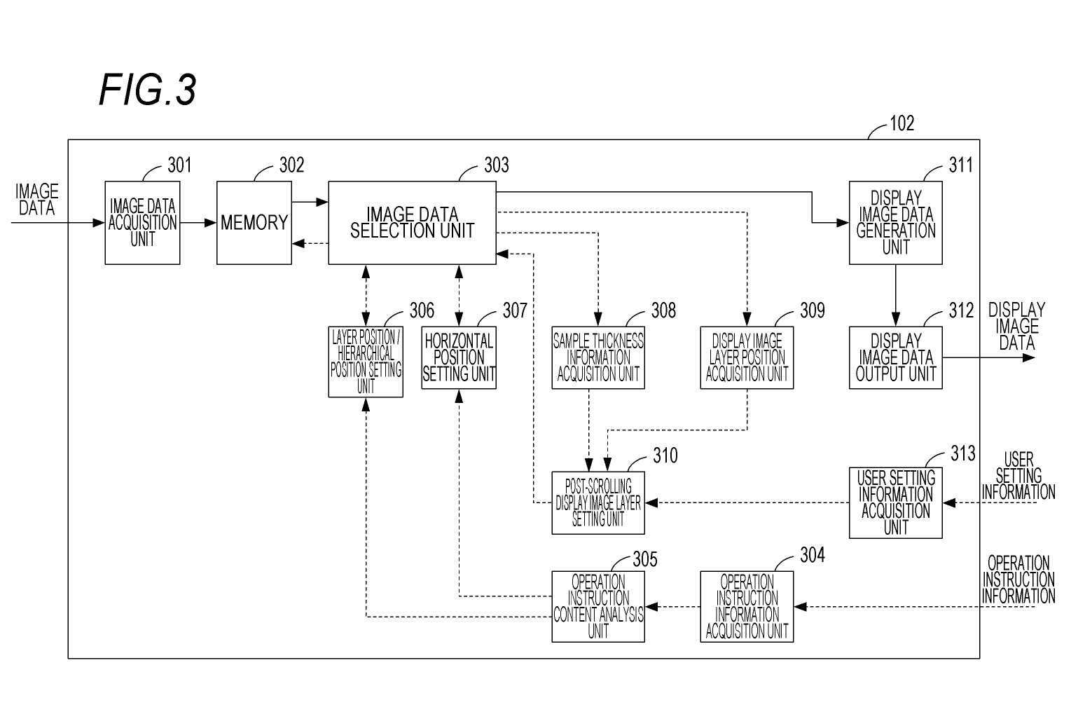

FIG. 3 is a block diagram showing the function configuration of the image processing apparatus 102 according to the first embodiment.

The image processing apparatus 102 has an image data acquisition unit 301, a storage retention unit (memory) 302, an image data selection unit 303, an operation instruction information acquisition unit 304, an operation instruction content analysis unit 305, a layer-position/hierarchical-position setting unit 306, and a horizontal position setting unit 307. In addition, the image processing apparatus 102 has a test-sample thickness information acquisition unit 308, a display image layer position acquisition unit 309, a post-scrolling display image layer setting unit 310, a display image data generation unit 311, a display image data output unit 312, and a user setting data information acquisition unit 313.

The image data acquisition unit 301 acquires image data picked up by the imaging apparatus 101. Here, the image data indicates at least any of RGB tile image data obtained by a divided image pick-up, one two-dimensional image data in which tile image data is combined together, and image data (hierarchical image data that will be described later) hierarchized for each display magnification based on two-dimensional image data. Note that the tile image data may be monochrome image data. In addition, a Z-stack image constituted by a plurality of layer images is assumed here.

In addition, the pixel pitch of the image pick-up sensor 208 and the magnification information and the in-focus information of an objective lens, which are conditions for image pick-up specifications and image pick-up time, may be added to the image data.

Here, it is defined that the in-focus information is information indicating the in-focus degree of the image data. The in-focus degree may be evaluated by, for example, the contrast value of an image. In the specification, a state in which the in-focus degree is higher than a prescribed reference (threshold) will be called “in-focus,” while a state in which the in-focus degree is lower than the reference will be called “non-focus.” In addition, among a plurality of layer images in the same area (same XY range) of a subject, images in focus will be called “in-focus images.” Moreover, among the in-focus images, an image having the highest in-focus degree will be called a “most in-focus image.”

The storage retention unit 302 imports tile image data acquired from an external apparatus via the image data acquisition unit 301 and stores and retains the same.

The operation instruction information acquisition unit 304 acquires input information from the user via an operation unit such as a mouse and a keyboard and outputs the same to the operation instruction content analysis unit 305. The input information includes, for example, an instruction to update display image data such as changing a display area and zooming in/out the display area.

The operation instruction content analysis unit 305 analyzes the user's input information acquired by the operation instruction information acquisition unit 304 and generates various parameters on the operation instruction as to how the user has operated the operation unit (a scrolling operation, a scaling operation, a layer position switching operation, and each operation direction). The generated parameters are output to the layer position/hierarchical position setting unit 306 or the horizontal position setting unit 307. At the same time, the operation instruction content analysis unit 305 determines the output of the parameters to both the setting units.

The layer position/hierarchical position setting unit 306 determines the switching or the display magnification of a layer image based on various setting parameters on an operation instruction (an instruction to move between layers or an instruction to zoom in/out a display). Then, the layer position/hierarchical position setting unit 306 sets layer position information and hierarchical position information to acquire tile image data from the determined result and outputs the same to the image data selection unit 303.

The layer position information and the hierarchical position information of the picked-up tile image data required for the setting are acquired from the storage retention unit 302 via the image data selection unit 303.

The horizontal position setting unit 307 calculates the display position of an image in a horizontal direction based on setting parameters on an operation instruction (to change a position in the horizontal direction). Then, the horizontal position setting unit 307 sets horizontal position information for acquiring the tile image data and outputs the same to the image data selection unit 303. The information required for the setting is acquired as in the layer position/hierarchical position setting unit 306.

The image data selection unit 303 selects the tile image data to be displayed from the storage retention unit 302 and outputs the same. The tile image data to be displayed is selected based on the layer position and the hierarchical position set by the layer position/hierarchical position setting unit 306, the horizontal position set by the horizontal position setting unit 307, and the layer position set by the post-scrolling display image layer setting unit 310. In addition, the image data selection unit 303 has the function of acquiring the information required for the settings by the layer position/hierarchical position setting unit 306, the horizontal position setting unit 307, and the post-scrolling display image layer setting unit 310 from the storage retention unit 302 and transferring the same to the respective setting units.

The test-sample thickness information acquisition unit 308 acquires the thickness information of a test sample from the storage retention unit 302 via the image data selection unit 303 and outputs the same to the post-scrolling display image layer setting unit 310. The thickness information is information indicating the existence range of the test sample in a depth direction (Z direction).

The display image layer position acquisition unit 309 acquires the layer position (depth position in the Z direction) of the currently-displayed tile image data and outputs the same to the post-scrolling display image setting unit 310.

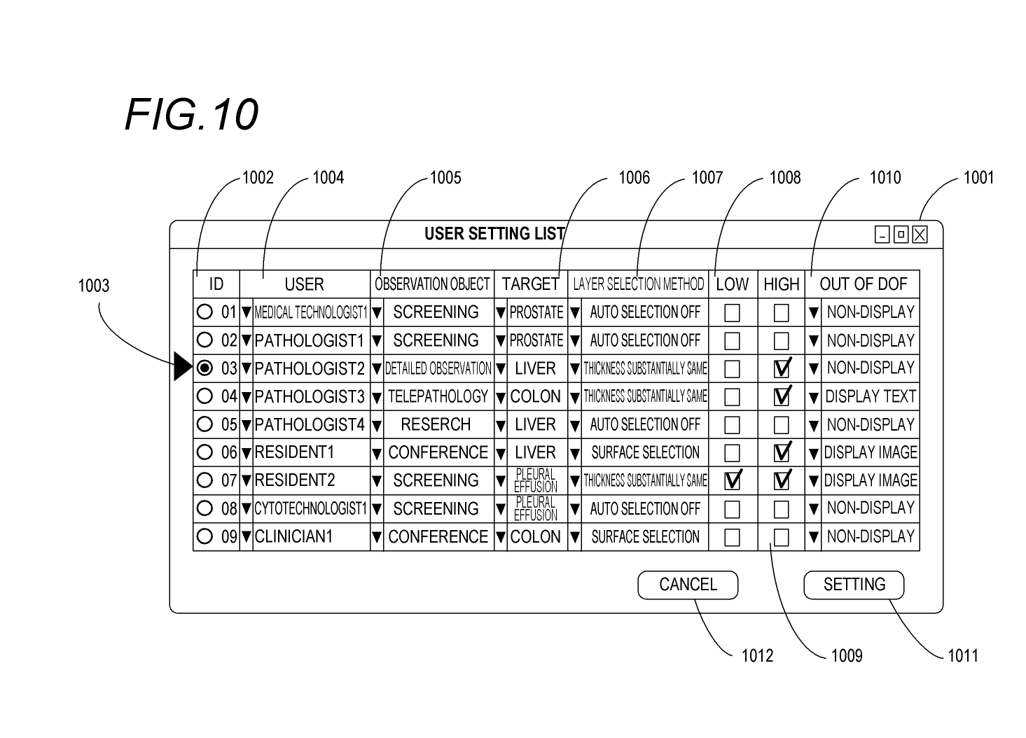

The post-scrolling display image layer setting unit 310 sets the layer position of the tile image data to be displayed after scrolling based on the thickness information acquired by the test-sample thickness information acquisition unit 308 and outputs the same to the image data selection unit 303. At this time, the post-scrolling display image layer setting unit 310 selects the layer position to be displayed after the scrolling according to setting contents (selection conditions) for layer selection acquired by the user setting data information acquisition unit 313. In addition, the post-scrolling display image layer setting unit 310 considers, where necessary, the layer position of a currently-displayed image (i.e., a pre-scrolling image) acquired by the display image layer position acquisition unit 309. The setting contents acquired by the user setting data information acquisition unit 313 will be described later with reference to FIG. 10.

The display image data generation unit 311 generates display data to be displayed on the display apparatus 103 based on the image data acquired from the image data selection unit 303 and outputs the same to the display image data output unit 312.

The display image data output unit 312 outputs the display image data generated by the display image data generation unit 311 to the display apparatus 103 serving as an external apparatus.

(Hardware Configuration of Image Processing Apparatus)

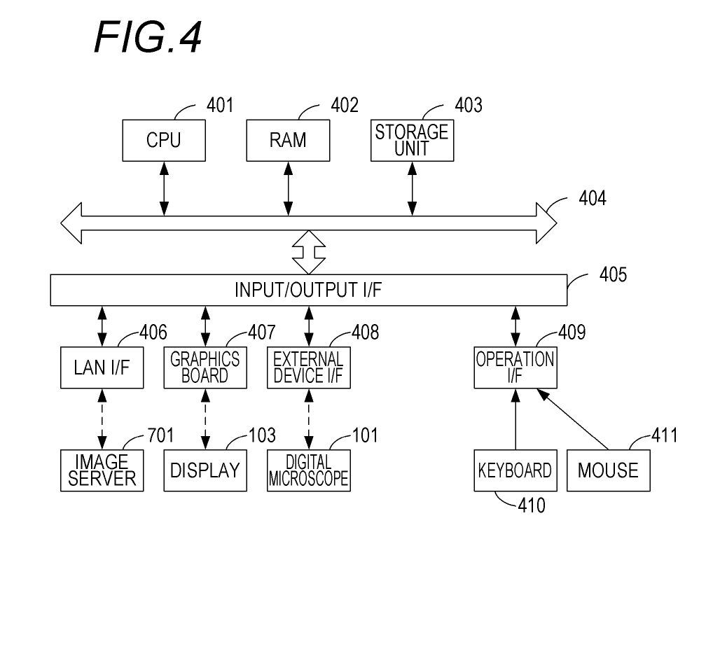

FIG. 4 is a block diagram showing the hardware configuration of the image processing apparatus.

As an apparatus that performs image processing, a personal computer (PC) is, for example, used. The PC has a central processing unit (CPU) 401, a random access memory (RAM) 402, a storage unit 403, a data input/output I/F 405, and an internal bus 404 that connects these components to each other.

The CPU 401 appropriately accesses the RAM 402 or the like where necessary and entirely controls the respective blocks of the PC while performing calculation processing.

The RAM 402 is used as the work area or the like of the CPU 401 and temporarily stores an OS, various running programs, and various data to be processed for generating display data considering an observation object and an observation object as a feature of the embodiment.

The storage unit 403 is an auxiliary storage unit that stores and reads an OS executed by the CPU 401 and information in which firmware such as a program and various parameters is fixedly stored. As such, a magnetic storage medium such as a hard disk drive (HDD) or a semiconductor device using a flash memory such as a solid state disk (SSD) is used.

To the data input/output I/F 405 are connected an image server 701 via a LAN I/F 406, the display apparatus (display) 103 via a graphics board 407, and the imaging apparatus 101 as represented by a virtual slide apparatus or a digital microscope via an external apparatus I/F 408. In addition, to the data input/output I/F 405 are connected a keyboard 410 and a mouse 411 via an operation I/F 409.

The display apparatus 103 is a display apparatus using, for example, a liquid crystal, an electro-luminescence (EL), a cathode ray tube (CRT), or the like. The display apparatus 103 is assumed to be connected as an external apparatus, but a PC is assumed to be integrated with the display apparatus. For example, a notebook PC is applicable as such.

Pointing devices such as the keyboard 410 and the mouse 411 are assumed as the connection devices of the operation I/F 409, but a configuration as in a touch panel in which the screen of the display apparatus 103 directly serves as an input device is applicable. In this case, the touch panel may be integrated with the display apparatus 103.

(Relationship Between Slide and Acquisition Position of Tile Image)

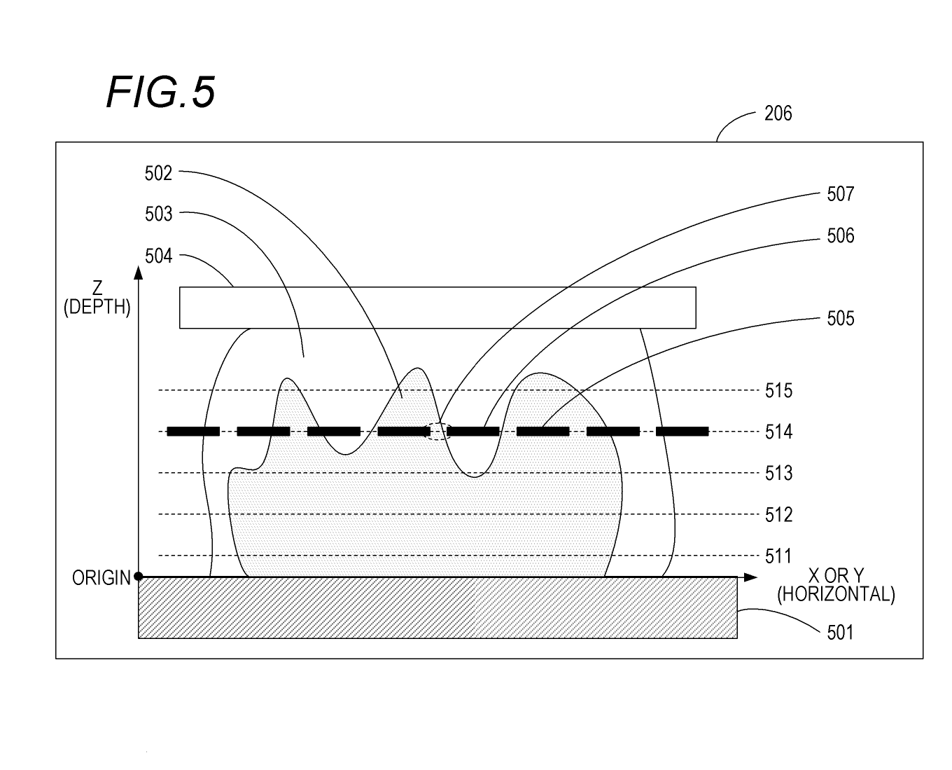

FIG. 5 is a schematic diagram for describing the relationship between the slide 206 and the acquisition position of tile image data. Note that a Z axis indicates an optical axis direction, and X and Y axes indicate an axis orthogonal to an optical axis.

The slide 206 is a member in which a test sample 502 serving as a subject is placed on a slide glass 501 and that is fixed beneath a cover glass 504 with a mounting medium 503. The test sample 502 is a transmission object having a thickness of about several μm to several hundred μm.

In FIG. 5, the optical axis direction of the slide 206 is indicated as the Z axis (depth direction), and a plurality of layers different in depth position is expressed by layer positions 511 to 515. The respective layer positions 511 to 515 express the focal position of an image forming optical system on a subject side.

FIG. 5 shows the cross section of the slide 206 based on an XZ plane or a YZ plane. It is shown in FIG. 5 that the test sample 502 fixed onto the slide 206 is different in existence position in its thickness direction, i.e., the test sample 502 has different thicknesses.

FIG. 5 shows an example in which an image of the test sample 502 is picked up in a divided way with the focal position fixed at the depth of the layer position 514 to acquire eight tile image data (indicated by bold lines). Since the focal position of tile image data 505 exists inside the test sample 502, the tile image data 505 is handled as in-focus image data. Since the focal position of tile image data 506 does not exist inside the test sample 502, some or all regions of the tile image data 506 are handled as non-focus image data.

Boundaries 507 between the tile image data indicate the boundary positions between the respective tile image data. In the example of FIG. 5, gaps are provided to clearly show the boundaries between the tile image data. However, the tile image data is actually in a continuous form without having the gaps therebetween, or regions acquired in a divided way overlap each other. In the following description, it is assumed that there are no gaps between the tile image data acquired in a divided way.

As described above, the plurality of tile image data different in XY position is retained. Therefore, when a scrolling operation is performed to move a display area in a horizontal direction (XY direction) for image observation, a display image is generated using the corresponding tile image data to allow a high-speed display.

(Configuration of Image Data Set)

FIGS. 6A to 6C are diagrams showing a configuration example of an image data set generated when an image of the test sample 502 is picked up. The image data set includes the image data (tile image data) of one or more layers different in depth position for each of the plurality of areas (horizontal regions) of the test sample 502. In the embodiment, the image data set also includes hierarchical image data different in magnification to zoom in/out a display at a high speed. Hereinafter, a description will be given of the relationship between the tile image data, the hierarchical image data, and the data configuration of an image file.

FIG. 6A is a diagram showing the relationship between the positions of the respective areas (horizontal regions) when an image of the test sample 502 is picked up in a divided way, the Z positions (focal positions) of respective layer images constituting Z-stack image data, and the plurality of tile image data. It is shown in FIG. 6A that the image data set of the test sample 502 includes the plurality of tile image data different in the horizontal position (XY position) and the position (Z position) in the optical axis direction.

A first layer image 611 is a tile image group at the focal position (the same position as the layer position 511 shown in FIG. 5) closest to an origin in the Z axis direction. FIG. 6A shows an example in which the layer image 611 is constituted by eight tile image data acquired by picking up an image of the test sample 502 in a first horizontal region 601 to an eighth horizontal region 608. A second layer image 612 is a layer image (at the second-closest position from the origin) different in focal position from the first layer image 611. The focal position becomes shallower in order of a third layer image 613, a fourth layer image 614, and a fifth layer image 615.

Z-stack image data 610 is a group of the plurality of layer images different in focal position. Here, the Z-stack image data 610 is constituted by the five layer images of the first layer image 611, the second layer image 612, the third layer image 613, the fourth layer image 614, and the fifth layer image 615.

In the example of FIG. 6A, the Z-stack image data is acquired regardless of a region in which the test sample 502 exists. However, for example, only the image data of a region in which the test sample 502 exists may be acquired or only a region that exists after the acquisition of the Z-stack image data may be stored.

With the generation of the Z-stack image data as shown in FIG. 6A, it becomes possible for the user to move a display position in the horizontal (XY) and vertical (Z) directions to observe an image of the test sample 502.

FIG. 6B is a schematic diagram showing the structure of the hierarchical image data.

Hierarchical image data 620 is constituted by a plurality of groups of the Z-stack image data different in resolution (the number of pixels). FIG. 6B shows an example in which the hierarchical image data 620 is constituted by four groups of Z-stack image data 621 of a first hierarchy, Z-stack image data 622 of a second hierarchy, Z-stack image data 623 of a third hierarchy, and Z-stack image data 624 of a fourth hierarchy. The image data of the second to fourth hierarchies is generated by resolution-converting the image data having the highest resolution of the first hierarchy.

The Z-stack image data of the respective hierarchies of the hierarchical image data 620 is constituted by the five-layer image data of the first layer image 611 to the fifth layer image 615. In addition, each of the layer images is constituted by the plurality of tile images. The numbers of the layers and the tile image data are for illustration purpose.

Symbol 625 indicates an example of the segment of a tissue or a smeared cell to be observed. In FIG. 6B, the sizes of the images of the same object 625 of the respective hierarchies are shown to facilitate the understanding of the difference between the resolution of the respective hierarchies.

The Z-stack image data 624 of the fourth hierarchy is image data having the lowest resolution and used for a thumbnail image (about less than four times at the magnification of the objective lens of a microscope) indicating the whole test sample 502.

Each of the Z-stack image data 623 of the third hierarchy and the Z-stack image data 622 of the second hierarchy is image data having middle resolution and used for the wide-range observation or the like (about four to 20 times at the magnification of the objective lens of a microscope) of a virtual slide image.

The Z-stack image data 621 of the first hierarchy is image data having the highest resolution and used for the detailed observation (about 40 times or more at the magnification of the objective lens of a microscope) of a virtual slide image.

The layer images of the respective hierarchies are constituted by the plurality of tile image data, and the respective tile image data is subjected to still picture compression. The tile image data is stored in, for example, a JPEG image data format.

One of the layer images of the Z-stack image data 624 of the fourth hierarchy is constituted by one tile image data. One of the layer images of the Z-stack image data 623 of the third hierarchy is constituted by four tile image data. Similarly, one of the layer images of the Z-stack image data 623 of the second hierarchy is constituted by the 16 tile image data, and one of the layer images of the Z-stack image data 623 of the first hierarchy is constituted by 64 tile image data.

The difference in resolution between the respective hierarchical images is based on a difference in optical magnification at observation under a microscope, and the user's observation of the Z-stack image data 624 of the fourth hierarchy on the display apparatus 103 is equivalent to observation under the microscope at a low magnification. Similarly, the observation of the Z-stack image data 621 of the first hierarchy is equivalent to observation under the microscope at a high magnification. When the user intends to observe the test sample 502 in detail, he/she is only required to select any of the layer images of the Z-stack image data 621 of the first hierarchy and display the same on the display apparatus 103.

FIG. 6C is a diagram showing the outline of a data format as the configuration of the image file. The data format of an image file 630 of FIG. 6C is roughly constituted by header data 631 and image data 632.

The header data 631 stores date/time information 634 at which the image file 630 is generated, image pick-up conditions 636, pre-measurement information 638, security information 633, additional information 635, and pointer information 637 of the tile image data constituting the image data 632. The pre-measurement information 638 includes thickness information (for example, a position of the front surface of the test sample 502 in the Z direction) in the respective horizontal positions (positions in the X and Y directions) of the test sample 502 obtained by the pre-measurement unit 220. The security information 633 includes the information of the user who has generated the data, the information of the user capable of viewing the data, or the like. The additional information 635 includes annotation information in which comments are made at image generation or image viewing, or the like. The pointer information 637 is the address information of the tile image data of the image data 632.

The image data 632 is constituted by the hierarchical structure shown in the hierarchical image data 620 of FIG. 6B, and it is shown that image data 621 to 624 corresponds to the hierarchical image data 621 to 624 of FIG. 6B. It is shown that the image data 621 is the Z-stack image data of a first hierarchy. Symbol 611 of the Z-stack image data 621 of the first hierarchy indicates first-layer image data and corresponds to the first layer images 611 of FIGS. 6A and 6B. Similarly, respective layer images 612 to 615 correspond to the layer images of the same symbols of FIGS. 6A and 6B.

The image data 632 is stored in the form of the hierarchical image data (in which the tile image data is compressed) described with reference to FIG. 6B. Here, it is assumed that the image data 632 is compressed in a JPEG format. Other compression formats such as JPEG2000 may be used, or the image data 632 may be stored in a non-compression format such as TIFF. The JPEG header files of the respective tile image data store the in-focus information of the tile image data. In the embodiment, the in-focus information is stored in the header files of the respective tile image data. However, the respective in-focus information of the tile image data may be collectively stored in the header data 631 of the files in combination with the pointer information.

Here, the files are integrated with each other but may be divided and stored in storage media physically different from each other. For example, in the case of a cloud server that manages a plurality of storage media, respective hierarchical data may be allocated to different servers and read where necessary.

With the file configuration described above, the user is not required to read all high-capacity image data as a high-precision image when he/she performs a scroll operation instruction to change a display position, a scaling operation instruction, a layer switching operation instruction, or the like. That is, the user is allowed to perform the switching display of an image at a high speed by appropriately reading and using the tile image data required for the display.

(Selection of Tile Image Data Displayed after Scrolling)

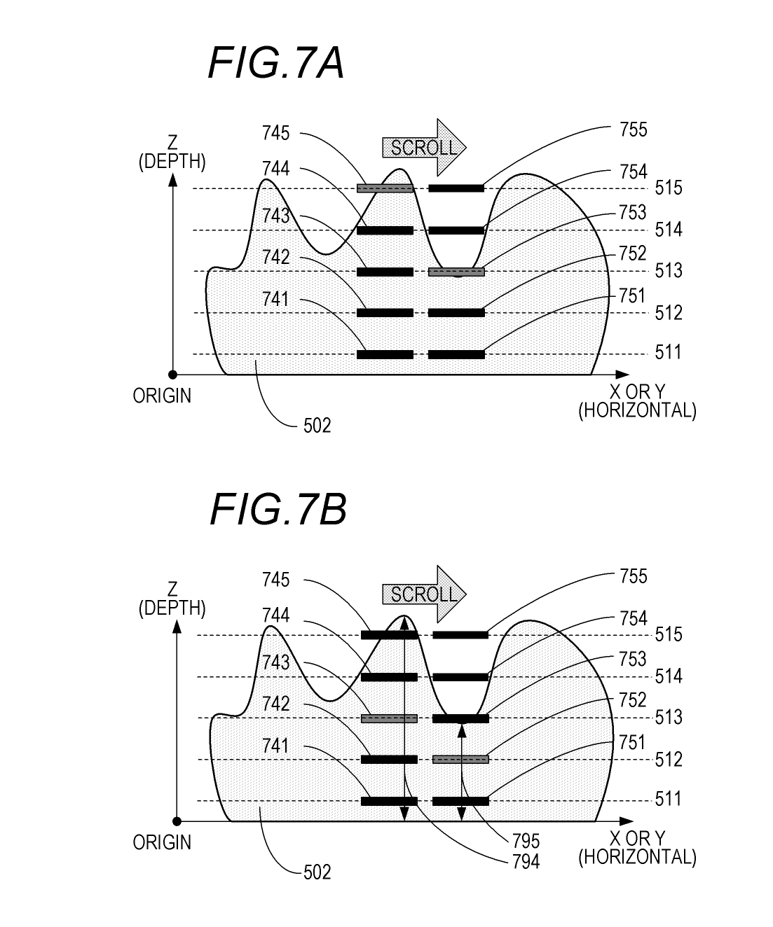

FIGS. 7A and 7B are diagrams showing the concept of the method of switching a display image (a method of selecting a displayed layer position) when the user performs an operation (scrolling) to move the display area of an image in the horizontal direction.

FIG. 7A shows a method suitable for scrolling and successively observing a depth near the front surface of the test sample 502 having different thicknesses (existence ranges in the depth direction) according to the horizontal position.

Here, the front surface of the test sample 502 indicates the periphery of the test sample in the XZ or YZ cross section and indicates the surface of the stump of tissues or cells (the upper end of the existence range of the test sample) contacting a cover glass or a sealant on the side of the cover glass 504. On the side of the slide, the front surface of the test sample 502 indicates the surface of the stump of tissues or cells (the lower end of the existence range of the test sample) contacting the slide or the sealant. In addition, the surface of the test sample 502 that will be described later indicates a layer ranging from the front surface of the test sample 502 within a specific distance, and the thickness of the layer is at 0.5 μm in this example. Note that the thickness of the layer is at a numeric value considering the fact that the thickness of the test sample 502 is at 3 to 5 μm, and is at a different value according to the thickness of the test sample and the specifications of an optical system at image acquisition.

FIG. 7A is a diagram showing partial positions (near the fourth horizontal region and the fifth horizontal region) of FIG. 6A. Tile image data 741 to 745 is the Z-stack image data whose image is picked up with the focal position set at layer positions 511 to 515 of the fourth horizontal region. Tile image data 751 to 755 is the Z-stack image data whose image is picked up with the focal position set at the layer positions 511 to 515 of the fifth horizontal region.

It is assumed that an operation instruction (scrolling in the horizontal direction) is given to display the fifth horizontal region (second area) on the right side in a state in which the tile image data 745 (first image data) of the fourth horizontal region (first area) of FIG. 7A is being displayed.

After the scrolling operation, the tile image data (second image data) to be displayed after the scrolling (after the display area is changed) is selected from among the Z-stack image data (the tile image data 751 to 755) of the fifth horizontal region. In this example, the tile image data 753 closest to the upper end of the existence range of the test sample 502 in the fifth horizontal region is selected.

According to the layer selection method of FIG. 7A, when the display area is moved, the tile image data 753 is automatically selected based on the existence range of the test sample 502 instead of the tile image data 755 of the same layer. The depth between the display images becomes discontinuous with the switching of the layer. However, the convenience of observation is improved since the in-focus image (the clearly-taken image of the test sample 502) is displayed at all times. In addition, even if unevenness or undulations occur on the front surface of the test sample 502, it is possible to easily observe the image with the focal point set near the upper front surface of the test sample 502 while scrolling the same. For example, when a lesion or ROI is distributed over the surface of the test sample 502, this method is really effective.

FIG. 7B shows a method suitable for scrolling and successively observing the positions, at which a relative depth inside the test sample 502 is almost the same, of the test sample 502 having different thicknesses (existence ranges in the depth direction) according to the horizontal position.

It is assumed that an operation instruction (scrolling in the horizontal direction) is given to display the fifth horizontal region (second area) on the right side in a state in which the tile image data 742 (first image data) of the fourth horizontal region (first area) of FIG. 7B is being displayed.

After the scrolling operation, the tile image data (second image data) to be displayed after the scrolling (after the display area is changed) is selected from among the Z-stack image data (the tile image data 751 to 755) in the fifth horizontal region. In this example, the currently-displayed tile image data 742 is placed at nearly the central area of the thickness of the test sample 502. Therefore, in the fifth horizontal region, the tile image data 752 placed at nearly the central area of the thickness of the test sample 502 is selected.

According to the layer selection method of FIG. 7B, when the display area is moved (scrolled in the horizontal direction), the tile image data 752 having nearly the same relative position (relative depth) with respect to the existence range of the test sample 502 is automatically selected instead of the tile image data 753 of the same layer. The depth between the display images becomes discontinuous with the switching of the layer. However, the convenience of observation is improved since the in-focus image (the clearly-taken image of the test sample 502) is displayed at all times. In addition, even if unevenness or undulations occur on the front surface of the test sample 502, it is possible to easily observe the image with the focal point set at a constant relative depth inside the test sample 502 while scrolling the same. For example, when a lesion or ROI is distributed over the middle layer (½, ⅔, or the like of the thickness) of the test sample 502, this method is really effective.

Note that the layer selection methods of FIGS. 7A and 7B are for illustration purpose, and other selection methods may be used. For example, a method of selecting the layer near the lower end of the existence range of the test sample, a method of selecting the layer near a depth with a prescribed distance from the upper end or the lower end of the existence range of the test sample, or the like may be used. In addition, the selection of the layer near the upper end or the lower end of the existence range of the test sample may be based on the premise that the layer position is included in the existence range of the test sample. Alternatively, it may be possible to calculate the in-focus degrees (for example, the contrast values of an image or the like) of the respective tile image data and set only the layer having an in-focus degree higher than a prescribed reference (threshold) as a selection candidate or simply select the layer (most in-focus image) having the highest in-focus degree with priority.

(Main Flow of Image Display Switching Processing)

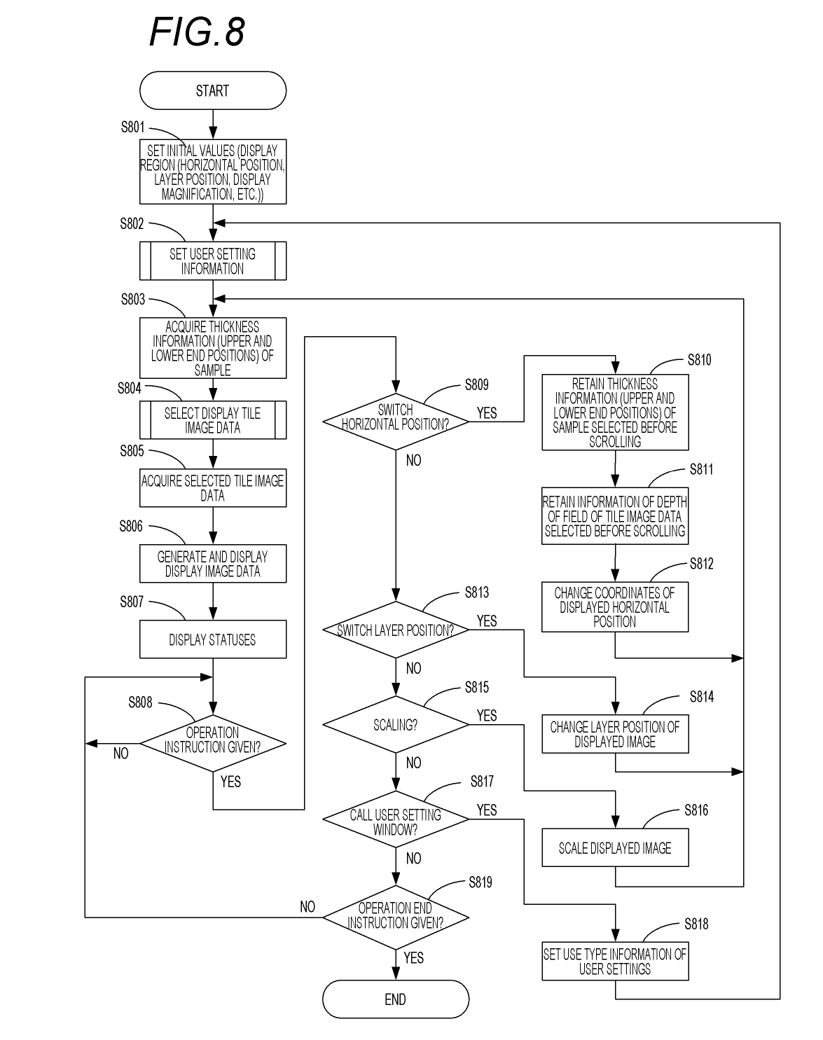

A description will be given, with reference to the flowchart of FIG. 8, of the flow of the main processing of image display switching in the image processing apparatus according to the embodiment.

FIG. 8 is a flowchart for describing the flow of processing to select the tile image data at image display switching.

In step S801, initialization processing is performed. In the initialization processing, the initial values of a display start horizontal position, a display start vertical position, a layer position, a display magnification, a use type for user settings, or the like are set. Then, the processing proceeds to step S802.

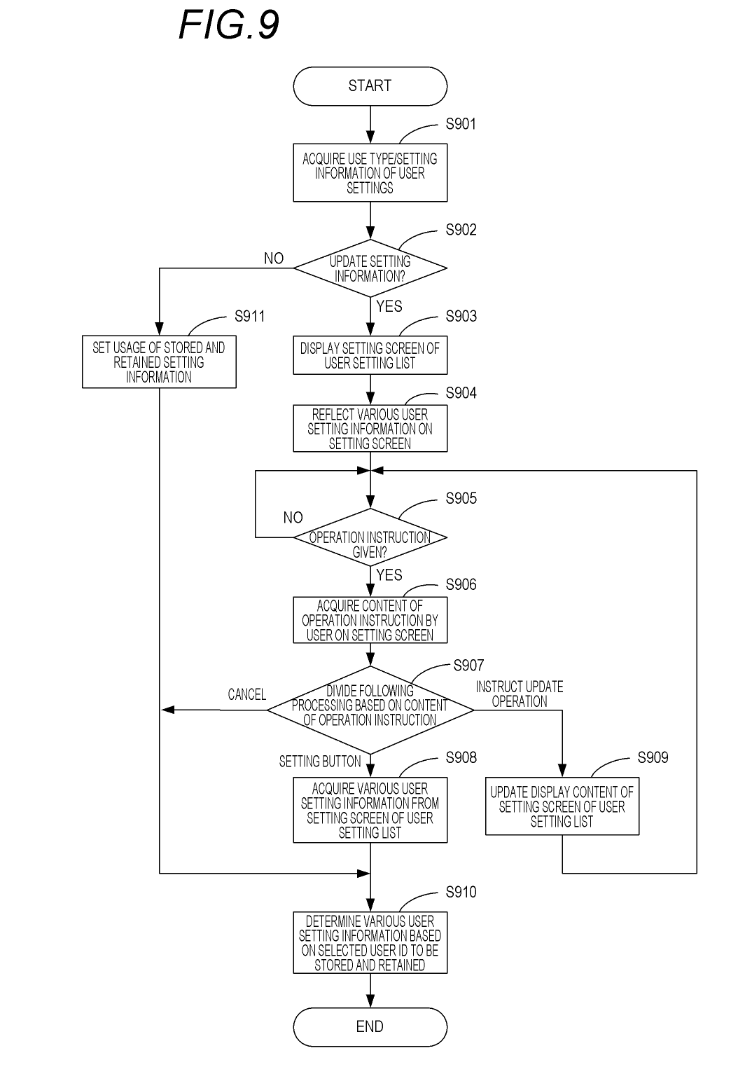

In step S802, processing to set user setting information is performed. In the processing to set the user setting information, a method of selecting a layer position displayed at the scrolling as a feature of the embodiment (selection conditions) is set. The details of the user setting processing will be described with reference to FIG. 9.

In step S803, the thickness information of the test sample 502 at a horizontal position at which an image is to be displayed (in an area after the scrolling when a display area is moved by the scrolling operation) is acquired. Then, the processing proceeds to step S804.

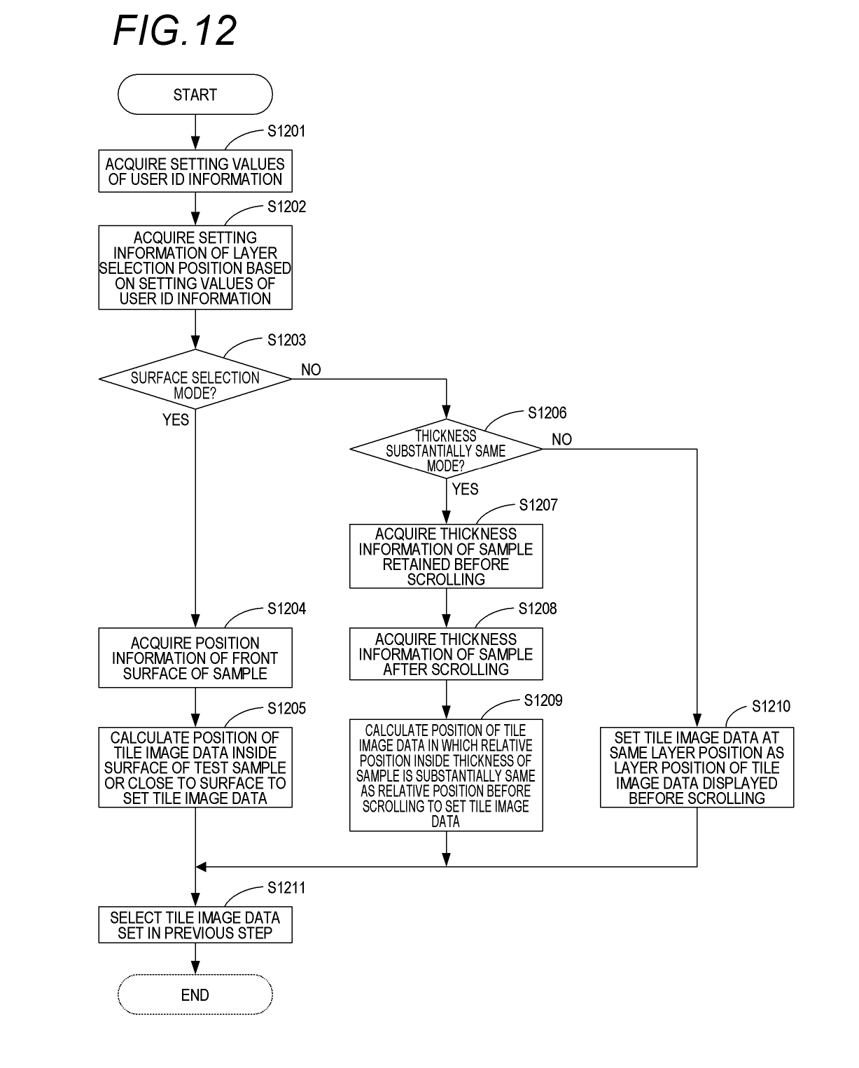

In step S804, processing to select the tile image data to be displayed is performed. Here, as the layer selection methods, the mode in which the same layer as a displayed layer is selected, the mode in which the layer close to the front surface of the test sample is selected (FIG. 7A), and the mode in which the layer at substantially the same relative position inside the thickness of the test sample is selected (FIG. 7B) are prepared. The details of the processing of step S804 will be described with reference to FIG. 12. After the completion of the processing to select the tile image data, the processing proceeds to step S805.

In step S805, the tile image data selected in step S804 is acquired, and then the processing proceeds to step S806.

In step S806, display image data is generated from the acquired tile image data. The display image data is output to the display apparatus 103. Thus, the display image is updated according to a user operation (such as switching a horizontal position, switching a layer position, and changing a magnification).

In step S807, various statuses on the displayed image data are displayed. The statuses may include information such as user setting information, the display magnification of the displayed image, and display position information. The display position information may be such that absolute coordinates from the origin of the image are displayed by numeric values or may be such that the relative position or the size of a display area with respect to the whole image of the test sample 502 is displayed in a map form using an image or the like. After the display of the statuses, the processing proceeds to step S808. Note that the processing of step S807 may be performed simultaneously with or before the processing of step S806.

In step S808, a determination is made as to whether an operation instruction has been given. The processing is on standby until the operation instruction is received. After the reception of the operation instruction from the user, the processing proceeds to step S809.

In step S809, a determination is made as to whether the content of the operation instruction indicates the switching of the horizontal position (the position on the XY plane), i.e., the scrolling operation. When it is determined that the instruction to switch the horizontal position has been given, the processing proceeds to step S810. On the other hand, when it is determined that an operation instruction other than the operation instruction to switch the horizontal position has been given, the processing proceeds to step S813.

In step S810, the thickness information (the upper limit position and the lower limit position in the depth direction) of the test sample 502 at the currently-displayed horizontal position (i.e., the area before the scrolling) is retained.

In step S811, the information of the depth of field (DOF) of the currently-displayed tile image data (i.e., the image data before the scrolling) is retained.

In step S812, processing to change the coordinates of a display start position is performed to suit a horizontal position after the movement (i.e., an area after the scrolling), and then the processing returns to step S803.

In step S813, a determination is made as to whether an operation instruction to switch the layer position of the display image has been given. When it is determined that the operation instruction to switch the layer position has been given, the processing proceeds to step S814. On the other hand, when it is determined that an operation instruction other than the operation instruction to switch the layer position has been given, the processing proceeds to step S815.

In step S814, processing to change the layer position of the displayed image is performed, and then returns to step S803.

In step S815, a determination is made as to whether a scaling operation has been performed. When it is determined that an instruction to perform the scaling operation has been received, the processing proceeds to step S816. On the other hand, when it is determined that an operation instruction other than the scaling operation has been received, the processing proceeds to step S817.

In step S816, processing to change the display magnification of the displayed image is performed, and then the processing returns to step S803.

In step S817, a determination is made as to whether a user setting window has been called. When it is determined that an instruction to call the user setting window has been given, the processing proceeds to step S818. On the other hand, when it is determined that an instruction other than the calling instruction has been given, the processing proceeds to step S819.

In step S818, a setting screen for a user setting list is displayed, and the use type information of user settings is updated and set. Then, the processing returns to step S802.

In step S819, a determination is made as to whether an instruction to end the operation has been given. When it is determined that the instruction to end the operation has been given, the processing ends. On the other hand, when it is determined that the instruction to end the operation has not been given, the processing returns to step S808 and is brought into a state in which the processing is on standby until the operation instruction is received.

As described above, the scrolling display and the scaling display of the display image and the switching display of the layer position are performed according to the content of the operation instruction given by the user to perform the display switching. In addition, the layer position is selected according to the layer selection method (selection conditions) set in the user setting list when the scrolling operation is performed, whereby the image at an appropriate depth is displayed.

(User Setting Processing)

A description will be given, with reference to the flowchart of FIG. 9, of the flow of processing to read and write user setting information in the image processing apparatus according to the embodiment. FIG. 9 is a flowchart showing the detailed flow of the user setting processing performed in step S802 of FIG. 8.

In step S901, the use type information of the user settings and the user setting information stored and retained are acquired from the RAM 402 or the storage unit 403.

The use type information of the user settings is based on the three types of (1) the use of initial setting values, (2) the use of setting values updated by the user, and (3) the update and use of setting contents on the setting screen of the user setting list.

(1) When the use of initial setting values is set, the initial setting values of the user setting information set in the initialization setting processing in step S801 of FIG. 8 are used without modification.

(2) When the use of setting values updated by the user is set, the user reads and uses the updated various user setting information from the RAM 402, the storage unit 403, or the like.

(3) When the update and use of setting contents on the setting screen of the user setting list is set, the initial setting values or the user update setting values are read from the RAM 402, the storage unit 403, or the like and the various setting information is updated and used on the setting screen of the user setting list.

In step S902, a determination is made as to whether the user setting information is updated and used based on the use type information for the user settings acquired in step S901. When it is determined that the user setting information is updated, the processing proceeds to step S903. On the other hand, when it is determined that the user setting information is not updated, the processing proceeds to step S911. In step S911, any of the use of initial values and the use of user updated setting values is selected, and then processing proceeds to step S910.

In step S903, the setting screen to set the user setting information is displayed, and then the processing proceeds to step S904. In step S904, the initial setting values of the user setting information and the user setting information acquired in step S901 are reflected on the display screen as the setting contents of the user setting list. An example of the reflected display will be described later with reference to FIG. 10. After the display of the setting screen of the user setting list, the processing proceeds to step S905.

In step S905, a determination is made as to whether an operation instruction has been given by the user. When it is determined that any operation instruction has been given, the processing proceeds to step S906. The processing is on standby until the operation instruction is given. In step S906, the contents of the operation instruction given by the user on the setting screen of the user setting list is acquired. In step S907, a determination is made as to whether the following processing is divided based on the content of the operation instruction by the user. When the content of the operation instruction indicates the update of the setting screen, the processing proceeds to step S909. In step S909, the display contents of the setting screen of the user setting list are updated, and then the processing returns to step S905.

When a “setting button” is selected in step S907, the setting contents are fixed. Then, the processing proceeds to step S908. In step S908, the user setting information is read, and the window of the setting screen for the user setting list is closed. Then, the processing proceeds to step S910. On the other hand, when a “cancel button” is selected in step S907, the setting contents updated so far are cancelled. Then, the processing proceeds to step S910. In step S910, the read or updated various setting information is stored and retained in the RAM 402 or the storage unit 403 based on currently-selected user ID information, and then the processing ends.

(Setting Screen for User Setting List)

FIG. 10 is an example of a screen for setting the user setting list to set the layer selection method (selection conditions) or the like at the scrolling.

Symbol 1001 indicates the window of the user setting list displayed on the display apparatus 103. In the window of the user setting list, various setting items accompanied with the switching of an image display are displayed in a list form. Here, it is possible for each of a plurality of different users to perform different settings for each observation object of the test sample 502. Similarly, it is also possible for the same user to prepare a plurality of settings in advance and call setting contents suiting conditions from the list.

A setting item 1002 includes user ID information to specify a person who observes a display image. The user ID information is constituted by, for example, radio buttons. With the setting of the user ID information, it is possible to select one of a plurality of IDs. This example shows a case in which a user ID indicated by symbol 1003 is selected from among the user ID information “01” to “09.”

A setting item 1004 includes user names. The user names are constituted by, for example, the lists of pull-down menu options and correspond to the user ID information one to one. In this example, a selection example based on the pull-down menu options is shown. However, the user may directly input a user name in a text form.

A setting item 1005 includes observation objects. The observation objects are constituted by, for example, the lists of pull-down menu options. Like the user names, a selection example based on the pull-down menu options is shown. However, the user may directly input an observation object. When it is assumed to perform a pathological diagnosis, the observation objects include screening before a detailed observation, a detailed observation, a remote diagnosis (telepathology), a clinical study, a conference, a second opinion, or the like.

A setting item 1006 includes observation targets such as internal organs from which a test sample is taken. The observation targets are, for example, constituted by the lists of pull-down menu options. A selection method and an input mode are the same as those of other items.

A setting item 1007 is an item to set the layer selection method. As alternatives of the layer selection method, the three modes of “layer auto selection off,” “selection of surface layer,” and “selection of layer having substantially same relative position inside thickness” are available. Among them, any one of the modes may be selected. A list mode, a selection method, and an input mode are the same as those of other items.

When the “layer auto selection off” is selected, the tile image data at the same layer position as the tile image data displayed before the scrolling is selected. When the “selection of surface layer” is selected, the layer inside the surface of the test sample 502 or close to the surface is selected. When the “selection of layer having substantially same relative position inside thickness” is selected, the layer in which a relative position inside the thickness of the test sample 502 is substantially the same is selected. Note that it is possible to set the details of the relative position with a sub-window, which is not shown, or the like.

Specifically, it is possible to set, for example, ⅔, ⅓, ½ (middle of the thickness of the test sample) or the like from the front surface of the test sample on the side of the cover glass.

Setting items 1008 and 1009 are used to set whether the function of automatically selecting a layer works with a display magnification at the observation of a display image. The designation of a link to a target magnification in a check box allows the selection of “checked” and “unchecked.” In this example, switching selection with the check box is shown. However, a pull-down menu may be used to set the link to a target magnification.

The selection of the “checked” in a low-magnification check box indicates that the processing set in the setting item 1007 is performed at a low-magnification observation, while the selection of the “unchecked” indicates that the processing set in the setting item 1007 is not performed at the low-magnification observation. The same applies to the case of a high magnification. Note that it is possible to set the details of a high magnification and a low magnification on a sub-window, which is not shown, or the like.

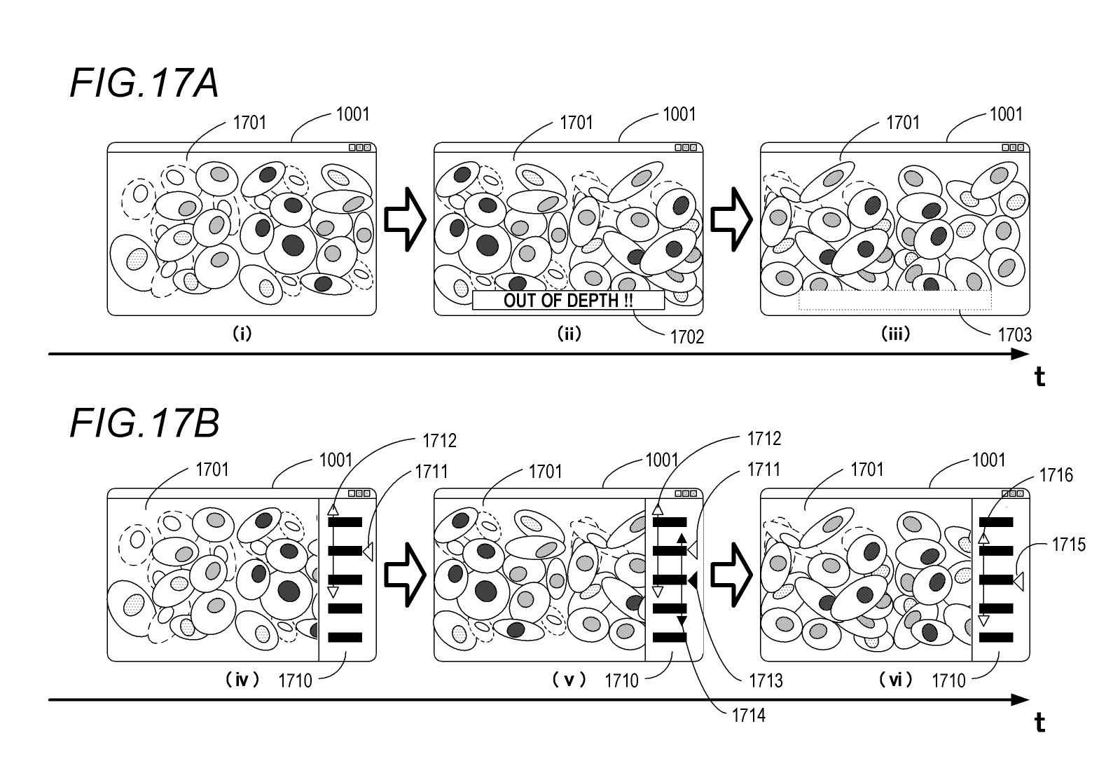

A setting item 1010 includes alerting display methods in a case in which the layer selected according to the layer selection method is out of the depth of field of a currently-displayed image. The setting lists of the alerting display methods when the layer is out of the depth of field are constituted by, for example, the lists of pull-down menu options. A selection method and an input mode are the same as those of the items of other setting lists other than the lists working with the magnifications. As the types of the setting lists of the alerting display methods when the layer is out of the depth of field, a “non-display mode,” an “image display mode,” and a “text display mode” are prepared. It is possible to select any one of the modes. When the “image display mode” is set as the alerting display method, a graphic image on the display screen clearly informs the user of the fact that a layer is out of the depth of field. Similarly, when the “text display mode” is set, character strings (texts) clearly inform the user of the fact that a layer is out of the depth of field. When the “non-display mode” is set, the screen does not inform the fact that the layer is out of the depth of field. Note that the alerting display on the screen when the layer is out of the depth of field will be described in a second embodiment with reference to FIG. 17.

Symbol 1011 indicates a “setting button.” When the setting button 1011 is clicked, the various setting items described above are stored as setting lists. When the window of the user setting list is opened next time, the stored updated contents are read and displayed.

Symbol 1012 indicates a “cancellation button.” When the cancellation button 1012 is clicked, the setting contents updated with addition, selection change, inputting, or the like are invalidated and the window is closed. When the setting screen is displayed next time, previously-stored setting information is read.

The correspondence relationship between the information of the users (observers), the observation objects, or the like and the layer selection methods (selection conditions) is described in the data of the above user setting list, and the system automatically selects an appropriate one of the layer selection methods. Thus, when a plurality of users exists or when different display settings are desired by the same user depending on observation targets (such as screening, detailed observations, and second opinions), the layer position desired by the user(s) may be automatically selected.

(Screen Display Example of User Settings)

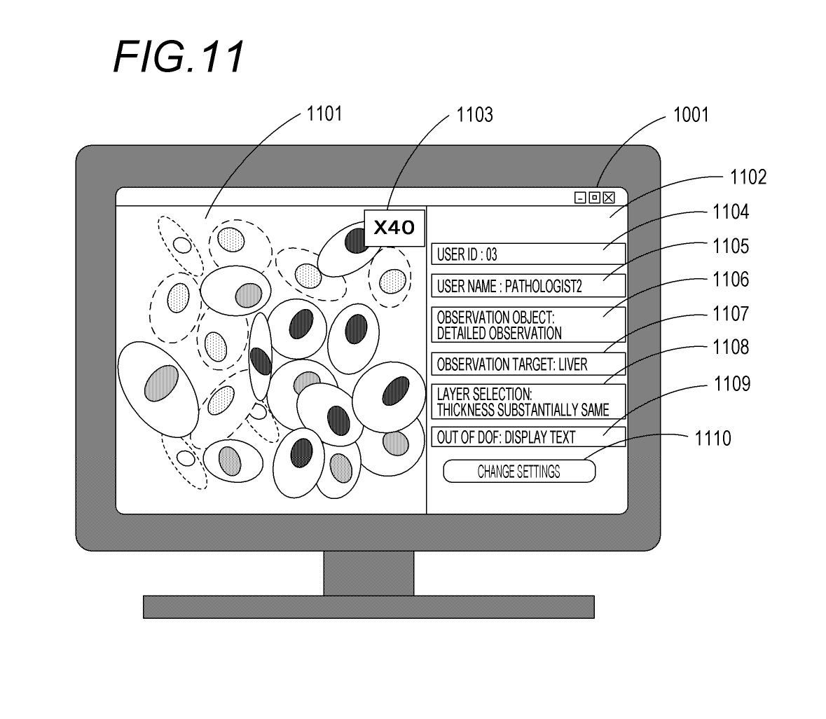

A description will be given, with reference to FIG. 11, of the display of currently-selected setting values in the user setting list described with reference to FIG. 10 and a configuration example of the display screen of the function of calling the user setting screen.

FIG. 11 is a diagram showing the display of user setting values as a feature of the embodiment and a display example of an operation UI to call the user setting screen.

In the whole window 1001 of the display screen, a display region 1101 to display an image of the test sample 502, a display magnification 1103 of the image in the display region 1101, a user setting information area 1102, a setting button 1110 to call the user setting screen, or the like is arranged.

In the user setting information area 1102, currently-selected user setting contents 1104 to 1109 are displayed. Symbol 1104 indicates the user ID information 1002 selected from the user setting list described with reference to FIG. 10. Similarly, symbol 1105 indicates the user name 1004, symbol 1106 indicates the observation object setting item 1005, symbol 1107 indicates the observation target item 1006, symbol 1108 indicates the layer selection method 1007, and symbol 1109 indicates the alerting display setting 1010 when the layer is out of the depth of field.

When the setting change button 1110 is clicked, the user setting list described with reference to FIG. 10 is screen-displayed, and the contents set and selected on the user setting screen are displayed in the user setting information area 1102.

The embodiment describes an example in which the user setting information area 1102 is provided in the whole window 1001 using a single document interface (SDI). However, a display mode is not limited to this. A separate window may be displayed using a multiple document interface (MDI). In addition, the embodiment describes an example in which the setting change button 1110 is clicked to call the user setting screen. However, it may also be possible to allocate functions to short-cut keys and call the setting screen.

As described above, when the test sample 502 is observed in detail, the setting contents of the layer display position setting items set in the user setting list may be confirmed on the display screen. In addition, when the setting contents are switched in the middle of the observation, the setting conditions are changed and selected with the confirmation of the displayed setting contents, whereby the settings may be easily changed.

(Processing to Select Layer Displayed after Scrolling)

A description will be given, with reference to the flowchart of FIG. 12, of the flow of the processing (step S804 of FIG. 8) to select the layer after the scrolling according to the layer selection method in the image processing apparatus according to the embodiment.

In step S1201, the setting values of the user ID information are acquired. In step S1202, the contents of the user setting list are confirmed, and the setting information (selection conditions) of the layer selection method corresponding to the currently-set user ID information is acquired. Here, the acquisition of the user ID information and the confirmation of the setting contents are performed for each scrolling. However, the processing of steps S1201 and S1202 may be skipped after the second time unless the user ID and the layer selection method are changed.

In step S1203, a determination is made as to whether the layer selection method has been set in the mode of the “selection of surface layer.” When it is determined that the layer selection method has been set in the mode of “selection of surface layer,” the processing proceeds to step S1204. When it is determined that the layer selection method has been set in any mode other than the mode of the “selection of surface layer,” the processing proceeds to step S1206.

In step S1204, the positional information of the front surface of the test sample 502 in an area after the scrolling is acquired based on the thickness information of the test sample 502. Here, a Z position at the upper end, i.e., the front surface of the cover glass is acquired. The thickness information of the test sample 502 may be acquired from the pre-measurement information of the header data of the image file. Alternatively, the thickness information may be acquired from each vertical position information stored in the Z-stack image data in a corresponding horizontal region or may be acquired from other files stored separately from the image data.

In step S1205, the layer position of the tile image data inside the surface of the test sample 502 or close to the surface is calculated. Specifically, among the respective layer positions of the Z-stack image data in the area after the scrolling, one closest to the upper end (or one lower than but closest to the upper end) of the test sample 502 acquired in step S1204 is selected. The calculated layer position is set, and then the processing proceeds to step S1211.

On the other hand, in step S1206, a determination is made as to whether the layer selection method has been set in the mode of “selection of layer having substantially same relative position inside thickness.” When it is determined that the layer selection method has been set in the mode of the “selection of layer having substantially same relative position inside thickness”, the processing proceeds to step S1207. When it is determined that the layer selection method has been set in any mode other than the mode of “selection of layer having substantially same inside thickness”, the processing proceeds to step S1210.

In step S1207, the thickness information of the test sample 502 in the area before the scrolling retained in step S810 of FIG. 8 is acquired. In step S1208, the thickness information of the test sample 502 in the area after the scrolling is acquired. After the acquisition, the processing proceeds to step S1209.

In step S1209, a layer position is calculated such that relative positions inside the thickness of the test sample become substantially the same before and after the scrolling based on the thickness information of the test sample 502 before and the after the scrolling acquired in steps S1207 and S1208. The calculated layer position is set, and then the processing proceeds to step S1211.

In step S1210, processing is performed based on the premise that the mode of “layer auto selection off” has been set. That is, the same layer position as that of tile image data displayed before the scrolling is set, and then the processing proceeds to step S1211.

In step S1211, the tile image data corresponding to the layer position set in step S1205, step S1209, or S1210 is selected, and then the processing ends. Note that when only one tile image data exists in the area after the scrolling, it may be selected regardless of the setting of the layer setting method.

(Layout Example of Image Display Screen)

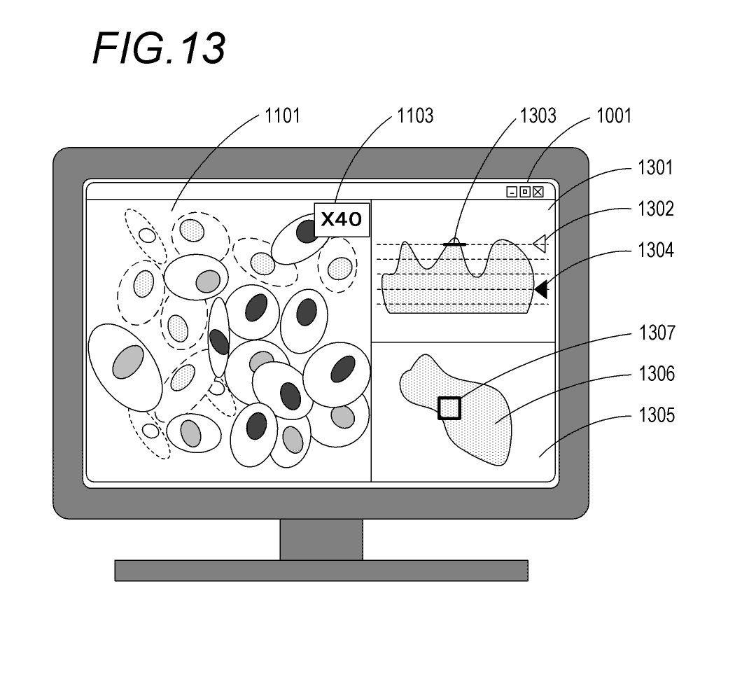

FIG. 13 is a diagram showing an example of a display screen layout when display data generated by the image processing apparatus 102 according to the embodiment is displayed on the display apparatus 103.

In the window 1001, the display region 1101, a layer position information display region 1301, and a horizontal position information display region 1305 are arranged.

In the display region 1101, an image of the tissues or cells of the test sample 502 to be observed is displayed. That is, the display image generated based on the tile image data is displayed in the display region 1101. Symbol 1103 indicates the display magnification (observation magnification) of the image displayed in the display region 1101.

In the layer position information display region 1301, the whole image of the vertical cross section (cut surface on the XZ or YZ plane) of the test sample 502 and a guide image (fourth image data) to show the area position and the layer position of the tile image displayed in the display region 1101 are displayed. Symbol 1302 indicates the layer position of the currently-displayed tile image. When the scrolling operation or the processing to automatically switch the layer position is performed, the layer position of the displayed tile image data is switched and displayed. Symbol 1303 indicates the position and the size of the image displayed in the display region 1101 with respect to the test sample 502.

Symbol 1304 indicates the layer position of the tile image data displayed after the scrolling. The layer position of the image displayed after the scrolling is displayed so as to be distinguishable from the currently-observed layer position 1302. For example, the color and the shape of markers indicating the layer positions are made different to distinguish the layer positions.

It is possible to change the layer with an operation instruction to the layer position information display region 1301, e.g., the selection of the layer with a mouse, and an operation instruction to the display region 1101. In this case, the layer may be selected in such a way that the wheel of a mouse is operated with a mouse cursor arranged inside the display region 1101.

In the horizontal position information display region 1305, a whole image 1306 of the test sample 502 in the horizontal direction (XY plane) and a display range 1307 of the tile image displayed in the display region 1101 are displayed. In the display range 1307, the display image of the display region 1101 shows a target region of the whole test sample 502 in a rectangle form.

As described above, the positional relationship between the display region as an observation target and the whole test sample 502 may be presented to the user together with the enlarged image of the test sample 502 for a detailed observation.

### Effects of Embodiment

According to the embodiment, it is possible to provide the image processing apparatus that allows the user to observe an image at an intended layer position when he/she performs the scrolling operation to move a display area in the horizontal direction for the observation of the image of the test sample 502.

In particular, the user is allowed to easily observe an image at a desired depth suiting an observation object or an observation target when he/she scrolls and observes the test sample 502 having variations in thickness and unevenness on its front surface.

Specifically, for the purpose of observing the surface of the test sample 502, the image processing apparatus may select image data along the surface of the test sample 502 and display successive images to the user. In addition, for the purpose of observing, for example, the central position of the test sample 502 at which relative positions inside the thickness of the test sample 502 are substantially the same, the image processing apparatus may select image data whose relative positions inside the thickness of the test sample 502 are substantially the same and display successive images to the user.

As a result, the user is allowed to observe tissues or cells at a depth suiting an observation object without manually changing a layer position when he/she performs the scrolling operation to move a display position in the horizontal direction and thus may reduce work loads at a pathological diagnosis and improve accuracy in diagnosis.

### Second Embodiment

### Apparatus Configuration of Image Processing System

The first embodiment describes the method in which the tile image data of a user's intended layer is automatically selected according to an observation object when the user performs the scrolling operation. A second embodiment is different from the first embodiment in that exception processing is performed when a layer selected according to the method of the first embodiment is out of the depth of field of an image before scrolling. Hereinafter, a configuration unique to the embodiment will be mainly described, and the descriptions of the same configurations and contents as those of the first embodiment will be omitted.

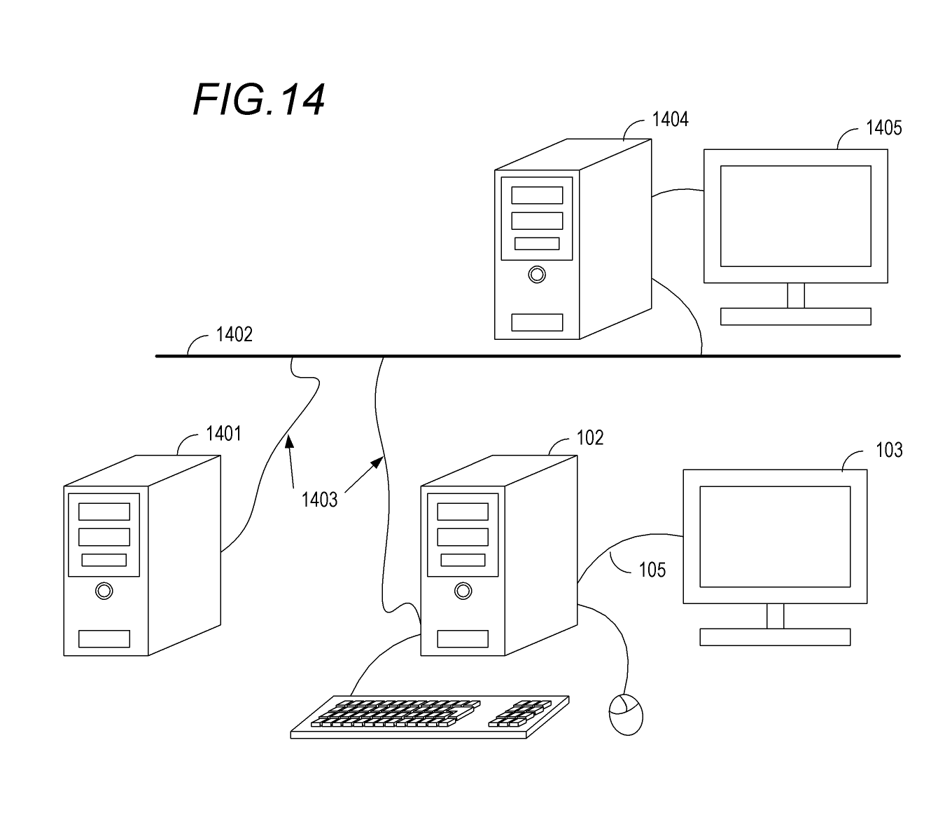

FIG. 14 is an entire diagram of apparatuses constituting an image processing system according to the embodiment. The image processing system is constituted by an image server 1401, an image processing apparatus 102, a display apparatus 103, an image processing apparatus 1404, and a display apparatus 1405.

The image server 1401 is a data server having a high-capacity storage unit that stores image data whose images are picked up by an imaging apparatus 101 serving as a virtual slide apparatus. The image server 1401 may store image data having different hierarchized display magnifications and header data in the local storage of the image server 1401 as one image file. Alternatively, the image server 1401 may divide image files into respective hierarchical images and store the same in a server group (cloud server) existing anywhere on a network so as to be divided into the entity of respective hierarchical image data and their link information. In addition, it may be possible that various information such as image data and header data is divided and managed on different servers and the user appropriately reads management information or in-focus information from the different servers when reading the image data from the servers.

The image processing apparatus 102 may acquire image data obtained by picking up an image of a test sample 502 from the image server 1401 and generate image data to be displayed on the display apparatus 103.

The image server 1401 and the image processing apparatus 102 are connected to each other by general-purpose I/F LAN cables 1403 via a network 1402. Note that the image processing apparatus 102 and the display apparatus 103 are the same as those of the image processing system according to the first embodiment except that they have a network connection function. The image processing apparatuses 102 and 1404 are connected to each other via the network 1402, and the physical distance between both the apparatuses is not taken into consideration. The functions of both the apparatuses are the same. The image data set of the test sample acquired by the imaging apparatus is stored in the image server 1401, whereby the image data may be referenced from both the image processing apparatuses 102 and 1404.

In the example of FIG. 14, the image processing system is constituted by the five apparatuses of the image server 1401, the image processing apparatuses 102 and 1404, and the display apparatuses 103 and 1405. However, the present invention is not limited to this configuration. For example, the image processing apparatuses 102 and 1404 integrated with the display apparatuses 103 and 1405, respectively, may be used, or some of the functions of the image processing apparatuses 102 and 1404 may be incorporated in the image server 1401.

Conversely, the functions of the image server 1401 and the image processing apparatuses 102 and 1404 may be divided and implemented by a plurality of apparatuses.

As described above, the system of the embodiment is such that image data acquired by the imaging apparatus 101 is temporarily stored in the image server 1401 and then read by the image processing apparatuses 102 and 1404 connected via the network. The network 1402 may be a LAN or a wide area network such as the Internet.

(Depth of Field of Displayed Image and Layer after Scrolling)

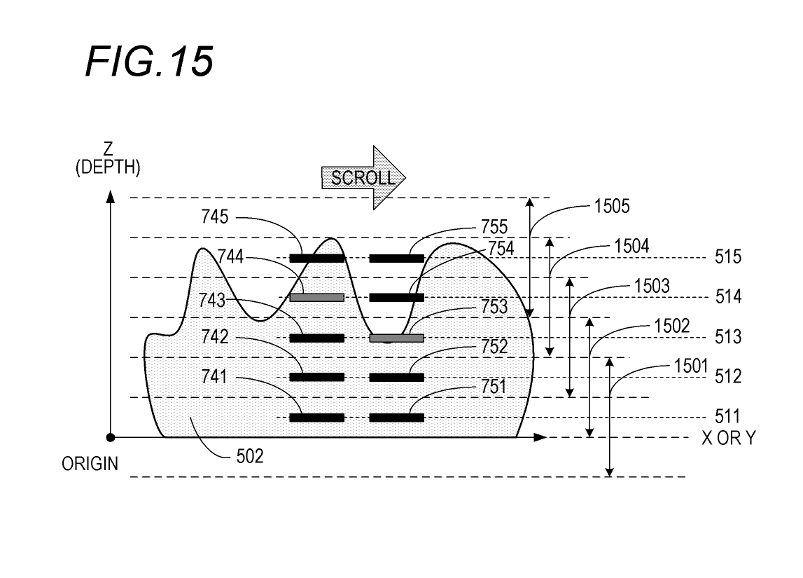

FIG. 15 is a conceptual diagram for describing the relationship between the depth of field of an image displayed before the scrolling and a layer position selected after the scrolling.

FIG. 15 is a diagram showing some positions (near the fourth horizontal region and the fifth horizontal region) of FIG. 6A. The tile image data 741 to 745 is Z-stack image data whose image is picked up with the focal position set at the layer positions 511 to 515 of the fourth horizontal region. The tile image data 751 to 755 is Z-stack image data whose image is picked up with the focal position set at the layer positions 511 to 515 of the fifth horizontal region.

An arrow 1501 indicates the depth of field of the tile image data 741 and 751 whose images are picked up with the focal position set at the layer position 511. Similarly, an arrow 1502 indicates the depth of field of the tile image data 742 and 752, an arrow 1503 indicates the depth of field of the tile image data 743 and 753, an arrow 1504 indicates the depth of field of the tile image data 744 and 754, and an arrow 1505 indicates the depth of field of the tile image data 745 and 755. The depth of field is a Z range in which a focus is adjusted based on (centered on) the focal position on the side of a subject, and represents a value uniquely determined when the optical characteristics and the image pick-up conditions of an image forming optical system are determined.

It is assumed that an operation instruction (scrolling in a horizontal direction) is given to display the fifth horizontal region (second area) on the right side in a state in which the tile image data 744 (first image data) of the fourth horizontal region (first area) of FIG. 15 is being displayed.

After the scrolling operation, tile image data (second image data) to be displayed after the scrolling (after a display area is changed) is selected from among Z-stack image data (tile image data 751 to 755) of the fifth horizontal region. Layer selection processing is the same as that of the first embodiment. In this example, the tile image data 753 is selected.

In the example of FIG. 15, the layer 513 of the tile image data 753 selected after the scrolling exists within the depth of field 1504 of the tile image data 744 displayed before the scrolling. Thus, with the selection of the image (layer) after the scrolling, the continuity of the images before and after the scrolling may be maintained. Therefore, the user may be free from an uncomfortable feeling due to the switching of the layer.

(Exception Processing when Layer Position is Out of Depth of Field)

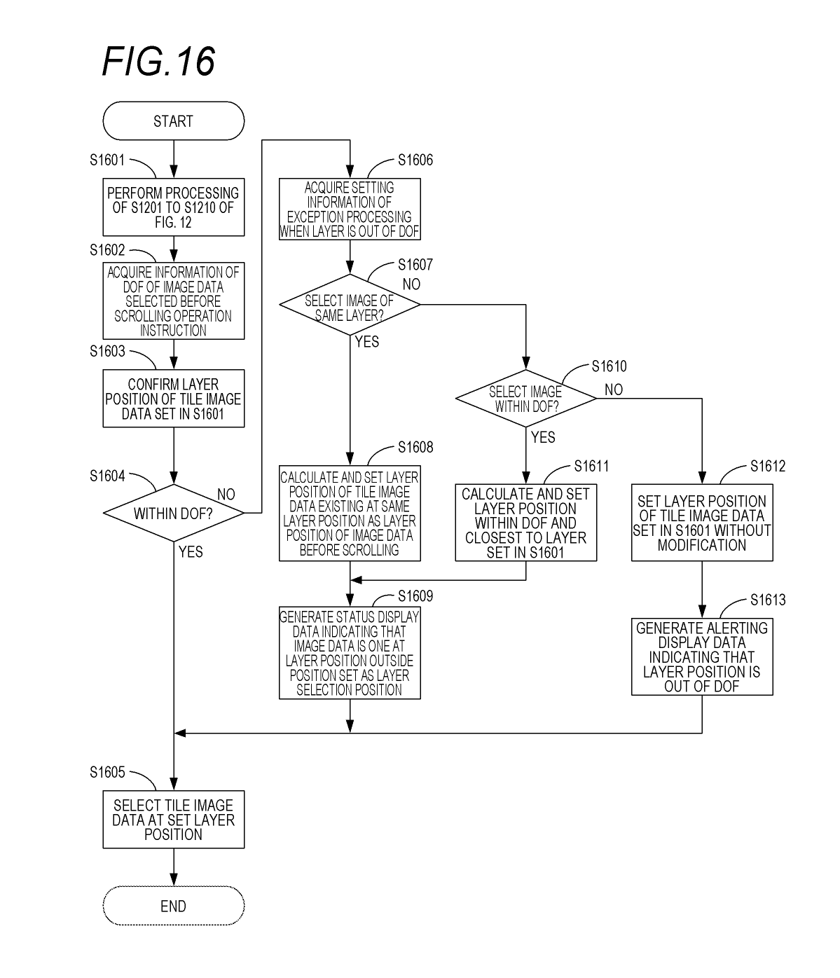

The image processing apparatus according to the embodiment performs the exception processing to change a layer position after the scrolling when the layer position after the scrolling is out of the depth of field of an image (that is being displayed) before the scrolling. The flow of the exception processing will be described with reference to the flowchart of FIG. 16.

FIG. 16 is the flowchart showing the details of step S804 of FIG. 8.

In step S1601, processing to determine a layer position after the scrolling is performed according to a previously-set layer selection method (selection conditions). Specifically, the same processing as that described in steps S1201 to S1210 in the flowchart of FIG. 12 is performed.

In step S1602, the information of the depth of field of tile image data (first image data) displayed before the scrolling is acquired. In step S1603, the layer position (depth position) of the tile image data (second image data) selected in step S1601 is confirmed. In step S1604, a determination is made as to whether the layer position of the tile image data confirmed in step S1603 is within the depth of field acquired in step S1602.

When it is determined that the layer position is within the depth of field, the processing proceeds to step S1605.

In step S1605, tile image data corresponding to the set layer position is selected, and then the processing ends. Note that when only one tile image data exists in an area after the scrolling, it may be selected regardless of whether the layer position exists within the depth of field. In addition, when no tile image data within the depth of field exists in the area after the scrolling, the tile image data selected in step S1601 may be used without modification.

On the other hand, when it is determined that the layer position of the tile image data is out of the depth of field in step S1604, the processing proceeds to step S1606. In step S1606, the user setting information is acquired that is used to determine the processing content of the exception processing performed when the layer position out of the depth of field is calculated.

The user setting information of the exception processing may be set on the setting screen of the user setting list described in the first embodiment. For example, a setting item to select the type of the exception processing is added to the user setting list of FIG. 10. In the embodiment, “selection of same-layer image within depth,” “selection of close image within depth,” and “selection of mode-fixation image outside depth” are available as the types of the exception processing.

The “selection of same-layer image within depth” is a mode in which tile image data at the same layer as that of the tile image data displayed before the scrolling is selected as the exception processing.

The “selection of close image within depth” is a mode in which image data closest to a layer position selected according to a layer selection method is selected as the exception processing from among tile image data included in the depth of field of tile image data displayed before the scrolling.

The “selection of mode-fixation image outside depth” is a mode in which the exception processing is not performed. That is, tile image data at a layer position selected according to a layer selection method is selected without modification. However, processing to clearly inform the user of the fact that the tile image data is an image out of the depth of field (alerting display) is performed.

In step S1607, a determination is made as to whether the type of the exception processing has been set in the “selection of same-layer image within depth.” When it is determined that the type of the exception processing has been set in the “selection of same-layer image within depth,” the processing proceeds to step S1608. In step S1608, the layer position of tile image data at the same layer as tile image data before the scrolling is set as a layer position selected after the scrolling, and then the processing proceeds to step S1609.

In step S1609, processing to generate status display data is generated in which the user is informed of the fact that the set layer position is a layer position not suiting the conditions of a previously-set layer selection method, and then the processing proceeds to step S1605. Note that when the setting information of a layer selection position has been set in the “layer auto selection off mode,” the processing to generate the status display data described above is not performed.

On the other hand, when it is determined that the type of the exception processing has not been set in the “selection of same-layer image within depth” in step S1607, the processing proceeds to step S1610. In step S1610, a determination is made as to whether the type of the exception processing has been set in the “selection of close-image within depth.” When it is determined that the type of the exception processing has been set in the “selection of close-image within depth,” the processing proceeds to step S1611. In step S1611, a layer position is calculated that is within the depth of field of the tile image data before the scrolling and is the closest to the layer position selected according to the layer selection method. The calculated layer position is set as the layer position displayed after the scrolling, and then the processing proceeds to step S1609.

On the other hand, when it is determined in step S1610 that the type of the exception processing has not been set in the “selection of close-image within depth,” the processing proceeds to step S1612 to perform processing to inform the user of the fact that the layer position is out of the depth of field. In step S1612, the layer position of the tile image data set in step S1601 is used without modification, and then the processing proceeds to step S1613. In step S1613, alerting display data indicating that the layer position is out of the depth of field is generated to inform the user of the fact that the set layer position is out of the depth of field, and then the processing proceeds to step S1605.

Thus, the user registers the settings of the exception processing for a case in which the layer position is out of the depth of field, whereby a response to the exception processing may be automatically made. In addition, it becomes possible to inform the user of the occurrence of the exception processing according to the contents of processing.

(Example of Switching Display of Image)

FIGS. 17A and 17B are diagrams showing an example of the switching display of an image.

FIG. 17A shows an example in which the user is informed by characters (texts) of the fact that a display is switched to an image out of the depth of field by the scrolling operation.

(i), (ii), and (iii) indicate the elapse of time and shows an example in which a display in the window 1001 is switched by turns with time (t). (i) shows an example of a display screen displayed before the scrolling operation. A detailed image 1701 of the test sample 502 is displayed on the whole window 1001. (ii) shows an example of an alerting message 1702 in a case in which the layer position of the image after the scrolling is out of the depth of field of the image before scrolling. The alerting message 1702 (auxiliary image data) like “Out of depth!!” is displayed on the detailed image 1701 in an overlaying fashion, whereby the user is informed of the fact that the layer position is out of the depth of field (that is, the joint between the images before and after the scrolling is discontinuous).

(iii) shows an example in which the user stops the scrolling operation to dismiss the alerting message 1702. The alerting message 1702 may be automatically dismissed after the elapse of specific or arbitrary time. Alternatively, the user may dismiss the alerting message with an operation (for example, by pressing the alerting message, moving a mouse cursor to the position of the alerting message, inputting any keyboard key to which a dismissing function is allocated, or the like). In addition, in this example, the alerting message is displayed in a text form. However, it may also be possible to inform the user of the fact that the layer position is out of the depth of field by the display of graphic data, a change in the brightness of a screen, and the use of a speaker, a vibration device, or the like.

By the alerting message as shown in FIG. 17A, the user may be clearly informed of the fact that the display is switched by the scrolling to the image in which a depth position is discontinuous. Therefore, even if the user feels something wrong with the joint between the images before and after the scrolling or sees an artifact in the same, he/she may find a reason (cause) for it.

FIG. 17B shows an example in which the layer positions of the images before and after the scrolling and the depth of field are displayed on a sub-window to facilitate the understanding of the positional relationship between the images before and after the scrolling in the depth direction.

(iv), (v), and (vi) indicate the elapse of time and show an example in a which display in the window is switched by turns with time (t).

(iv) shows an example of a display screen displayed before the scrolling operation. A layer position display region 1710 is a display region to display a graphic image that indicates the number of the layers of a Z-stack image, the position of a layer that is being displayed, and the depth of field of a display image. In (iv), the layer position of tile image data before the scrolling is indicated by a white triangle 1711, and the depth of field of the tile image data is indicated by a white arrow 1712. In this example, the tile image data on the second place from the top is displayed. (v) shows a display example of a state in which the scrolling operation is performed to switch the layer position of the display image (mixed state). In (v), a white triangle 1711 indicating a layer position before the switching, a white arrow 1712 indicating the depth of field, a black triangle 1713 indicating a layer position after the switching, and a black arrow 1714 indicating the depth of field are displayed. By the display, the user is allowed to easily understand the positional relationship between the images before and after the scrolling in the depth direction. (vi) shows a state in which the scrolling and the switching of the layer positions are completed. The display is switched from (v) to (vi) at a timing at which the boundary between the images before and after the scrolling deviates from the display region. With a change in graphic from the black triangle 1713 and the black arrow 1714 to a white triangle 1715 and a white arrow 1716, respectively, the user finds the completion of the switching of the display.

By the graphic display as shown in FIG. 17B, the user may be clearly informed of the relationship between the layer positions of the images before and after the scrolling and the depth of field. Therefore, even if the user feels something wrong with the joint between the images before and after the scrolling or sees an artifact in the same, he/she may find a reason (cause) for it. Note that when the user clicks a mouse or the like to select a layer position (black rectangle) displayed in the layer position display region 1710 of FIG. 17B, the display may be switched to an image at the layer position.

### Effects of Embodiment

In the embodiment, the same effects as those of the first embodiment may be obtained. In addition, according to the embodiment, switching to tile image data at a layer position within the depth of field of currently-displayed tile image data may be performed with priority. As a result, the continuity between display images in the depth direction is maintained, whereby the user may hardly feel something wrong with the joint between the images and see an artifact in the same.

Moreover, when an image out of the depth of field is displayed by the scrolling operation, the user may be informed of the fact by texts, graphics, or the like. As a result, the user is allowed to easily recognize the fact that the difference between layer positions before and after the scrolling exceeds the depth of field, that is, adjacent tile image data is discontinuous.

### Third Embodiment

### Clear Indication of Boundary Between Tile Image Data

The second embodiment describes an example in which an alerting message or the like is displayed to inform the user of the discontinuity between tile image data when an image after the scrolling is out of the depth of field of an image before the scrolling. A third embodiment is different in that when the information of the discontinuity between an image before the scrolling and an image after the scrolling in the depth direction is presented by an image display inside a display region. Hereinafter, this point will be mainly described, and the descriptions of the same configurations and contents as those of the first and second embodiments will be omitted.

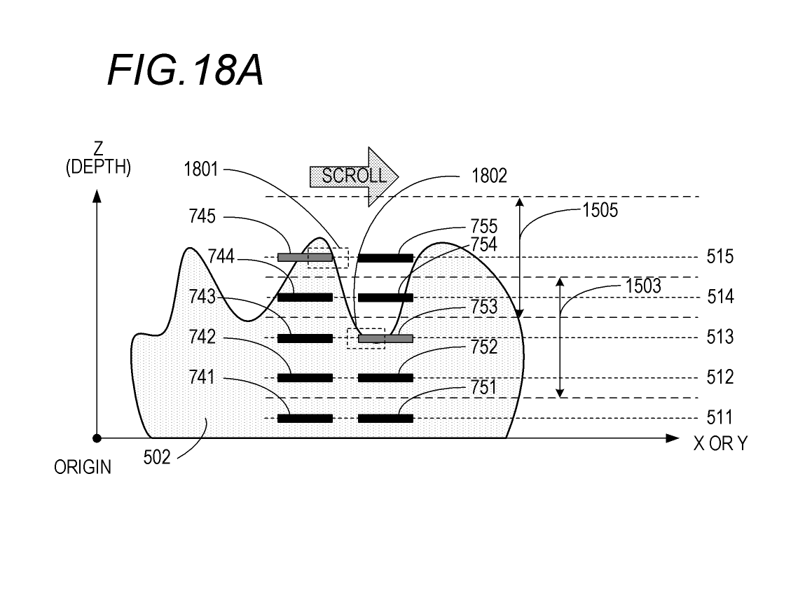

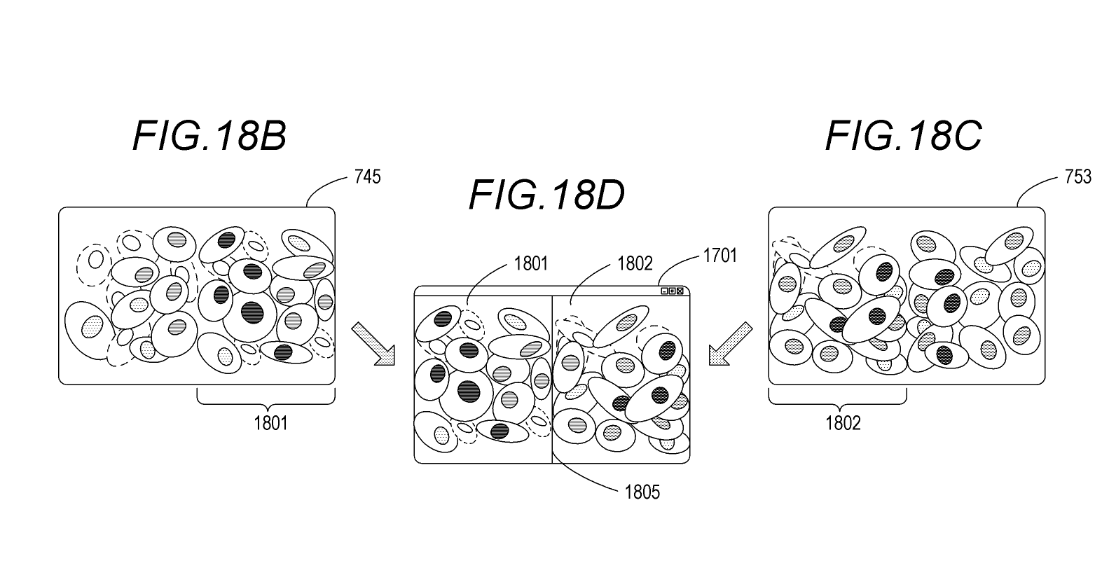

FIGS. 18A to 18D are the conceptual diagrams of a method of clearly informing the user of the fact that images before and after the scrolling are discontinuous from each other (i.e., they are out of the depth of field each other) in the depth direction.

FIG. 18A is a diagram showing some positions (near the fourth horizontal region and the fifth horizontal region) of FIG. 6A. The tile image data 741 to 745 is Z-stack image data whose image is picked up with the focal position set at the layer positions 511 to 515 of the fourth horizontal region. The tile image data 751 to 755 is Z-stack image data whose image is picked up with the focal position set at the layer positions 511 to 515 of the fifth horizontal region.

An arrow 1505 indicates the depth of field of the tile image data 745 displayed before the scrolling, and an arrow 1503 indicates the depth of field of the tile image data 753 selected to be displayed after the scrolling.

Here, it is assumed that the user performs the scrolling operation to move a display position in the horizontal direction to display the tile image data 753 in a state in which the whole tile image data 745 is displayed to the maximum in a window.

FIGS. 18B and 18C show examples of two-dimensional images of the tile image data 745 and the tile image data 753, respectively, described with reference to FIG. 18A. FIG. 18B shows an example of a two-dimensional image of the tile image data 745, and symbol 1801 indicates the right half region of the tile image data 745. FIG. 18C shows an example of a two-dimensional image of the tile image data 753, and symbol 1802 indicates the left half region of the tile image data 753.

FIG. 18D shows an example in which the right half region 1801 of the tile image data 745 and the left half region 1802 of the tile image data 753 are displayed in the window 1701 at the same time when the user performs the scrolling operation in a state in which the tile image data 745 is being displayed. In the embodiment, an auxiliary image 1805 indicating the boundary between the two images is displayed when the depths of the tile image data 745 and 753 are discontinuous from each other. Note that although a line is drawn at the boundary between the images in FIG. 18D, any graphic may be used so long as the clear indication of the boundary between the two images is allowed.

As described above, when a plurality of images different in layer position is displayed side by side on the same screen, the boundary between the images is clearly indicated to allow the user to be informed of the fact that an image in which images of the test sample 502 discontinuous from each other in the thickness direction are joined together is displayed. As a result, even if the user feels something wrong with the joint between the images or sees an artifact in the same, he/she may find a reason (cause) for it. Note that the embodiment describes an example in which the boundary between two images is clearly indicated. However, when three or more images different in layer position are displayed side by side on a screen, the boundaries between the respective images may be clearly indicated.

(Flow of Boundary Display Processing)

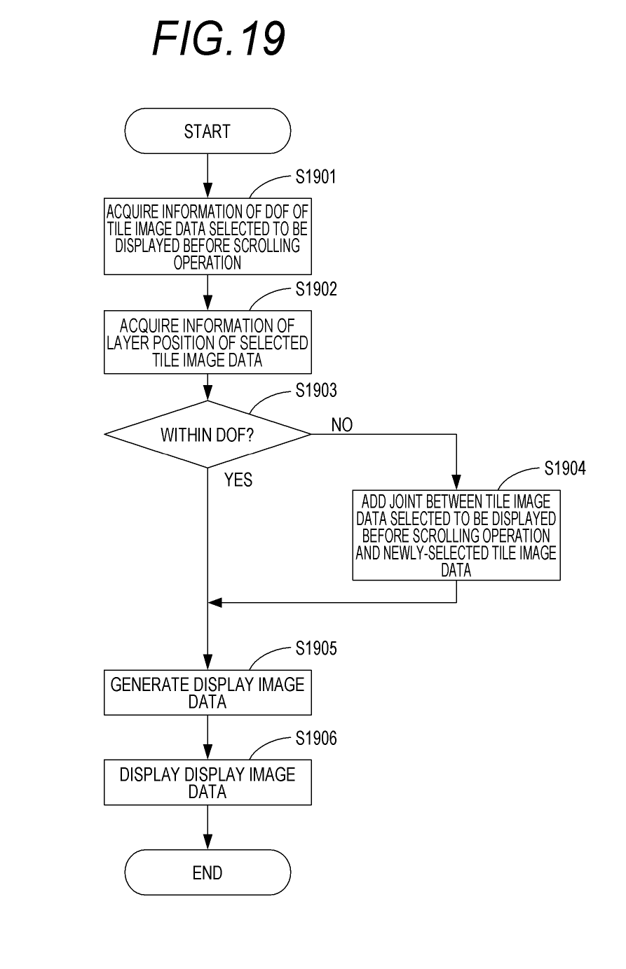

A description will be given, with reference to the flowchart of FIG. 19, of the flow of processing to clearly indicate the joint between tile image data when a layer position is out of the depth of field in the image processing apparatus according to the embodiment.

In step S1901, the information of the depth of field of tile image data selected before the scrolling is acquired. In step S1902, the information of the layer position of tile image data selected to be displayed after the scrolling is acquired. In step S1903, a determination is made as to whether the layer position of a tile image to be displayed next is within the depth of field of the tile image data selected before the scrolling based on the information of the layer position acquired in step s1902. When it is determined that the layer position of the tile image to be displayed next is within the depth of field, the processing proceeds to step S1905 (boundary display processing is skipped).

When it is determined in step S1903 that the layer position is out of the depth of field, the processing proceeds to step S1904. In step S1904, processing to add auxiliary image data to clearly indicate the boundary between the tile image data is performed, and then the processing proceeds to step S1905.

In step S1905, display image data is generated using the plurality of selected tile image data and the auxiliary image data at the boundary newly generated in step S1904. Note that since the auxiliary image data at the boundary does not exist when it is determined in step S1903 that the layer position is within the depth of field, display image data is generated using only the tile image data. In step S1906, processing to display the display image data is performed, and then the processing ends.

### Effects of Embodiment

As described above, when the layer positions of tile image data selected before and after the scrolling operation are out of the depth of field each other, the discontinuity between the tile image data may be visually confirmed. As a result, the user is allowed to easily understand the state in which images out of the depth of field each other are arranged side by side. Since the user is allowed to determine from a displayed image whether an artifact generated at the discontinuous boundary is information resulting from an original lesion or is added due to image processing, a diagnosing error or the like may be prevented from occurring.

### Fourth Embodiment

A fourth embodiment describes an example in which an image processing method and an image processing apparatus according to the present invention are applied to an image processing system having an imaging apparatus and a display apparatus. The configuration of the image processing system, the function configuration of the imaging apparatus, and the hardware configuration of the image processing apparatus are the same as those of the first embodiment (FIGS. 1, 2, and 4).

(Function Blocks of Image Processing Apparatus)

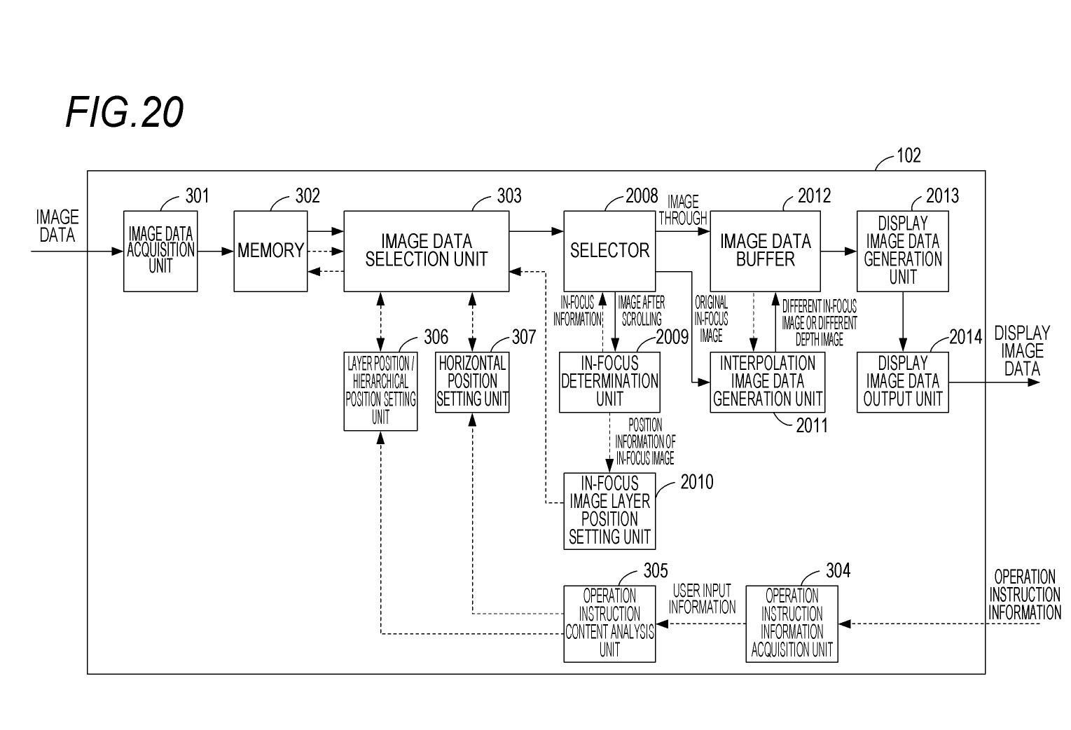

FIG. 20 is a block diagram showing the function configuration of an image processing apparatus 102 according to the fourth embodiment.

The image processing apparatus 102 has an image data acquisition unit 301, a storage retention unit (memory) 302, an image data selection unit 303, an operation instruction information acquisition unit 304, an operation instruction content analysis unit 305, a layer-position/hierarchical-position setting unit 306, and a horizontal position setting unit 307. The function units 301 to 307 are the same as those (symbols 301 to 307 of FIG. 3) of the first embodiment. In addition, the image processing apparatus 102 has a selector 2008, an in-focus determination unit 2009, an in-focus image layer position setting unit 2010, an interpolation image data generation unit 2011, an image data buffer 2012, a display image data generation unit 2013, and a display image data output unit 2014.

The image data selection unit 303 selects display tile image data from the storage retention unit 302 and outputs the same. The display tile image data is determined based on a layer position and a hierarchical position set by the layer-position/hierarchical-position setting unit 306, a horizontal position set by the horizontal position setting unit 307, and a layer position set by an in-focus image layer position setting unit 2010.

In addition, the image data selection unit 303 has the function of acquiring information required by the layer-position/hierarchical-position setting unit 306 and the horizontal position setting unit 307 to perform settings from the storage retention unit 302 and outputting the same to the respective setting units.

The selector 2008 outputs tile image data to the in-focus determination unit 2009 to perform the in-focus determination of the tile image data acquired from the storage retention unit 302 via the image data selection unit 303. In addition, the selector 2008 divides and outputs the tile image data to the image data buffer 2012 or the interpolation image data generation unit 2011 based on in-focus information acquired from the in-focus determination unit 2009. The tile image data stored in the image data buffer 2012 includes, besides an in-focus image to be finally displayed after scrolling, a plurality of previously-acquired tile image data (Z-stack image data) between an in-focus position and a layer position displayed before the scrolling. In addition, when the interpolation image data generation unit 2011 newly generates time-divided-display tile image data, the selector 2008 outputs required data to the interpolation image data generation unit 2011.

The in-focus determination unit 2009 determines the in-focus degree of the tile image data output from the selector 2008 and outputs obtained in-focus information to the selector 2008 and the in-focus image layer position setting unit 2010.

The in-focus degree of the tile image data may be determined by, for example, referring to in-focus information previously added to the tile image data. Alternatively, the determination may be made using an image contrast when the in-focus information is not previously added to the tile image data. The image contrast may be calculated according to the following formula assuming that the image contrast is E and the brightness component of pixels is L (m, n). Here, m indicates a position of the pixels in the Y direction, and n indicates the position of the pixels in the X direction.

E=Σ(L(m,n+1)−L(m,n))²+Σ(L(m+1,n)−L(m,n))² (Formula 1)

A first term on the right side indicates a difference in brightness between the adjacent pixels in the X direction, and a second term on the right side indicates a difference in brightness between the adjacent pixels in the Y direction. The image contrast E may be calculated by the sum of squares of the difference in brightness between the pixels adjacent in the X and Y directions.

The in-focus image layer position setting unit 2010 outputs the layer position of an in-focus image to the image data selection unit 303 based on the in-focus information output from the in-focus determination unit 2009.

The interpolation image data generation unit 2011 generates time-divided-display tile image data using the layer position information of tile image data before scrolling acquired from the image data buffer 2012 and an in-focus image at a scrolling destination output from the selector 2008. In the embodiment, a plurality of tile image data is generated by interpolation processing. The interpolation processing will be described in detail later. The generated time-divided-display tile image data is stored in the image data buffer 2012.

The image data buffer 2012 buffers image data generated by the selector 2008 and the interpolation image data generation unit 2011 and outputs the image data to the display image data generation unit 2013 according to display orders.

The display image data generation unit 2013 generates display image data to be displayed on the display apparatus 103 based on the image data acquired from the image data buffer 2012 and outputs the same to the display image data output unit 2014.

The display image data output unit 2014 outputs the display image data generated by the display image data generation unit 2013 to the display apparatus 103 serving as an external apparatus.

(Method of Generating Time-Divided-Display Image Data and Display Control)

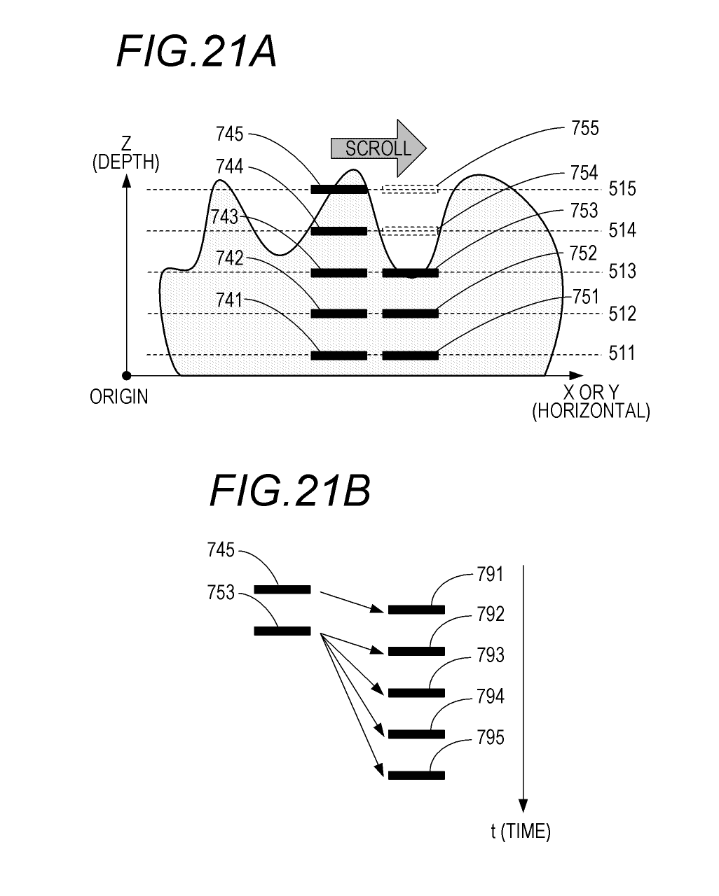

FIGS. 21A and 21B are diagrams showing the concept of a method of switching a display image when the user performs an operation (scrolling) to move the display area of an image in the horizontal direction.

FIG. 21A is a diagram showing some positions (near the fourth horizontal region and the fifth horizontal region) of FIG. 6A. In FIG. 21A, tile image data 741 to 745 is image generated by picking up an image of a region in which the test sample 502 exists, each indicating an in-focus image. The same applies to tile image data 751 to 753. Symbols 754 and 755 indicate regions in which the test sample 502 does not exist, indicating that tile image data does not exist. Note that the regions of symbols 754 and 755 are regions in which an image of the test sample 502 has not been initially picked up or data has been deleted after picking up the image.

The non-existence of data out of the existence range of the test sample 502 implies that an image is not picked up since it is out of an in-focus range, which contributes to reduction in time required for acquiring the data. Similarly, the deletion of data after being acquired implies that the capacity of a storage retention medium such as a memory to store the data is efficiently used.

It is assumed that an operation instruction (scrolling in the horizontal direction) is given to display the fifth horizontal region (second area) on the right side in a state in which the tile image data 745 (first image data) of the fourth horizontal region (first area) of FIG. 21A is being displayed. The tile image data 745 is an image at a layer position close to the front surface of the test sample 502.

Here, the front surface of the test sample 502 indicates the periphery of the test sample in the XZ or YZ cross section and indicates the surface of the stump of tissues or cells contacting a cover glass 504 or a sealant on the side of the cover glass 504. On the side of a slide, the front surface of the test sample 502 indicates the surface of the stump of tissues or cells contacting the slide or a sealant.

After the scrolling operation, tile image data (second image data) to be displayed after the scrolling (after a display area is changed) is selected from among Z-stack image data (tile image data 751 to 753) of the fifth horizontal region. In this example, tile image data does not exist at the same layer position 755 as that of the tile image data 745 (first image data) displayed before the scrolling. When the tile image data at the same layer position as that of the currently-displayed tile image data 745 does not exist as described above, it is required to prepare image data instead of the tile image data at the same layer position.

As the alternate display image data, tile image data at a layer position different from that of the tile image data 745 is selected from the Z-stack image of the fifth horizontal region. Here, the tile image data 753 having the same positional relationship as that of the tile image data 745, that is, the tile image data 753 at a position close to the front surface of the test sample 502 in the structure of the test sample 502 is selected. Note that although the embodiment describes an example in which the tile image data 753 is selected, the tile image data 752 or 751 may be used so long as any tile image data exists.

As described above, in a case in which the tile image data does not exist at the same layer position as that of the image displayed before the scrolling when the user gives the operation instruction to move the display position in the horizontal direction, the image data at the different layer position may be selected to display the image.

FIG. 21B is a diagram for describing the display concept of interpolation image data when a display is switched from the tile image data 745 to the tile image data 753 at a different layer position.

When a display is switched to tile image at a different layer position at the scrolling, the joint between tile images becomes discontinuous, which results in the occurrence of an artifact. Although the artifact may not cause a problem in a high-speed scrolling display, the user does not notice the switching of a layer position during an observation when an image is displayed with an auto focus function, that is, when a constantly-in-focus image is displayed. In the embodiment, when the display is switched to an image at a different layer, interpolation image data (third image data) to indicate a change in depth position (focal position) between image data before and after the scrolling is generated and displayed.

In the embodiment, time-divided-display interpolation image data 792 to 794 generated from the tile image data 753 after the scrolling is displayed during the switching of the display from the tile image data 745 to the tile image data 753.

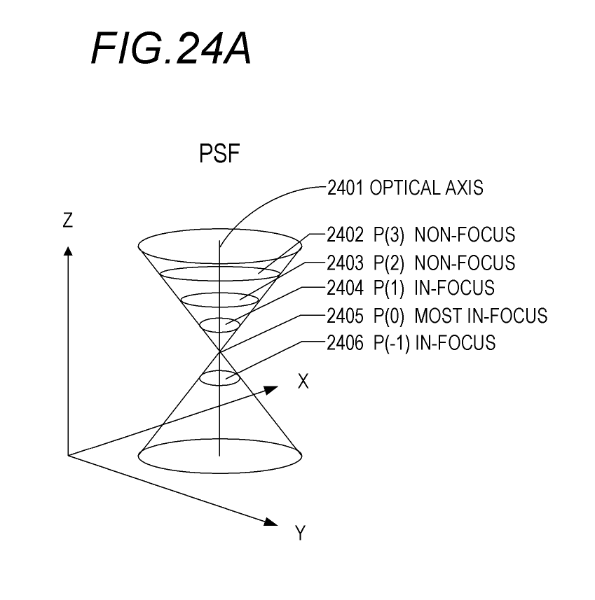

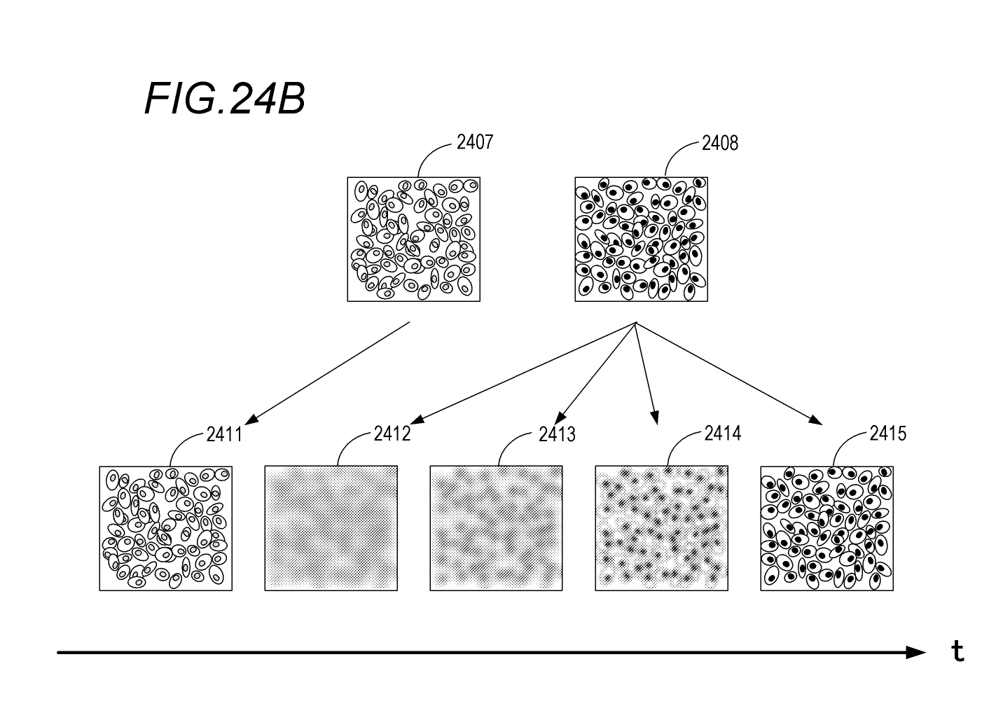

First, display image data 791 is generated from the tile image data 745 before the scrolling. Next, the tile image data 753 to be displayed after the scrolling is subjected to processing (blurring processing) to change its in-focus degree to successively generate the time-divided-display interpolation image data 792 to 794. A method of generating image data different in in-focus degree will be described with reference to FIGS. 24A and 24B. Finally, display image data 795 is generated from the tile image data 753 serving as an in-focus image.

The generated display image data 791 to 795 is displayed in the order of a time axis (t). Note that the time-divided-display interpolation image data may be generated simultaneously when the time-divided-display image data is displayed.

Actually, the tile image data 753 after the scrolling may be partially displayed depending on a scrolling speed or a display magnification. In addition, when the scrolling speed is fast, the display may be switched to an image at a next scrolling destination before the display image data 795 generated from the tile image data 753 is displayed. In any case, when the display is switched from the tile image data 745 to the tile image data 753, the interpolation image data is added on its way to switch the display from a non-focus (blurred) image to an in-focus image with time. Such a change in the display allows the user to intuitively understand the switching of a layer position (depth position) with the scrolling.

(Main Flow of Display Processing: Display Position Change Processing)

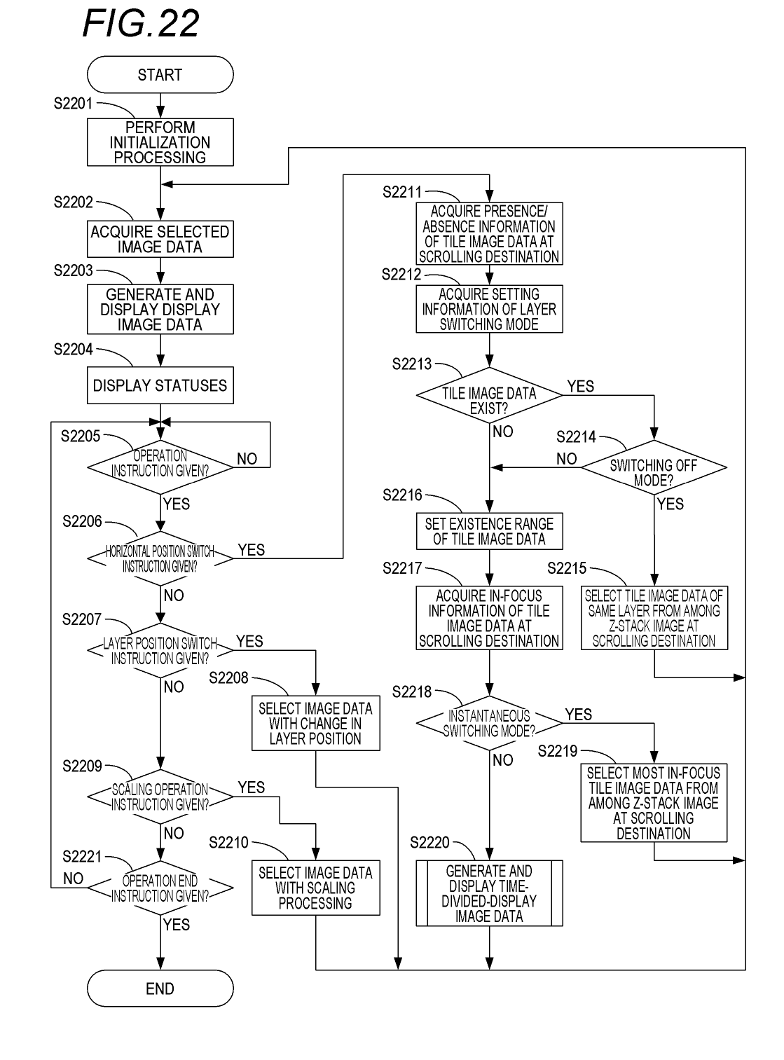

A description will be given, with reference to the flowchart of FIG. 22, of the flow of main processing to switch the display of an image in the image processing apparatus according to the embodiment.

FIG. 22 is a flowchart for describing the flow of the selection of in-focus image data at the switching of the display of an image and processing to switch a display image.

In step S2201, initialization processing is performed. In the initialization processing, the initial values of a display start horizontal position, a display start vertical position, a layer position, a display magnification, a layer switching mode, or the like required to perform the initial display of an image are set. Then, the processing proceeds to step S2202.

The type of the setting information of the layer switching mode includes, for example, a “switching off mode,” an “instantaneous display switching mode,” a “different in-focus image switching mode,” and a “different layer image switching mode,” and any one of these modes is set.

In the case of the “switching off mode,” the layer position of an image displayed after the scrolling is set at the same layer position as that of a display image before the scrolling when a (scrolling) operation instruction to move a display position in the horizontal direction is given from the user. This mode is based on the premise that tile image data exists at the same layer position.

The “instantaneous display switching mode” is a mode in which a most in-focus image is selected as an image displayed after the scrolling is selected and a display is directly switched from an image before the scrolling to the image after the scrolling when the same operation instruction is given.

In the cases of the “different in-focus image switching mode” and the “different layer image switching mode,” a most in-focus image is selected as an image displayed after the scrolling and image interpolated between a display image before the scrolling and the display image after the scrolling is prepared when the same operation instruction is received. These modes are modes in which the display of the images is switched on a time-divided basis. The processing described with reference to FIG. 21B is an example of the “different in-focus image switching mode.” The “different layer image switching mode” will be described in another embodiment. Both the modes are different in the generation of interpolation images to display an image on a time-divided basis.

In the embodiment, the following description will be given assuming that the “different in-focus image switching mode” is set as the initial value of the layer switching mode.

Although the initial value of the layer switching mode is set in the initialization processing, it may be set when a previously-prepared setting file is read. Alternatively, the initial value may be newly set or their setting contents may be changed when the setting screen of the layer switching mode is called. That is, the modes may be selected (switched) automatically or manually.

In the initialization processing (S2201), image data to perform the initial display of an image is selected. As an image to perform the initial display, the whole image of a test sample 502 is, for example, applied.

In order to display the whole image, hierarchical image data of the fourth hierarchy is selected as image data of the lowest magnification based on the setting values of the display start horizontal position, the display start vertical position, the layer position, and the display magnification described above. In the embodiment, the image data of the fourth hierarchy is selected. However, the image data of other hierarchies may be used. After the selection of the image data to perform the initial display of the image, the processing proceeds to step S2202.

In step S2202, the image data based on the values set in step S2201 is acquired, or image data selected in step S2208, S2210, S2215, S2219, and S2220 that will be described later is acquired, and then the processing proceeds to step S2203.

In step S2203, display image data is generated from the image data acquired in step S2202. The display image data is output to the display apparatus 103. Thus, a display image is updated according to a user operation (such as switching a horizontal position, switching a layer position, and changing a magnification).

In step S2204, various statuses on the displayed image data are displayed. The statuses may include information such as user setting information, the display magnification of the displayed image, and display position information. The display position information may be such that absolute coordinates from the origin of the image are displayed by numeric values or may be such that the relative position or the size of a display area with respect to the whole image of the test sample 502 is displayed in a map form using an image or the like. After the display of the statuses, the processing proceeds to step S2205. Note that the processing of step S2204 may be performed simultaneously with or before the processing of step S2203.

In step S2205, a determination is made as to whether an operation instruction has been given. The processing is on standby until the operation instruction is received. After the reception of the operation instruction from the user, the processing proceeds to step S2206.

In step S2206, a determination is made as to whether the content of the operation instruction indicates the switching of the horizontal position (the position on an XY plane), i.e., a scrolling operation. When it is determined that the instruction to switch the horizontal position has been given, the processing proceeds to step S2211. On the other hand, when it is determined that an operation instruction other than the operation instruction to switch the horizontal position has been given, the processing proceeds to step S2207.

In step S2207, a determination is made as to whether an operation instruction to switch the layer position of the display image has been given. When it is determined that the operation instruction to switch the layer position has been given, the processing proceeds to step S2208. On the other hand, when it is determined that an operation instruction other than the operation instruction to switch the layer position has been made, the processing proceeds to step S2209.

In step S2208, processing to change the layer position of the displayed image is performed with the reception of the operation instruction to switch the layer position, and then the processing returns to step S2202. Specifically, a change in the layer position with an operation amount is confirmed, and the image data of the corresponding layer position is selected.

In step S2209, a determination is made as to whether a scaling operation instruction to change a display magnification has been given. When it is determined that the instruction to perform the scaling operation has been given, the processing proceeds to step S2210. In step S2210, processing to change the display magnification of the displayed image is performed, and then the processing returns to step S2202. When it is determined that an instruction other than the operation instruction to perform the scaling operation has been received, the processing proceeds to step S2221. Specifically, a scaling amount accompanied with an operation amount is confirmed, and image data suiting a display magnification is selected from corresponding hierarchical image data.

In step S2211, a horizontal position displayed after the scrolling is confirmed based on the operation amount, tile image data presence/absence information indicating whether tile image data capable of being displayed at the corresponding position exists in Z-stack image data is acquired, and then the processing proceeds to step S2212.

In step S2212, the setting information of the layer switching mode is acquired, and then the processing proceeds to step S2213. Note that the processing of step S2212 may be performed simultaneously with or before the processing of step S2211.

In step S2213, a determination is made as to whether tile image data exists at the same layer position as that of image data displayed before a scrolling operation instruction based on the presence/absence information of the tile image data acquired in step S2211. When it is determined that the tile image data does not exist, the processing proceeds to step S2216. On the other hand, when it is determined that the tile image data exists, the processing proceeds to step S2214.

In step S2214, a determination is made as to whether the layer switching mode has been set in the “switching off mode.” When it is determined that the layer switching mode has been set in the “switching off mode,” the processing proceeds to step S2215. On the other hand, when it is determined that the layer switching mode has been set in any mode other than the “switching off mode,” the processing proceeds to step S2216.

In step S2215, the tile image data at the same layer position as that of the tile image data displayed before the scrolling operation instruction is selected from among the Z-stack image data at a scrolling destination as the image data displayed after the scrolling, and then processing returns to step S2202.

In step S2216, the existence range (the range of the layer position) of the Z-stack image data at the scrolling destination is acquired and set based on the fact that the tile image data does not exist at the same layer position as the layer position before the scrolling, and then the processing proceeds to step S2217.

In step S2217, the in-focus information of the respective tile image data within the existence range set in step S2216 is acquired, and then the processing proceeds to step S2218.

In step S2218, a determination is made as to whether the layer switching mode has been set in the “instantaneous switching mode.” When it is determined that the layer switching mode has been set in the “instantaneous switching mode,” the processing proceeds to step S2219. On the other hand, when it is determined that the layer switching mode has been set in any mode other than the “instantaneous switching mode,” the processing proceeds to step S2220. Note that the “different in-focus image switching mode” is assumed as another layer switching mode in the embodiment.

In step S2219, most in-focus tile image data is selected from among the Z-stack image data at the scrolling destination, and then the processing returns to step S2202. As a method of selecting the in-focus tile image data, in-focus information added to the respective tile image data is compared with each other based on the existence range of the tile image data acquired in step S2216 to select the tile image data having the highest in-focus degree. The comparison of the in-focus information added to the tile image data is exemplified as the method of selecting the most in-focus tile image data, but other method may be used. It may also be possible to compare the contrast values of all the tile image data within the existence range of the tile image data with each other to select the most in-focus tile image data.

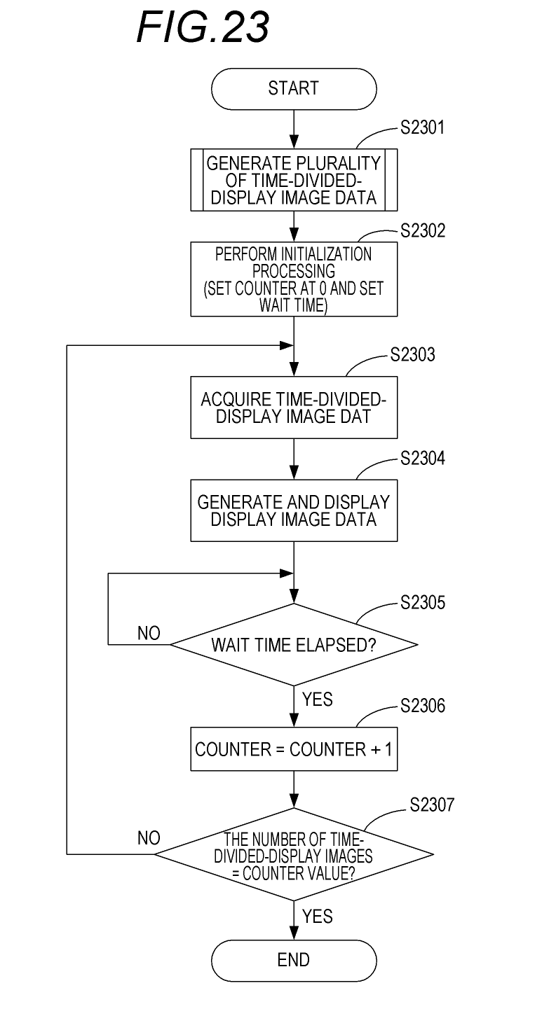

In step S2220, most in-focus tile image data is selected like step S2219 based on the in-focus information acquired in step S2217 to generate a plurality of display image data different in in-focus degree used in the “different in-focus image switching mode.” The generated display image data is successively displayed on a time-divided basis, and then the processing returns to step S2202. The details of the processing will be described with reference to FIG. 23.

In step S2221, a determination is made as to whether an ending operation has been performed. The processing returns to step S2205 to be on standby until the ending operation has been performed. When it is determined that the ending operation has been performed, the processing ends.

As described above, depending on how the user performs the operation instruction to switch the display of an image, the scrolling display (horizontal position changing display) and the scaling display of a display image and the switching display of a layer position are performed. In addition, the display of an image is switched corresponding to the setting contents of the layer switching mode. For example, when the layer positions of tile image data before and after the scrolling are different from each other, interpolation image data is generated and the display of an image is switched on a time-divided basis to display a change process as an image.

(Flow of Generating and Displaying Time-Divided-Display Image Data)

A description will be given, with reference to the flowchart of FIG. 23, of the flow of processing to generate and switch the display of time-divided-display tile image data after a scrolling operation in the image processing apparatus according to the embodiment.

FIG. 23 is the flowchart showing the flow of the processing to generate and display the time-divided-display tile image data performed in step S2220 of FIG. 22.

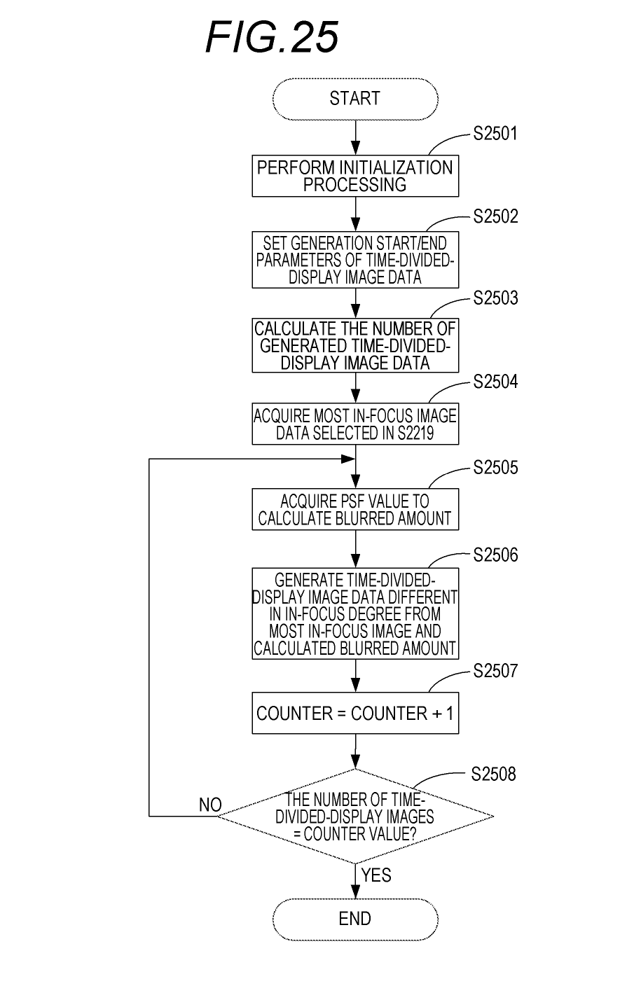

In step S2301, a plurality of time-divided-display interpolation image data is generated based on the in-focus image selected in step S2219 of FIG. 22, and then the processing proceeds to step S2302. The concept and the processing flow of the processing to generate the plurality of time-divided-display interpolation image data performed in step S2301 are described in detail with reference to FIG. 24 and FIG. 25, respectively.

In step S2302, initialization processing is performed. In the initialization processing, a counter value used to generate the plurality of time-divided-display interpolation image data is initialized to zero. In addition, wait time to determine a display interval at time-divided display is set, and then the processing proceeds to step S2303.

In step S2303, interpolation image data to be displayed is acquired from the plurality of time-divided-display interpolation image data so as to suit the counter value, and then the processing proceeds to step S2304.

In step S2304, display image data is generated from the time-divided-display interpolation image data acquired in step S2303 and displayed, and then the processing proceeds to step S2305.

In step S2305, a determination is made as to whether the wait time set in step S2302 has elapsed. The processing is on standby until the time has elapsed, and then proceeds to step S2306 after the elapse of the wait time.

In step S2306, the counter value is incremented by one, and then processing proceeds to step S2307.

In step S2307, the total number of the time-divided-display interpolation image data generated in step S2301 and the counter value updated in step S2306 are compared with each other. When the counter value has not reached the number of the time-divided-display interpolation image data, it is determined that any of the time-divided-display interpolation image data, which has not been displayed, exists, and then the processing returns to step S2303. On the other hand, when the counter value has reached the number of the time-divided-display interpolation image data, it is determined that all the time-divided-display interpolation image data have been displayed, and then the time-divided-display processing ends.

As described above, the plurality of time-divided-display interpolation image data is generated and successively switched and displayed at a set time interval, whereby the user may be informed of the fact that the tile image data different in layer position is selected by the scrolling.

(Generation of Interpolation Images Different in in-Focus Degree)

A description will be given, with reference to FIGS. 24A and 24B, of the concept of the generation of a plurality of image data different in in-focus degree in the image processing apparatus according to the embodiment.

FIG. 24A is a schematic diagram showing the relationship between a point spread function (PSF) used to generate a plurality of image data different in in-focus degree and the layer positions of the generated image data.

FIG. 24A shows an example of the PSF as the characteristics of an image forming optical system when an image of the tile image data 752 described with reference to FIG. 21A is, for example, picked up.

Symbol 2401 indicates the optical axis of the imaging apparatus 101. Symbol 2402 indicates the spread of the PSF corresponding to the layer position of the tile image data 755. Similarly, symbols 2403 to 2406 indicate the spreads of the PSF corresponding to the layer positions of the tile image data 754 to 751, respectively. Here, the tile image data 752 is the most in-focus tile image data.

FIG. 24B shows processing to generate time-divided-display interpolation image data from a display image 2411 generated from tile image data 2407 displayed before the scrolling operation and tile image data 2408 selected to be displayed after the scrolling operation. Note that the embodiment shows an example in which the tile image data 2408 is finally displayed after the scrolling operation in a state in which the tile image data 2407 is being displayed.

The display image data 2411 is image data generated as a display image based on the tile image data 2407 and displayed before the scrolling operation. The display image data 2412 to 2415 is time-divided-display interpolation image data different in in-focus degree generated based on the tile image data 2408. These are image data displayed on a time-divided basis after the scrolling operation. The display image data 2411 to 2415 is displayed along a time axis (t).

The images shown by the display image data 2411 to 2415 have a correspondence relationship with the display image data 791 to 795 described with reference to FIG. 21B. Based on the most in-focus tile image data 752, the display image data 2412 to 2414 generate images considering the spreads of the PSF corresponding to distances from the layer position of the tile image data 752. Specifically, the respective image data 2412 to 2414 is generated by the tile image data 752 and the convolution of the PSF at the respective layer positions.

As described above, the plurality of image data different in in-focus degree may be artificially generated from the one image data in an in-focus state using the PSF.

(Flow of Generating Non-Focus Images Different in in-Focus Degree)

A description will be given, with reference to the flowchart of FIG. 25, of the flow of processing to generate time-divided-display image data (a plurality of images different in in-focus degree) in the image processing apparatus according to the embodiment.

FIG. 25 shows the detailed flow of the processing content performed in step S2301 of FIG. 23. In step S2501, initialization processing is performed. In the initialization processing, the initial value of a counter for use in loop processing to generate a plurality of time-divided-display tile image data is set, and then the processing proceeds to step S2502.

In step S2502, a generation start parameter to start the generation of the plurality of time-divided-display image data different in in-focus degree and a generation end parameter are set. Here, for example, the layer position of the tile image data 755 is set as the generation start parameter, and the layer position of the tile image data 752 is set as the generation end parameter. Then, the processing proceeds to step S2503.

In step S2503, the distance between the respective layer positions is calculated from the generation start and generation end parameters of the images different in in-focus degree, and the number of the generated time-divided-display image data is calculated with the depth of field defined by the NA of the image forming optical system 207. For example, the depth of field is about ±0.5 μm when the NA is 0.75. Therefore, the number of the generated time-divided-display image data is calculated in such a way as to set the interval between the display images at the range of the depth of field, i.e., 1.0 μm and divide the distance between the layer positions by the interval between the display images.

In step S2504, the most in-focus tile image data selected in the processing of step S2219 shown in FIG. 22 is acquired, and then the processing proceeds to step S2505. In the embodiment, the tile image data 752 is acquired.

In step S2505, non-focus (blurred) amounts of the respective layer positions are calculated from the value of the PSF based on a counter value. The calculated non-focus (blurred) amounts are confirmed, and the processing proceeds to step S2506.

In step S2506, the time-divided-display image data is generated from the tile image data acquired in step S2504 and the non-focus (blurred) amounts calculated in step S2505, and then the processing proceeds to step S2507.

For example, the non-focus amounts of the display images are calculated by the following formulae assuming that the tile image data 745 displayed before the scrolling operation instruction is I4(5) and the most in-focus image data 752 selected after the scrolling operation instruction is I5(2).

Non-focus amount B(0) of the image of the display image data 791=I4(5)

Non-focus amount B(1) of the image of the display image data 792=I5(2)**P(3)

Non-focus amount B(2) of the image of the display image data 793=I5(2)**P(2)

Non-focus amount B(3) of the image of the display image data 794=I5(2)**P(1)

Non-focus amount B(4) of the image of the display image data 795=I5(2)**P(0)

Note that ** indicates the convolution, and P(i)(i=0 to 3) indicates the value of the PSF shown in FIG. 24A.

In step S2507, the counter value is incremented, and then the processing proceeds to step S2508.

In step S2508, the number of the generated time-divided-display image data and the counter (the number of the generated images) are compared with each other to determine whether the number of the generated images has reached a prescribed generation number. When it is determined that the number of the generated images has not reached the prescribed number, the processing returns to step S2505 to repeatedly perform the processing. When it is determined that the number of the generated images has reached the prescribed number, the processing to generate the time-divided-display image data ends. As described above, the plurality of image data different in in-focus degree may be generated from the one in-focus image data using the PSF.

In the embodiment as well, the information of image data and layers may be displayed with the same display screen layout (FIG. 13) as that of the first embodiment.

### Effects of Embodiment

According to the embodiment, since the display of an image is automatically switched to an appropriate layer position when tile image data at the same layer position does not exist at a scrolling destination, the user is allowed to continuously observe the image without performing a new operation.

In particular, when the layer position of a display image is automatically switched, the user is clearly informed of the fact that the layer position has been changed with a change in display image (in-focus degree). Therefore, the user is allowed to easily recognize the switching of the layer position.

As a result, it becomes possible for the user to observe test samples such as tissues and cells having different thicknesses in the horizontal direction through an easy operation and improve the convenience of pathological analyses.

### Fifth Embodiment

### Apparatus Configuration of Image Processing System

In the fourth embodiment, the user is informed of the fact that the layer position is automatically changed when he/she performs the scrolling operation with the display of the interpolation images obtained by subjecting the in-focus image to the blurring processing. In a fifth embodiment, the same effects as those of the fourth embodiment are realized in such a way as to display Z-stack image data in the area of a scrolling destination on a time-divided basis. Hereinafter, a point unique to the fifth embodiment will be mainly described, and the descriptions of the same configurations and contents as those of the fourth embodiment will be omitted.

An image processing system has the same configuration as that of the second embodiment (FIG. 14). That is, the system of the embodiment is configured such that image data acquired by the imaging apparatus 101 is temporarily stored in the image server 1401 and then read by the image processing apparatuses 102 and 1404 connected via the network. The network 1402 may be a LAN or a wide area network such as the Internet.

(Display of Z-Stack Image on Time-Divided Basis)

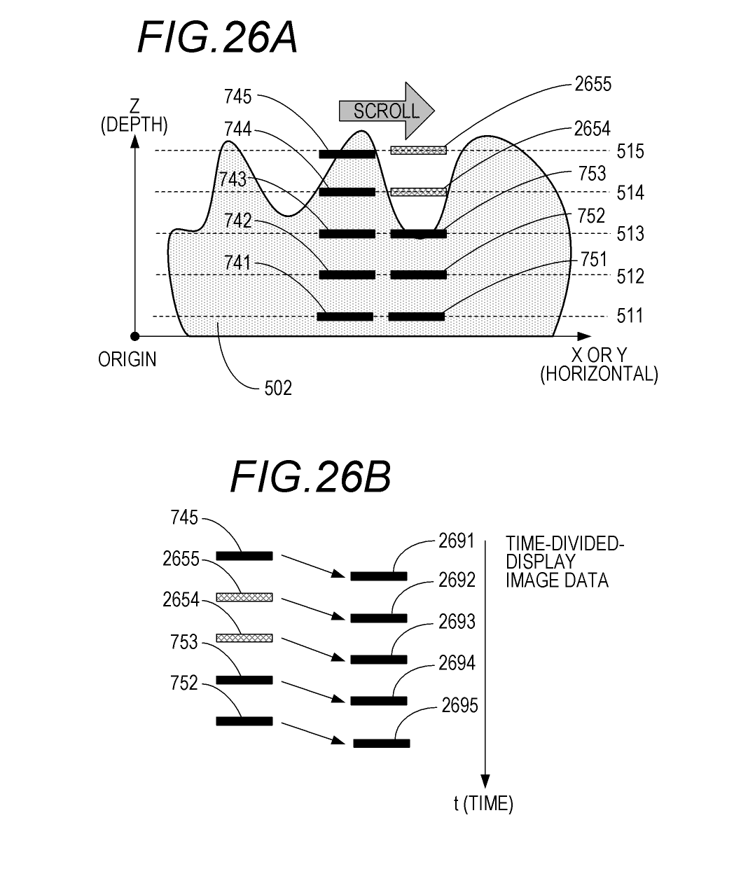

FIGS. 26A and 26B are diagrams showing the concept of a method of switching a display image when the user performs an operation (scrolling) to move the display area of the image in the horizontal direction. The descriptions of the same contents as those of FIGS. 21A and 21B described in the fourth embodiment will be omitted.

FIG. 26A is a diagram showing some positions (near the fourth horizontal region and the fifth horizontal region) of FIG. 6A. FIG. 26A is similar to FIG. 21A. FIG. 26A is different from FIG. 21A in that Z-stack tile image data 2655 and 2654 exists in regions in which the test sample 502 does not exist. The focal positions of the tile image data 2655 and 2654 are indicated by symbols 515 and 514, respectively, and the test sample 502 does not actually exist in the regions. Therefore, the tile image data 2655 and 2654 are images blurred corresponding to respective depths with respect to the tile image data 753 at the focal position 513.

It is assumed that a scrolling operation is performed to change a display to the fifth horizontal region (second area) on the right side in a state in which the tile image data 745 (first image data) of the fourth horizontal region (first area) is being displayed. As a display image after the change of the display area, it is assumed that the most in-focus tile image data 752 (second image data) is selected from among the Z-stack image data of the fifth horizontal region. In the embodiment, when the display is switched from the tile image data 745 to the tile image data 752, the tile image data 2655, 2654, and 753 same in area as but different in layer from the tile image data 752 is displayed as the interpolation image data (third image data). Each of the tile image data 2655 and 2654 is a non-focus image, and the tile image data 753 is an in-focus image but is not a most in-focus image. The generation of display image data will be described with reference to FIG. 26B.

FIG. 26B is a diagram for describing the concept of the display of the interpolation image data when the display is changed from the tile image data 745 to the tile image data 752 at a different layer position.

Symbol 2691 indicates display image data corresponding to the currently-displayed tile image data 745, and symbol 2695 indicates display image data corresponding to the tile image data 752 displayed after the area is changed. Further, symbols 2692 to 2694 indicate time-divided-display interpolation image data displayed between the image data 2691 and 2695. The interpolation image data 2692 to 2694 is, respectively, generated from the tile image data 2655, 2654, and 753 at the layers between the layer 515 of the tile image data 745 and the layer 512 of the tile image data 752 in the area to which the display is changed. In the embodiment, when the image data 2691 is switched to the image data 2695, the five image data items 2691, 2692, 2693, 2694, and 2695 are displayed in the order of a time axis (t).

Accordingly, the display after the scrolling is switched from a non-focus image to an in-focus image with time, whereby the user may be informed of the switching of the display through the display image.

Like the fourth embodiment, such display control is equivalent to a case in which the view of an optical image observed through the eyepiece of an optical microscope is simulated on a display. Therefore, it becomes possible for the user to perform an observation without having an uncomfortable feeling.

(Flow of Setting Time-Divided-Display Image Data Using Z-Stack Image)

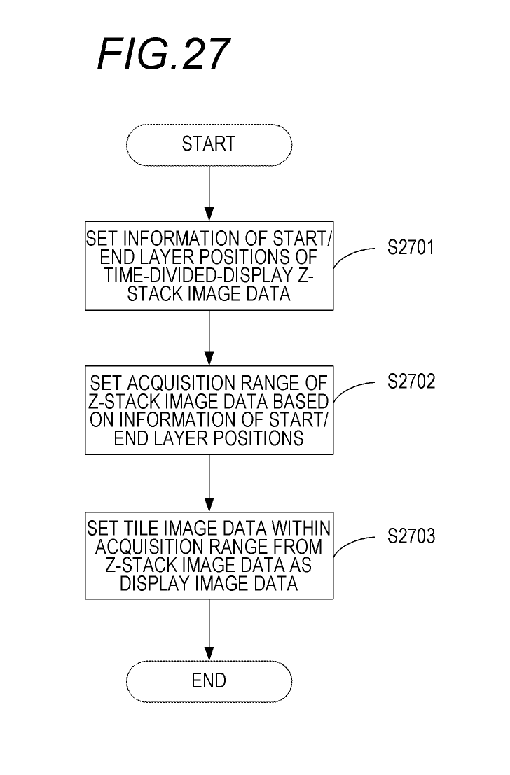

A description will be given, with reference to the flowchart of FIG. 27, of the flow of processing to set time-divided-display image data using Z-stack image data in the image processing apparatus according to the embodiment.

FIG. 27 shows the detailed flow of the processing content performed in step S2301 of FIG. 23 described in the fourth embodiment. The embodiment is different from the fourth embodiment in that previously-acquired Z-stack image data is used in the embodiment while the interpolation image data is newly generated from the tile image data to be displayed after the scrolling in the fourth embodiment. The processing of the generation in step S2301 refers to the selection and setting of image data.

Note that the following description will be given assuming that the “different layer image switching mode” has been set as a layer switching mode in the embodiment. Note that the description of a main flowchart will be omitted since it is the same as that of the fourth embodiment.

In step S2701, layer position information to determine the acquisition range of time-divided-display tile image data among acquired Z-stack image data is acquired and set. Specifically, the position information is acquired and set in which the layer position 515 of the tile image data before the scrolling is a starting position and the layer position 512 of the in-focus image data finally displayed after the scrolling is an ending position. Then, the processing proceeds to step S2702.

In step S2702, the range of acquiring the plurality of tile image data from the display start to the display end from the Z-stack image data is set based on the layer position information set in step S2701. After the setting of the acquisition range, the processing proceeds to step S2703.

In step S2703, the tile image data within the acquisition range is selected from among the Z-stack image data and set as the display image data, and then processing ends. As described above, the tile image data different in focal position may be set from the Z-stack image data.

(Example of Switching Display of Image)

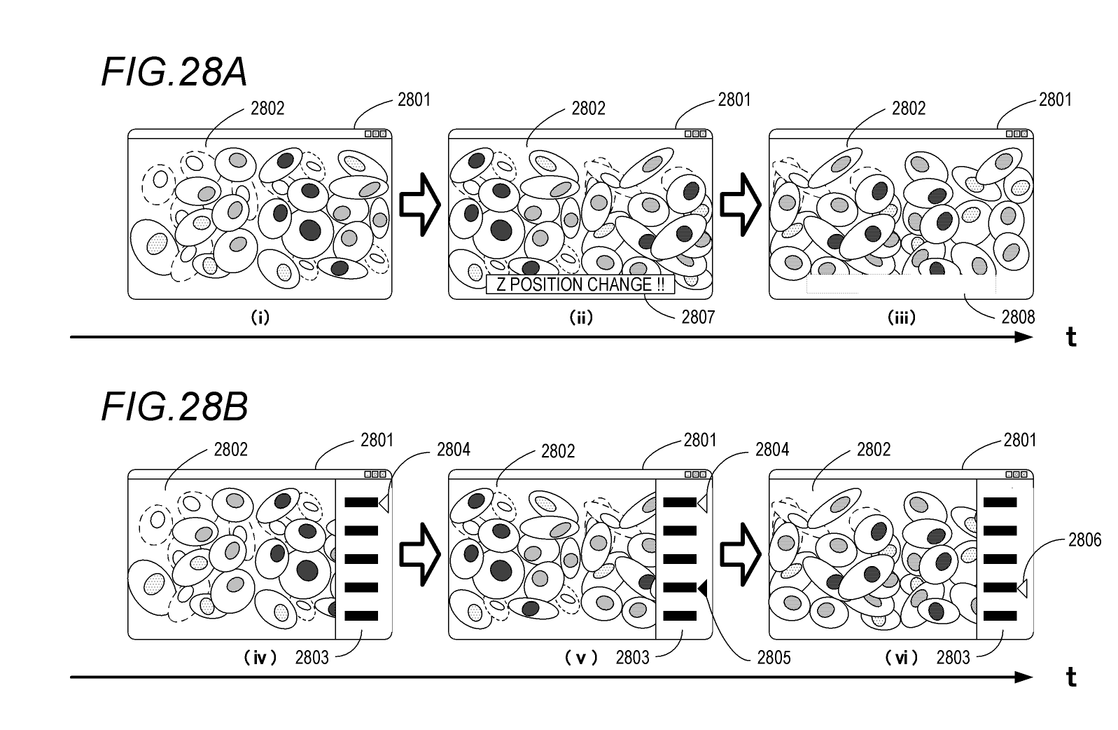

FIGS. 28A and 28B are diagrams showing an example of the switching display of an image.

FIG. 28A shows an example in which the user is informed by characters (texts) of the fact that the layer position (depth position) of tile image data displayed in a display region 2802 has been changed during a scrolling operation at a timing at which the layer position has been changed.

(i), (ii), and (iii) indicate the elapse of time and show an example in which a display inside a window 2801 is switched by turns with time (t). (i) shows an example of a display screen displayed before the scrolling operation. A detailed image 2802 of the test sample 502 is displayed in the whole window 2801. (ii) shows an example of a layer switching alerting display 2807 indicating that a layer position has been changed before and after the scrolling when the user performs the scrolling operation. The text image (third image data) “Z position change!!” is displayed on the detailed image 2802 in an overlaying fashion. (iii) shows an example in which the user stops the scrolling operation to dismiss the alerting display 2807. The alerting display 2807 may be automatically dismissed after the elapse of specific or arbitrary time. Alternatively, the user may dismiss the alerting message with an operation (for example, by pressing the alerting message, moving a mouse cursor to the position of the alerting message, inputting any keyboard key to which a dismissing function is allocated, or the like). In addition, in this example, the alerting message is displayed in a text form. However, it may also be possible to inform the user of the alerting message by the display of graphic data, a change in the brightness of a screen, and the use of a speaker, a vibration device, or the like.

FIG. 28B shows an example in which a layer position is displayed in another display region as a method of informing the user of the fact that the layer position has been automatically switched by the scrolling operation.

(iv), (v), and (vi) indicate the elapse of time and show an example in which a display in a window 2801 is switched by turns with time (t).

(iv) shows an example of a display screen displayed before the scrolling operation. A layer position display region 2803 is a display region to display the number of the layers of a Z-stack image and a graphic image (third image data) indicating a layer position that is being displayed. In (iv), the layer position of tile image data before the scrolling is indicated by a white triangle 2804. That is, the tile image data at the top layer is being displayed. (v) shows a display example of a case in which the layer position of the display image is switched and displayed by the scrolling operation. The white triangle 2804 indicating the layer position before the switching and a black triangle 2805 indicating a layer position after the switching are displayed. (vi) shows a state in which the scrolling and the switching of the layer position have been completed. With a change in graphic from the black triangle 2805 to the white triangle 2806, the user is allowed to notice the completion of the switching of the display.

As described above, it is also possible to inform the user of a change in layer position (depth position) in such a way as to alert the change in layer position in a text form or clearly indicate the layer position before and after the scrolling.

### Effects of Embodiment

Like the fourth embodiment, the embodiment may provide the image processing apparatus capable of generating a virtual slide image allowing the user to be clearly informed of a change in the layer position of a display image.

In particular, for a visual alert with a display image, the use of previously-acquired Z-stack image data eliminates need for the generation of new display image data. In addition, the user is allowed to easily recognize the switching of a display image in the depth direction (Z direction) with the clear indication of layer positions before and after the scrolling operation.

As a result, the user is allowed to notice a discontinuous display in understanding the structure of tissues. Such information is required to perform an accurate analysis to understand the three-dimensional shape of tissues (a false diagnosis may be prevented since a change in layer position implies the likelihood of discontinuous images being joined together).

### Sixth Embodiment

### Function Blocks of Image Processing Apparatus

The fourth and fifth embodiments describe an example in which a plurality of tile image data different in in-focus degree or Z-stack image data is displayed on a time-divided basis to inform the user of an auto change in the layer position of a display image.

A sixth embodiment is different in that the information method for the user described above is automatically switched according to an observer, an observation object, an observation object, a display magnification, or the like. Hereinafter, this point will be mainly described, and the descriptions of the same configurations and contents as those of the above embodiments will be omitted.

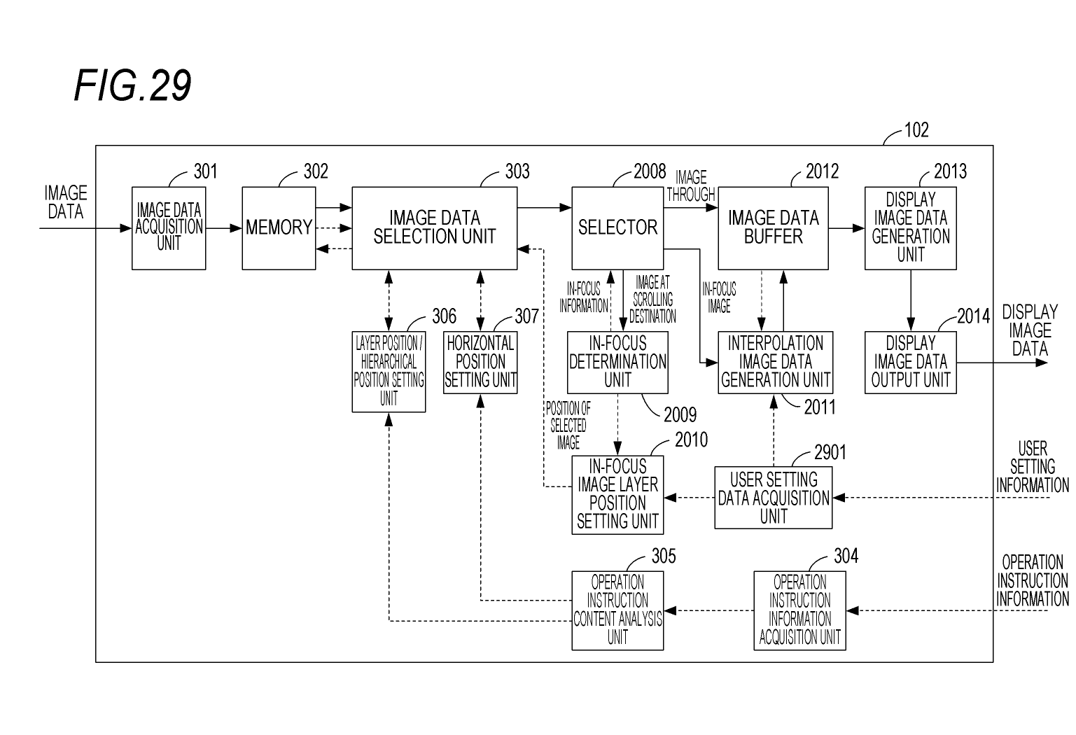

FIG. 29 is a block diagram showing the function configuration of an image processing apparatus 102 according to the embodiment. A difference in the function of the image processing apparatus 102 is a user setting data acquisition unit 2901. A description will be given of the user setting data acquisition unit 2901 as a feature of the function blocks.

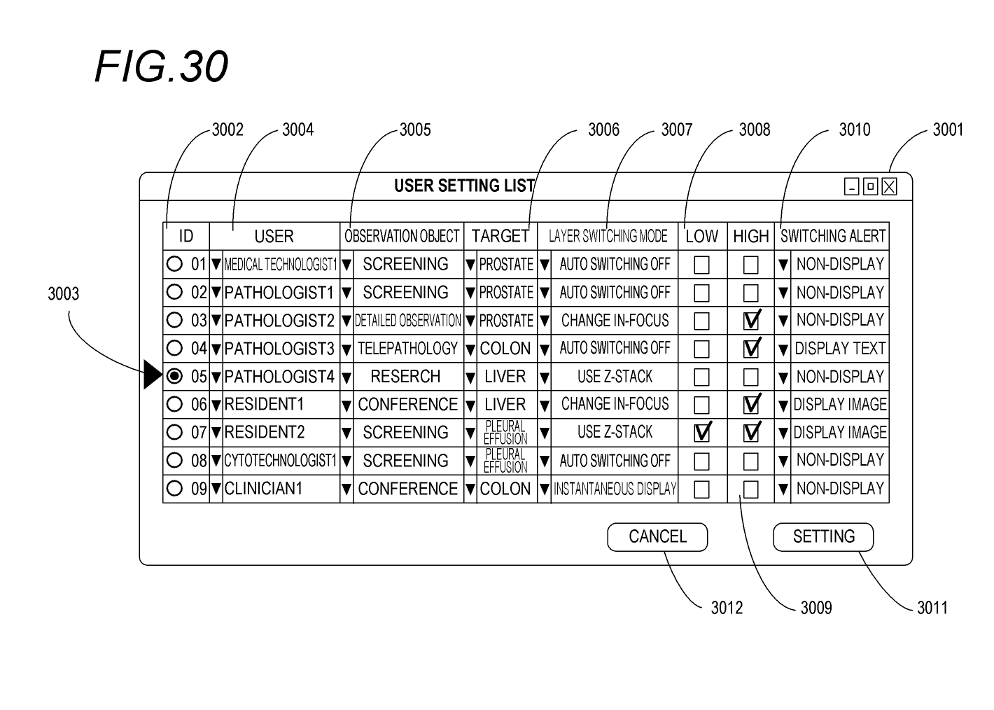

The user setting data acquisition unit 2901 acquires setting information based on a user setting list described with reference to FIG. 30. The items of the setting information will be described later. Based on the user setting information, a time-divided display, an alerting display, and a layer position display are set like the settings of the layer switching mode described above. As described above, a plurality of observation conditions including a difference in user is switched and changed based on the contents described in the user setting list, whereby a display method suiting a user's object or observation object may be selected.

(Screen for Setting User Setting List)

FIG. 30 is a diagram showing an example of a screen for setting the user setting list.

Symbol 3001 indicates the window of the user setting list displayed on a display apparatus 103. In the window of the user setting list, various setting items accompanied with the switching of an image are displayed in a list form. Here, it is possible for each of a plurality of different users to perform different settings for each observation object of the test sample 502. Similarly, it is also possible for the same user to prepare a plurality of settings in advance and call setting contents suiting conditions from the list.

A setting item 3002 includes user ID information to specify a person who observes a display image. The user ID information is constituted by, for example, radio buttons. With the setting of the user ID information, it is possible to select one of a plurality of IDs. This example shows a case in which a user ID indicated by symbol 3003 is selected from among the user ID information “01” to “09.”

A setting item 3004 includes user names. The user names are constituted by, for example, the lists of pull-down menu options and correspond to the user ID information one to one. In this example, a selection example based on the pull-down menu options is shown. However, the user may directly input a user name in a text form.

A setting item 3005 includes observation objects. The observation objects are constituted by, for example, the lists of pull-down menu options. Like the user names, a selection example based on the pull-down menu options is shown. However, the user may directly input an observation object. When it is assumed to perform a pathological diagnosis, the observation objects include screening before a detailed observation, a detailed observation, a remote diagnosis (telepathology), a clinical study, a conference, a second opinion, or the like.

A setting item 3006 includes observation targets such as internal organs from which a test sample is taken. The observation targets are, for example, constituted by the lists of pull-down menu options. A selection method and an input mode are the same as those of other items.

A setting item 3007 is a layer switching mode. As alternatives of the layer switching mode, a “switching off mode,” an “instantaneous display switching mode,” a “different in-focus image switching mode,” and a “different layer image switching mode” are available. Among them, any one of the modes may be selected. A list mode, a selection method, and an input mode are the same as those of other items.

Setting items 3008 and 3009 are used to set whether the function of automatically selecting a layer works with a display magnification at the observation of a display image. The designation of a link to a target magnification in a check box allows the selection of “checked” and “unchecked.” In this example, switching selection with the check box is shown. However, a pull-down menu may be used to set a link to a target magnification.

The selection of the “checked” in a low-magnification check box indicates that the processing set in the setting item 3007 is performed at a low-magnification observation, while the selection of the “unchecked” indicates that the processing set in the setting item 3007 is not performed at the low-magnification observation. The same applies to the case of a high magnification. Note that it is possible to set the details of a high magnification and a low magnification on a sub-window, which is not shown, or the like.

A setting item 3010 includes layer switching alerting display methods by which a change in layer position before and after the scrolling is expressed. The setting lists of the layer switching alerting display methods are constituted by, for example, the lists of pull-down menu options. A selection method and an input mode are the same as those of the items of other setting lists other than the lists working with the magnifications. As the types of the setting lists of the layer switching alerting display methods, a “non-display mode,” an “image display mode,” and a “text display mode” are prepared. It is possible to select any one of the modes. When the “image display mode” is set as the layer switching alerting display method, a graphic image on a display screen clearly informs the user of the fact that a layer position has been switched. Similarly, when the “text display mode” is set, character strings (texts) clearly inform the user of the fact that a layer position has been switched. When the “non-display mode” is set, a layer position is not automatically updated.

Symbol 3011 indicates a “setting button.” When the setting button 3011 is clicked, the various setting items described above are stored as setting lists. When the window of the user setting list is opened next time, the stored updated contents are read and displayed.

Symbol 3012 indicates a “cancellation button.” When the cancellation button 3012 is clicked, the setting contents updated with addition, selection change, inputting, or the like are invalidated and the window is closed. When the setting screen is displayed next time, previously-stored setting information is read.

The correspondence relationship between the information of the users (observers), the observation objects, or the like and the layer switching modes is described in the data of the above user setting list, and the system automatically selects an appropriate one of the layer switching modes. Thus, when a plurality of users exists or when different display settings are desired by the same user depending on observation objects (such as screening, detailed observations, and second opinions), a layer position desired by the user(s) may be automatically selected.

(Screen Display Example of User Settings)

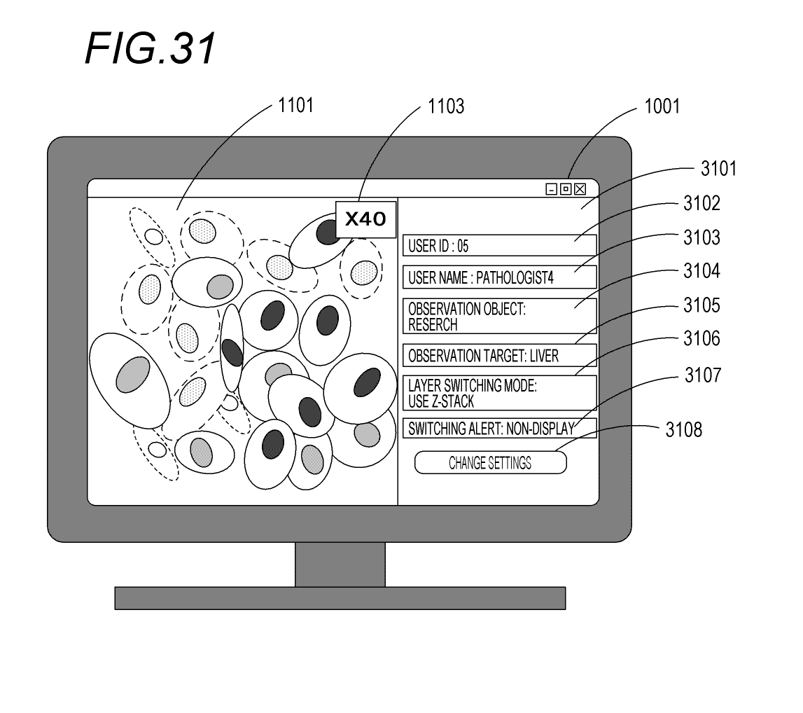

A description will be given, with reference to FIG. 31, of the display of currently-selected setting values in the user setting list described with reference to FIG. 30 and a configuration example of the display screen of the function of calling the user setting screen.

FIG. 31 is a diagram showing the display of user setting values as a feature of the embodiment and a display example of an operation UI to call the user setting screen.

In a whole window 1001 of the display screen, a display region 1101 to display an image of the test sample 502, a display magnification 1103 of the image in the display region 1101, a user setting information area 3101, a setting change button 3108 to call the user setting screen, or the like is arranged.

In the user setting information area 3101, currently-selected user setting contents 3102 to 3107 are displayed. Symbol 3102 indicates the user ID information 3002 selected from the user setting list described with reference to FIG. 30. Similarly, symbol 3103 indicates the user name 3004, symbol 3104 indicates the observation object 3005, symbol 3105 indicates the observation target 3006, symbol 3106 indicates the layer switching mode 3007, and symbol 3107 indicates the layer switching alerting display setting 3010.

When the setting change button 3108 is clicked, the user setting list described with reference to FIG. 30 is screen-displayed, and contents set and selected on the user setting screen are displayed in the user setting information area 3101.

The embodiment describes an example in which the user setting information area 3101 is provided in the whole window 1001 using a single document interface (SDI). However, a display mode is not limited to this. A separate window may be displayed using a multiple document interface (MDI). In addition, the embodiment describes an example of a case in which the setting change button 3108 is clicked to call the user setting screen. However, it may also be possible to allocate functions to short-cut keys and call the setting screen.

### Effects of Embodiment

As described above, the display settings suiting user's intentions such as observation objects and observation targets are managed in a list form and called, whereby detailed display control may be automatically performed. In addition, the area to display the setting contents is provided to switch the setting contents during an observation, whereby the user is allowed to easily confirm the setting contents and change settings.

### Seventh Embodiment

The fourth and fifth embodiments describe an example in which the user is informed of a change in layer position when the layer position is automatically switched. The fourth embodiment describes an example in which the tile image data that does not exist at a layer position is newly generated based on an in-focus image. The fifth embodiment describes an example in which tile image data at all layer positions exists in previously-acquired Z-stack image data. A seventh embodiment will describes a method of converting the Z-stack image data used in the fifth embodiment into an image data set that retains tile image data only in a range in which the test sample 502 used in the fourth embodiment exists. Note that the descriptions of the same configurations and contents as those of the above embodiments will be omitted.

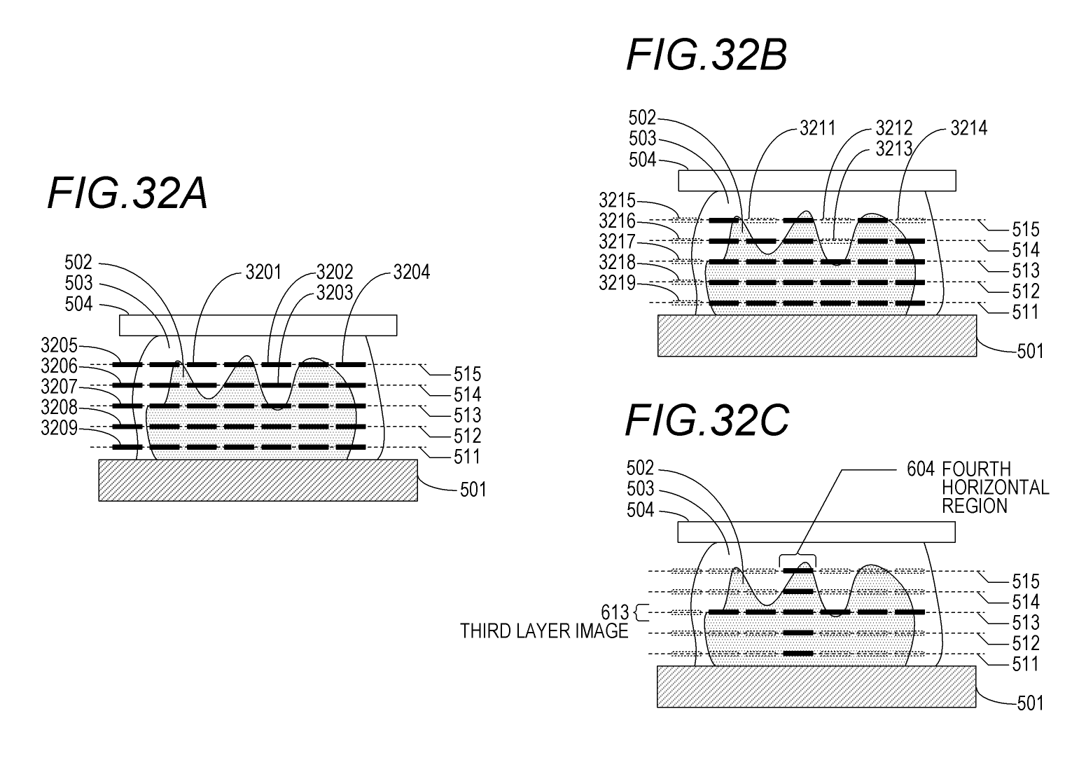

FIG. 32A is a schematic diagram showing the relationship between a slide 206 on which an image is to be picked up and the acquisition positions of tile image data. An image data set is constituted by a plurality of tile image data acquired and generated when a horizontal position and a layer position with respect to the test sample 502 are changed.

FIG. 32A shows an example in which tile image data exists in the horizontal direction and all the regions of a plurality of layer positions regardless of the existence range of the test sample 502. The image data based on the Z-stack image data used in the fifth embodiment corresponds to this data.

Tile image data 3201 to 3209 is tile image data (non-focus image) generated when images of regions in which the test sample 502 does not exist are picked up. Conversely, the tile image data items to which symbols are not assigned are in-focus images since their focal positions exist in the existence range of the test sample 502.

FIG. 32B shows image data items obtained when images of the tile image data items are not picked up or generated in the regions in which the test sample 502 does not exist. The image data used in the fourth embodiment corresponds to this data.

Image pick-up regions 3211 to 3219 indicate the regions in which the test sample 502 does not exist, and does not include the tile image data.

The feature of the embodiment is that an image data group shown in FIG. 32B is generated from a Z-stack image data group shown in FIG. 32A. Specifically, the tile image data in the regions in which the test sample 502 does not exist is deleted from the Z-stack image data to constitute the image data group. Thus, it becomes possible to delete a data amount while assuring a minimum amount of the information required for an observation.

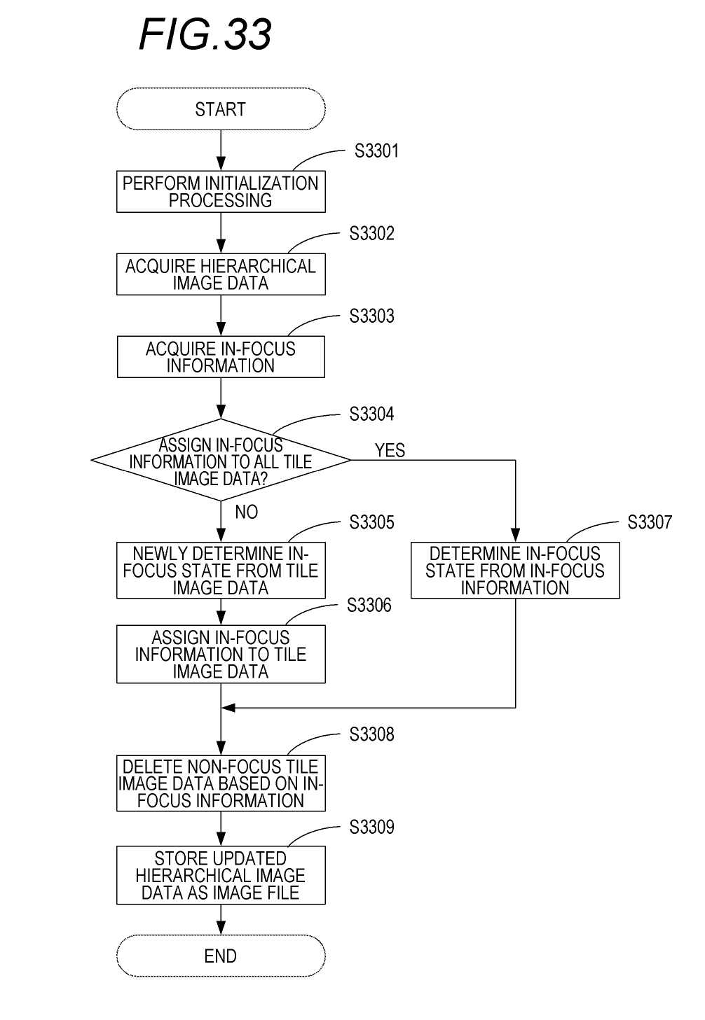

In addition, even if the in-focus information of the respective tile image data does not exist in this process, it may be calculated from image information and newly assigned to the image data. Thus, it becomes possible to determine an in-focus state in a short period of time. The process of deleting the data and assigning the in-focus information will be described with reference to the flowchart of FIG. 33.

FIG. 32C shows an example in which the processing to leave the tile image data only in the range in which the test sample 502 exists as shown in FIG. 32B is further advanced to retain the Z-stack image data only in a specific horizontal region. In this example, only the Z-stack image data in a targeted horizontal region 604 is retained based on the tile image data of a third layer 613, whereby it becomes possible to further reduce a data amount.

(Flow of Generating Input Data)

FIG. 33 is a flowchart showing the flow of processing to delete the tile image data and assign the in-focus information shown in FIGS. 32B and 32C.

In step S3301, initialization processing is performed to select an image file including a targeted Z-stack image data group, and then the processing proceeds to step S3302. In the initialization processing, the selection range of the tile image data to be deleted in step S3308 is also set. As the selection range in which the tile image data is to be deleted, a range other than the range in which the test sample 502 exists and a range other than a base layer and Z-stack image data of a specific region are, for example, assumed.

In step S3302, the image file designated in step S3301 is selected to acquire hierarchical image data. An example of the selected image file includes the image data shown in FIG. 32A. After the acquisition of the hierarchical image data, the processing proceeds to step S3303. In step S3303, the in-focus information of the respective tile image data constituting the hierarchical image data is acquired. After the acquisition of the in-focus information, the processing proceeds to step S3304.

In step S3304, a determination is made as to whether the in-focus information has been assigned to all the tile image data constituting the hierarchical image data. When it is determined that the in-focus information has been assigned to all the tile image data, the processing proceeds to step S3307. On the other hand, when it is determined that even some of the in-focus information have not been assigned to all the tile image data, the processing proceeds to step S3305.

In step S3305, when the in-focus information has not been assigned to at least some of the tile image data constituting the hierarchical image data, the in-focus state of the tile image data having no in-focus information is determined. The in-focus determination may be made based on a known method such as the comparison of contrast values.

In step S3306, in-focus information resulting from the in-focus determination in step S3305 is assigned to the corresponding tile image data. For example, the in-focus information is recorded on the header of the tile image data. On this occasion, user setting information may be assigned to the header data of the image file separately from the in-focus information. After the assignment of the in-focus information, the processing proceeds to step S3308.

In step S3307, an in-focus state is determined based on the in-focus information linked to the respective tile image data, and then the processing proceeds to step S3308.

In step S3308, non-focus tile image data is deleted based on the in-focus determination result of step S3305 or step S3307 and the deleted target information set in the initialization processing of step S3301, and then the processing proceeds to step S3309. For example, the tile image data whose in-focus degree does not satisfy a prescribed reference (threshold) is handled as the non-focus tile image data.

In step S3309, the hierarchical image data after being subjected to the deletion in step S3308 is updated and stored as an image file. In the way described above, the processing ends.

As described above, it becomes possible to reduce the data of the tile image data suiting a user's intension (specification of an observation target region and reduction in data amount). In addition, the following processing may be accelerated with the assignment of new in-focus information when in-focus information is not assigned in advance.

### Effects of Embodiment

According to the embodiment, the non-focus tile image data is reduced suiting a user's observation intention, whereby the data capacity of the image file may be reduced. In addition, the following processing may be accelerated with the assignment of the in-focus information to the image data.

For example, in a case in which a plurality of users share the load of performing a screening operation and a final analysis, a person in charge of the screening removes in advance image data in a region other than a region in which a lesion is suspected. Thus, it becomes possible to reduce the burden of a person who performs the final analysis.

### Other Embodiments

The object of the present invention may be achieved as follows.

That is, a recording medium (or storage medium) recording the program code of software implementing the whole or some of the functions of the above embodiments is provided in a system or an apparatus. Then, the computer (or the CPU or MPU) of the system or the apparatus reads and executes the program code stored in the recording medium. In this case, the program code per se read from the recording medium implements the functions of the above embodiments, and the recording medium recording the program code constitutes the present invention. In addition, when the computer executes the read program code, an OS (Operating System) or the like operating on the computer performs some or the whole of actual processing based on the instructions of the program code. A case in which the functions of the above embodiments are implemented by the processing may also be included in the present invention.

Moreover, it is assumed that the program code read from the recording medium is written in a function expansion card inserted in the computer or a memory provided in a function expansion unit connected to the computer. A case in which the CPU or the like provided in the function expansion card or the function expansion unit performs some or the whole of the actual processing based on the instructions of the program code to implement the functions of the above embodiments may also be included in the present invention. When the present invention is applied to the above recording medium, a program code corresponding to the flowcharts described above is recorded on the recording medium.

The configurations described in the first to the third embodiments may be combined together.

For example, when the tile image data selected according to the layer selection method described in the first embodiment is out of the depth of field, the method of clearly informing the user of the fact that the tile image data is out of the depth of field described in the third embodiment may be used in combination. In addition, the configuration of selecting the tile image data so as to be within the depth of field may be applied. Moreover, when the tile image data is out of the depth of field, such a state may be expressed by both the displays (FIGS. 17A and 17B) described in the second embodiment and the display (FIG. 18D) described in the third embodiment. Alternatively, if the layer positions before and after the scrolling are different from each other or the difference between the layer positions before and after the scrolling is greater than a prescribed value even when the tile image data is within the depth of field, such a state may be expressed by the displays shown in FIGS. 17A and 18D.

The configurations described in the fourth to the seventh embodiments may be combined together. For example, the plurality of images different in in-focus degree described in the fourth embodiment and the plurality of image data different in layer position described in the fifth embodiment may be combined together to change the layer positions after the switching of the in-focus degrees.

The image processing apparatus may be connected to both the imaging apparatus and the image server to acquire image data for use in the processing from any of the apparatuses.

Besides, configurations obtained when the various technologies of the above respective embodiments are appropriately combined together are also included in the scope of the present invention.

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2014-163671, filed on Aug. 11, 2014 and Japanese Patent Application No. 2014-163672, filed on Aug. 11, 2014, which are hereby incorporated by reference herein in their entirety.

What is claimed is:

1. An image processing method for generating display image data, which is to be displayed on a display apparatus, based on an image data set of an object, the image data set having image data of one or more layers different in depth position for each of a plurality of areas of the object, the method comprising:
acquiring an operation instruction to change a display area from a state in which first image data of a first area is being displayed to a state in which image data of a second area is to be displayed;
acquiring thickness information indicating an existence range of the object in a depth direction;
selecting second image data, which is to be displayed after the display area is changed, from among the image data of the one or more layers of the second area, based on the thickness information of the object; and
generating display image data from the second image data to be output.

2. The image processing method according to claim 1, wherein
image data of a layer, in which a depth position with respect to the existence range of the object satisfies a previously-set selection condition, is selected as the second image data from among the image data of the one or more layers of the second area.

3. The image processing method according to claim 2, wherein
the selection condition includes a condition in which the layer of the second image data is a layer closest to an upper end of the existence range of the object in the second area or is a layer included within the existence range of the object and closest to the upper end of the existence range of the object in the second area.

4. The image processing method according to claim 2, wherein
the selection condition includes a condition in which a relative position of the layer of the first image data with respect to the existence range of the object in the first area and a relative position of the layer of the second image data with respect to the existence range of the object in the second area coincide with or are proximate to each other.

5. The image processing method according to claim 2, wherein
the selection condition includes a condition in which a relative position of the layer of the second image data with respect to the existence range of the object in the second area corresponds to a prescribed value.

6. The image processing method according to claim 5, wherein
the selection condition includes a condition in which the depth position of the layer of the second image data coincides with or is proximate to a center of the existence range of the object in the second area.

7. The image processing method according to claim 2, wherein
the selection condition includes a condition in which the layer of the second image data is a layer closest to a lower end of the existence range of the object in the second area or is a layer included within the existence range of the object and closest to the lower end of the existence range of the object in the second area.

8. The image processing method according to claim 2, wherein
the selection condition is automatically set based on list data describing a correspondence relationship between the selection condition and at least one of information items of a person who observes an image displayed on the display apparatus, an observation target, an observation object, and a display magnification.

9. The image processing method according to claim 1, further comprising:
acquiring information indicating a depth of field of the first image data;
determining whether the depth position of the layer of the selected second image data is within the depth of field of the first image data; and
performing prescribed processing when the depth position of the layer of the second image data is out of the depth of field of the first image data.

10. The image processing method according to claim 9, wherein
the prescribed processing includes processing to inform a user of a fact that the second image data is an image out of the depth of field of the first image data.

11. The image processing method according to claim 9, wherein
the prescribed processing includes processing to generate and output auxiliary image data to indicate a state in which the depth position of the first image data and the depth position of the second image data are discontinuous from each other.

12. The image processing method according to claim 11, wherein
the auxiliary image data includes image data indicating the state, in which the depth position of the first image data and the depth position of the second image data are discontinuous from each other, in a text or graphic form.

13. A non-transitory computer readable storage medium storing a program for causing a computer to execute respective steps of an image processing method for generating display image data, which is to be displayed on a display apparatus, based on an image data set of an object, the image data set having image data of one or more layers different in depth position for each of a plurality of areas of the object, the method including:
acquiring an operation instruction to change a display area from a state in which first image data of a first area is being displayed to a state in which image data of a second area is to be displayed;
acquiring thickness information indicating an existence range of the object in a depth direction;
selecting second image data, which is to be displayed after the display area is changed, from among the image data of the one or more layers of the second area, based on the thickness information of the object; and
generating display image data from the second image data to be output.

14. An image processing apparatus for generating display image data, which is to be displayed on a display apparatus, based on an image data set of an object, the image data set having image data of one or more layers different in depth position for each of a plurality of areas of the object, the image processing apparatus comprising:
an instruction information acquisition unit that acquires an operation instruction to change a display area from a state in which first image data of a first area is being displayed to a state in which image data of a second area is to be displayed;
a thickness information acquisition unit that acquires thickness information indicating an existence range of the object in a depth direction;
a selection unit that selects second image data, which is to be displayed after the display area is changed, from among the image data of the one or more layers of the second area based on the thickness information of the object; and
a generation unit that generates display image data from the second image data.

15. An image processing method for generating display image data, which is to be displayed on a display apparatus, based on an image data set of an object, the image data set having image data of one or more layers different in depth position for each of a plurality of areas of the object, the method comprising:
acquiring an operation instruction to change a display area from a state in which image data of a first area is being displayed to a state in which image data of a second area is to be displayed;
generating third image data to indicate a change in depth position between first image data and second image data when the first image data and the second image data are image data of different layers, the first image data being the image data of the first area currently-displayed, the second image data being the image data of the second area to be displayed after the display area is changed; and
outputting the third image data to the display apparatus.

16. The image processing method according to claim 15, further comprising:
determining whether image data of a same layer as the layer of the first image data exists in the image data of the second area when the operation instruction is acquired; and
selecting image data of a layer different from the layer of the first image data as the second image data when the image data of the same layer does not exist or when the image data of the same layer exists but image data of another layer is more focused.

17. The image processing method according to claim 15, wherein
the third image data is output such that the display is switched on a time-divided basis in order of the first image data, the third image data, and the second image data.

18. The image processing method according to claim 15, wherein
the third image data includes image data indicating a change in depth position between the first image data and the second image data, in a text or graphic form.

19. The image processing method according to claim 15, wherein,
when the first image data and the second image data are image data of different layers, a mode is selectable from among a plurality of modes including at least a mode in which the display is switched on a time-divided basis in order of the first image data, the third image data, and the second image data, and a mode in which the display is directly switched from the first image data to the second image data.

20. The image processing method according to claim 19, wherein
one of the modes is automatically selected based on list data describing a correspondence relationship between the modes and at least one of information items of a person who observes an image displayed on the display apparatus, an observation target, an observation object, and a display magnification.

21. The image processing method according to claim 15, further comprising:
generating fourth image data to indicate an area position and a layer position of image data currently displayed with respect to the whole object.

22. A non-transitory computer readable storage medium storing a program for causing a computer to execute respective steps of an image processing method for generating display image data, which is to be displayed on a display apparatus, based on an image data set of an object, the image data set having image data of one or more layers different in depth position for each of a plurality of areas of the object, the method including:
acquiring an operation instruction to change a display area from a state in which image data of a first area is being displayed to a state in which image data of a second area is to be displayed;
generating third image data to indicate a change in depth position between first image data and second image data when the first image data and the second image data are image data of different layers, the first image data being the image data of the first area currently-displayed, the second image data being the image data of the second area to be displayed after the display area is changed; and
outputting the third image data to the display apparatus.

23. An image processing apparatus for generating display image data, which is to be displayed on a display apparatus, based on an image data set of an object, the image data set having image data of one or more layers different in depth position for each of a plurality of areas of the object, the image processing apparatus comprising:
an acquisition unit that acquires an operation instruction to change a display area from a state in which image data of a first area is being displayed to a state in which image data of a second area is to be displayed;
a generation unit that generates third image data to indicate a change in depth position between first image data and second image data when the first image data and the second image data are image data of different layers, the first image data being the image data of the first area currently-displayed, the second image data being the image data of the second area to be displayed after the display area is changed; and
an output unit that outputs the third image data to the display apparatus.
